(19) United States
(12) Patent Application Publication
(10) Pub. No.: US 2013/0191155 A1
(43) Pub. Date: Jul. 25, 2013

(54) ALLHEALTH

(71) Applicant: APA Concepts and Development Group, LLC, Long Beach, CA (US)

(72) Inventors: Ashvind N. Adkins Singh, Long Beach, CA (US); Angela D. Adkins Singh, Long Beach, CA (US); Paul Ananias, Long Beach, CA (US)

(73) Assignee: APA Concepts and Development Group, LLC, Long Beach, CA (US)

(21) Appl. No.: 13/654,101

(22) Filed: Oct. 17, 2012

Related U.S. Application Data
(60) Provisional application No. 61/548,011, filed on Oct. 17, 2011.
(60) Provisional application No. 61/714,031, filed on Oct. 15, 2012.

(51) Int. Cl. G06Q 10/10; G06Q 50/24

(52) U.S. Cl. CPC G06Q 10/10; G06Q 50/24
USPC 705/3

(57) ABSTRACT

A system, a method and a computer program for providing a comprehensive suite of applications that offer a holistic healthcare approach across multiple domains, products and services. The system is configured to assist users to, inter alia, perform initial intakes, record assessment data, track clinical progress, offer e-prescribing capabilities, and maintain an individual's complete medical record in a secure environment. The system is HIPPA compliant and meets the standards set forth by the US Government for EHR Certification.

### CROSS-REFERENCE TO RELATED APPLICATIONS

This application claims benefit and priority to U.S. Provisional Application No. 61/548,011 filed on Oct. 17, 2011 and also claims benefit and priority to U.S. Provisional Application No. 61/714,031 filed Oct. 15, 2012, the disclosures of which are incorporated by reference herein in their entirety.

### FIELD OF THE INVENTION

The present invention relates to a system, a method and a computer program that offer a holistic healthcare approach across multiple domains, products and services.

### BACKGROUND OF THE INVENTION

Healthcare providers are finding themselves facing an onslaught of information with which they must contend. They find that they must collect, create, process, maintain, and communicate information relating to various aspects of an individual's healthcare needs, including, for example, the individual's: health and wellness service; psychiatric care; psychological care; behavioral health services; wellness services encompassing nutritional and physical health services; rehabilitation therapy services; social work services; nursing care and services; general and specialized medical treatment and care; and the like. An unfulfilled need exists for a software suite that is designed for healthcare providers that provide services to individuals in need of health and wellness services. The healthcare providers (hereinafter referred to as “users”) may include, for example, individuals (such as, for example, physicians, psychologists, nurses, pharmacists, therapists, insurance agents, administrators, counselors, or the like) or entities (such as, for example, hospitals, clinics, schools, laboratories, government facilities, or the like).

The invention includes a novel system that comprises a comprehensive suite of applications that offer a holistic healthcare approach across multiple domains, products and services. The system is configured to assist users to, inter alia, perform initial intakes, record assessment data, track clinical progress, offer e-prescribing capabilities, and maintain an individual's complete medical record in a secure environment. The system is HIPPA compliant and meets the standards set forth by the US Government for electronic health record (EHR) Certification.

### SUMMARY OF THE INVENTION

According to one non-limiting example of the invention, a system, a method, and a computer program are provided that collect, create, process, maintain, and communicate information relating to various aspects of an individual's healthcare needs, including, for example, the individual's: health and wellness service; psychiatric care; psychological care; behavioral health services; wellness services encompassing nutritional and physical health services; rehabilitation therapy services; social work services; nursing care and services; general and specialized medical treatment and care; and the like. The system includes a software suite that is designed for users to provide services to individuals in need of health and wellness services. The system is configured to assist users to, inter alia, perform initial intakes, record assessment data, track clinical progress, offer e-prescribing capabilities, and maintain an individual's complete medical record in a secure environment. The system is HIPPA compliant and meets the standards set forth by the US Government for EHR Certification.

The system enables uses to manage an individual's health records in a centralized location and incorporate data from multiple disciplines and sources to improve and maximize patient care including e-prescribing. The system helps users lower expenses and related health-care costs, increase productivity, efficiency and accuracy, minimize risk, simplify clinical processes, increase revenue, and promote health and wellness.

The system includes a full standard toolset to enable users to generate patient progress notes and assessments in a seamless and simple fashion. The system may include a database-driven web, windows, and/or mobile application suite.

For example, the system comprises a data collection module, a document generation module, an administration module, an authentication module, and a payment module. The data collection module may include a web application that collects all needed data through simple wizard like graphic user interface that may utilize check boxes, drop down lists, or the like, for ease of use. The document generation module may include a web application that manages users and service subscriptions. The administration module may include a web application that manages users and service subscriptions. The authentication module may include a web service that may authenticate user logins and validate their subscription status. The payment module includes a virtual shopping cart with an authorize.net gateway (e.g., a payment gateway to accept credit cards for monthly recurring transaction) to enable customers to sign up for the software service via the web.

In one aspect, a web-based medical record system is provided that includes a web-based server to control patient electronic medical records (EMRs), a database operatively coupled to the web-based server to store the patient EMRs and at least one software module at the server operable to generate graphical user interfaces on a display at a user computer and operable to receive input from the user computer, the user computer in communication with the web-based server over the Internet, wherein the graphical user interfaces are configured to permit selection of medical parameters for a patient from predetermined selections to update the patient EMRs.

In one aspect, a method of providing a web-based medical record system is provided comprising the steps of providing a web-based server to control patient electronic medical records (EMRs), providing a database operatively coupled to the web-based server to store the patient EMRs and generating at the web-based server graphical user interfaces on a display at a user computer and receiving input from the user computer, the user computer in communication with the web-based server over the Internet, wherein the graphical user interfaces are configured to permit selection of medical parameters for a patient from predetermined selections to update the patient EMRs.

In one aspect, a computer-implemented program product having software code stored in a readable storage medium, the software code when read and executed by a processor, cause the following steps to be performed: generating from a web-based server, a plurality of graphical user interfaces (GUIs) to permit a user to select information from predetermined lists presented in in the plurality of GUIs to be entered into a selected patients electronic medical record (EMR) in an EMR database, providing a Physician's Psychiatric Progress Note (PPN) module to permit recordation and access by a user to a patient's medical records for recording Psychiatric information, and providing access to an electronic prescribing service so that a single login by user to the PPN module also provides access to the electronic prescribing service.

Additional features, advantages, and embodiments of the invention may be set forth or apparent from consideration of the detailed description, drawings and attachment. Moreover, it is to be understood that the foregoing summary of the invention and the following detailed description, drawings and attachment are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description and attachment serve to explain the principles of the invention. No attempt is made to show structural details of the invention in more detail than may be necessary for a fundamental understanding of the invention and the various ways in which it may be practiced. In the drawings:

FIG. 1 is an example of a Graphical User Interface (GUI) showing a Patient Information page, according to principles of the invention;

FIG. 2 is an example of a GUI showing an Add New Patient page, according to principles of the invention;

FIG. 3 is an example of a GUI showing Add New Patient page being filled out, according to principles of the invention;

FIGS. 4, and 4A-4C are examples of a GUIs showing various Legal Status pages, according to principles of the invention;

FIG. 5 is an example of a GUI showing Subjective concerns and symptoms of individual this month, according to principles of the invention;

FIG. 6 is an example of a GUI showing Identified Target Symptoms, according to principles of the invention;

FIG. 7 is an example of a GUI showing Medication Adherence, according to principles of the invention;

FIG. 8 is an example of a GUI showing Interval History, according to principles of the invention;

FIG. 9 is an example of a GUI showing Medical Conditions, according to principles of the invention;

FIGS. 10,10A-10C are examples of a GUI showing Tests, according to principles of the invention;

FIG. 11 is an example of a GUI showing Interval History, according to principles of the invention;

FIG. 12 is an example of a GUI showing Other Test Date, according to principles of the invention;

FIG. 13 is an example of a GUI showing Other Test Date, according to principles of the invention;

FIG. 14 is an example of a GUI showing Other Test Selections, according to principles of the invention;

FIG. 15 is an example of a GUI showing Consults, according to principles of the invention;

FIG. 16 is an example of a GUI showing Interval History—Metabolic panel, according to principles of the invention;

FIG. 17 is an example of a GUI showing Routine Medications, according to principles of the invention;

FIG. 18 is an example of a GUI showing Routine Medications—Risk/Benefit, according to principles of the invention;

FIG. 19 is an example of a GUI showing Routine Medications, according to principles of the invention;

FIG. 20 is an example of a GUI showing Routine Medications, according to principles of the invention;

FIG. 21 is an example of a GUI showing Routine Medications, according to principles of the invention;

FIG. 22 is an example of a GUI showing PRN/Stat Medications, according to principles of the invention;

FIG. 23 is an example of a GUI showing Routine Medications, according to principles of the invention;

FIG. 24 is an example of a GUI showing PRN/Stats, according to principles of the invention;

FIG. 25 is an example of a GUI showing PRN/Stats, according to principles of the invention;

FIG. 26 is an example of a GUI showing PRN/Stats, according to principles of the invention;

FIG. 27 is an example of a GUI showing PRN/Stat Medications, according to principles of the invention;

FIG. 28 is an example of a GUI showing Effect of Medications on Symptoms, according to principles of the invention;

FIG. 29 is an example of a GUI showing Deviation from Psychotropic Guidelines, according to principles of the invention;

FIG. 30 is an example of a GUI showing Polypharmacy, according to principles of the invention;

FIG. 31 is an example of a GUI showing Medications with Elevated Risks, according to principles of the invention;

FIG. 32 is an example of a GUI showing Current Side Effects, according to principles of the invention;

FIG. 33 is an example of a GUI showing relative side effects, according to principles of the invention;

FIG. 34 is an example of a GUI showing Behavioral Guidelines, according to principles of the invention;

FIG. 35 is an example of a GUI showing Other, according to principles of the invention;

FIG. 36 is an example of a GUI showing Monthly Psychiatry Progress Note MSE, according to principles of the invention;

FIG. 37 is an example of a GUI showing Monthly Psychiatry Progress Note MSE, according to principles of the invention;

FIG. 38 is an example of a GUI showing Monthly Psychiatry Progress Note MSE, according to principles of the invention;

FIG. 39 is an example of a GUI showing Monthly Psychiatry Progress Note MSE, according to principles of the invention;

FIG. 40 is an example of a GUI showing Monthly Psychiatry Progress Note MSE, according to principles of the invention;

FIG. 41 is an example of a GUI showing Monthly Psychiatry Progress Note MSE, according to principles of the invention;

FIG. 42 is an example of a GUI showing Monthly Psychiatry Progress Note MSE, according to principles of the invention;

FIG. 43 is an example of a GUI showing Monthly Psychiatry Progress Note MSE, according to principles of the invention;

FIG. 44 is an example of a GUI showing Monthly Psychiatry Progress Note MSE, according to principles of the invention;

FIG. 45 is an example of a GUI showing Monthly Psychiatry Progress Note MSE, according to principles of the invention;

FIG. 46 is an example of a GUI showing Monthly Psychiatry Progress Note MSE, according to principles of the invention;

FIG. 47 is an example of a GUI showing Monthly Psychiatry Progress Note MSE, according to principles of the invention;

FIG. 48 is an example of a GUI showing Monthly Psychiatry Progress Note MSE, according to principles of the invention;

FIG. 49 is an example of a GUI showing Monthly Psychiatry Progress Note MSE, according to principles of the invention;

FIG. 50 is an example of a GUI showing Monthly Psychiatry Progress Note MSE, according to principles of the invention;

FIG. 51 is an example of a GUI showing Monthly Psychiatry Progress Note MSE, according to principles of the invention;

FIG. 52 is an example of a GUI showing Monthly Psychiatry Progress Note MSE, according to principles of the invention;

FIG. 53 is an example of a GUI showing MMSE Items, according to principles of the invention;

FIGS. 54A and 54B are examples of a GUIs showing MMSE/Score, according to principles of the invention;

FIG. 55 is an example of a GUI showing AIMS tests, according to principles of the invention;

FIG. 56 is an example of a GUI showing AIMS tests, according to principles of the invention;

FIG. 57 is an example of a GUI showing AIMS, according to principles of the invention;

FIG. 58 is an example of a GUI showing Current Risk Assessment, according to principles of the invention;

FIGS. 59a-59d are an example of a GUI showing DIAGNOSIS AXIS I selection and entry for a patient, according to principles of the invention;

FIGS. 60a-60d are an example of a GUI showing DIAGNOSIS AXIS II selection and entry for a patient, according to principles of the invention;

FIGS. 61a-61d are an example of a GUI showing DIAGNOSIS AXIS III selection and entry for a patient, according to principles of the invention;

FIG. 62 is an example of a GUI showing DIAGNOSIS AXIS IV selection and entry for a patient, according to principles of the invention;

FIG. 63 is an example of a GUI showing DIAGNOSIS AXIS V, according to principles of the invention;

FIG. 64 is an example of a GUI showing Medical Comments, according to principles of the invention;

FIG. 65 is an example of a GUI showing Barriers to Discharge, according to principles of the invention;

FIG. 66 is an example of a GUI showing “Plan for the Coming Month,” according to principles of the invention;

FIG. 67 shows an example of a system configured according to the principles of the invention;

FIG. 68 shows an example of a process according to the principles of the invention; and

FIG. 69 is a block diagram showing a Physician's Psychiatric Progress Note (PPN) module the database and an electronic prescription service system or module, according to principles of the invention.

The present invention is further described in the detailed description that follows.

### DETAILED DESCRIPTION OF THE INVENTION

The invention and the various features and advantageous details thereof are explained more fully with reference to the non-limiting embodiments and examples that are described and/or illustrated in the accompanying drawings and detailed in the following description and attachment. It should be noted that the features illustrated in the drawings and attachment are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server”, as used in this disclosure, means any combination of software and/or hardware, including at least one application and/or at least one computer to perform services for connected users as part of a user-server architecture. The at least one server application may include, but is not limited to, for example, an application program that can accept connections to service requests from users by sending back responses to the users. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from users by sending back responses to the users. The database may be configured to run the application, often under heavy workloads, unattended, for extended periods of time with minimal human direction.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously. The graphical user interfaces (GUI) illustrated herein may also be considered as block diagrams of the software component and associated hardware for providing the GUI and for receiving and processing input received in response to displaying the GUI. The GUIs may also represent steps of implementing and/or processing the respective information associated with the GUIs.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other tangible medium from which a computer can read. The computer-readable medium may include a “Cloud,” which includes a distribution of files across multiple (e.g., thousands of) memory caches on multiple (e.g., thousands of) computers. The computer-readable medium may also comprise a computer program product having software code that when read and executed performs the steps described herein, including the steps associated with and provided by the graphical user interfaces described herein

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

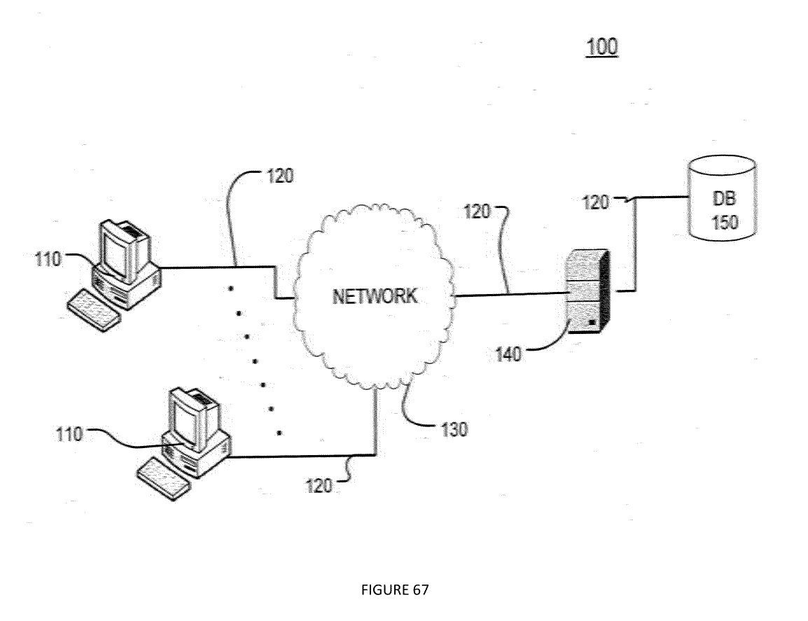

FIG. 67 shows an example of a system 100 that comprises a comprehensive suite of applications that offer a holistic healthcare approach across multiple domains, products and services. The system 100 (also known as ALLHEALTH) may be configured to assist users 110 to, inter alia, perform initial intakes, record assessment data, track clinical progress, offer e-prescribing capabilities, and maintain an individual's complete medical record (i.e., an electronic medical record—EMR) in a secure environment. The system 100 is HIPPA compliant and meets the standards set forth by the US Government for EHR Certification. The system 100 includes a plurality of user computers 110, a network 130, a server (or computer) 140, and one or more databases 150. The server 140 and database(s) 150 may be connected to each other and/or the network 130 via one or more communication links 120. The user computers may include a wired or wireless computing device including, but not limited to: a personal computer, a tablet computer, a laptop computer, a cellphone, a work station, and the like.

The system 100 may be implemented as a web based system that provides data storage and access across the network 130 (which may be the Internet). The server 140 may include software to support relational database accesses on behalf of the users at the user computers 110. The server 140 and database 150 may implement a relational database management system (RDBMS) such as a structured query language (SQL). SQL is a known standard of the International Organization for Standards (ISO) and the American National Standards Institute (ANSI). The database 150 may maintain an EMR database.

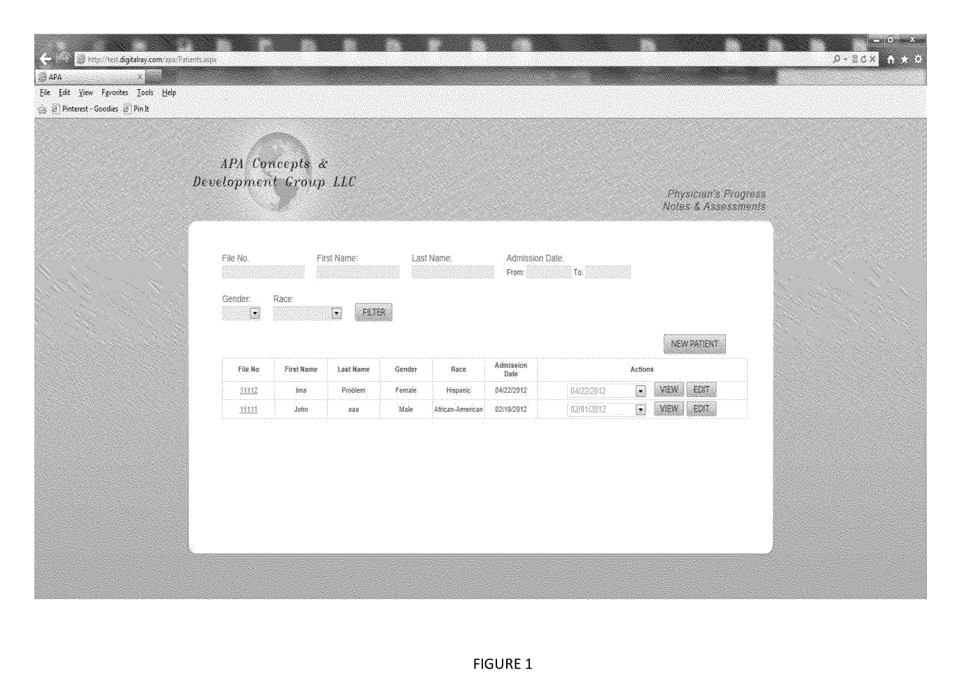

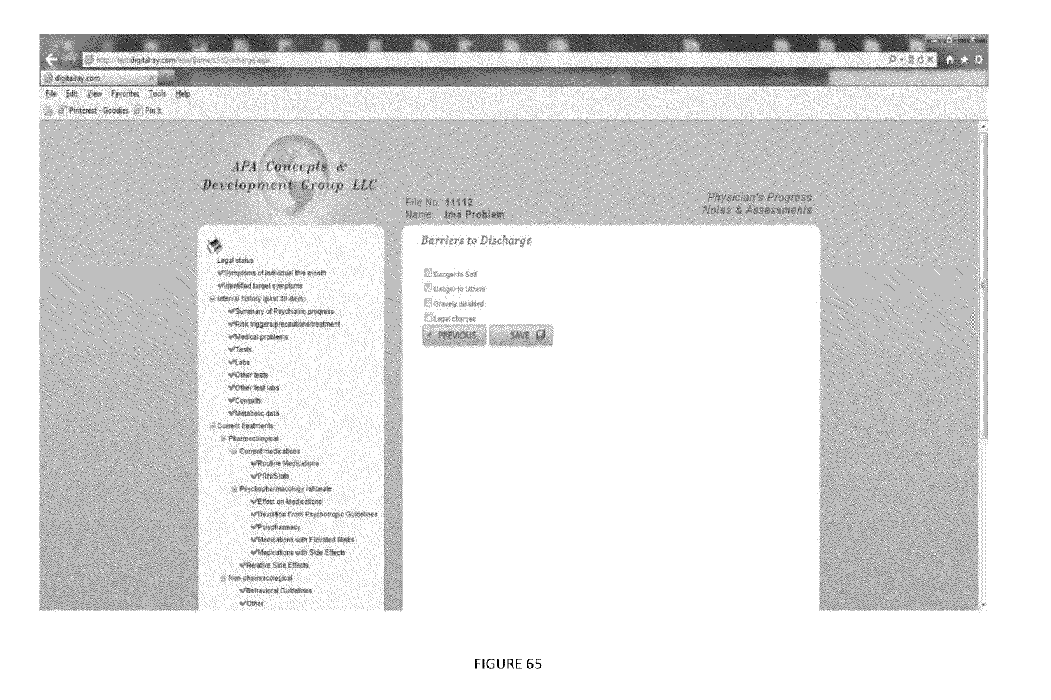

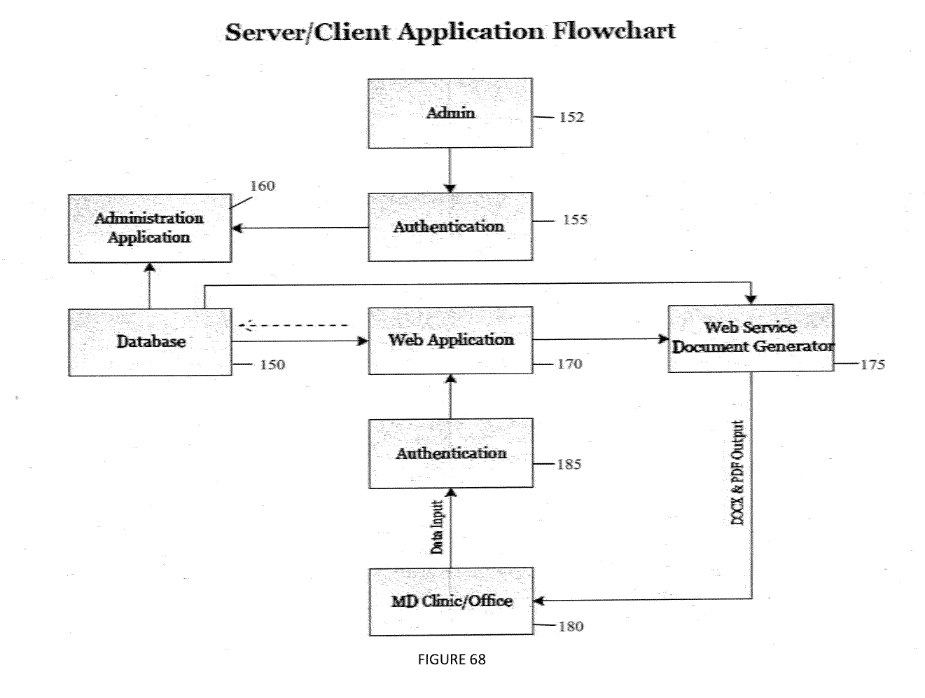

FIG. 68 shows an example of a process that may be carried out according to the principles of the invention. FIG. 68 may also be viewed as a block diagram of components of the system 100. The process may include administrating the web based system 100 by an Administrator 152 that may access the system from a computing device to access or interact with the system 100. An authentication module 155 may provide for identification of an administrator 152 to confirm that they may access the system or selected portions of the system 100, or deny access if they are not permitted access. An administration application 160 may control an Administrator 152 access from a computing device to the system 100 and control abilities to acquire and update portions of the system 100. In some implementations, the administration application 160 and authentication module may be implemented as part of the web application 170. For example, Administrator 152 may access database 150 to update data definitions in database 150 to be used by a clinic or office. Administrator 152 may also acquire access to update software functionality for web application 170 functionality. Since the web application 170 may be primarily data driven by data resident in database 150, the Administrator 152 may alter data definitions to make new data selections (e.g., new options or features in the graphical user interfaces described herein) available to clinic personnel when using the system 100 in actual patient care mode by clinic personnel. Users (such as doctors, nurses, clinicians, and the like) at a clinic or medical office 180 may be authenticated by an authentication module 185 (which may be combined with module 155) to assure that the particular user may access the web application 170 for using the system 100 as describe more below in relation to the graphical user interfaces of FIGS. 1 to 65 that may be controlled by the web application 170. A document generator 175 may provide the clinic or office personnel with displays of printouts of a multitude of possible outputs, as demanded by the users.

The system 100 may include being operatively located at least in part as a web application 170, such as at server 140, that collects all needed data through simple wizard like graphic user interface that may utilize check boxes, drop down lists, or the like, for ease of use. The system 100 may include the following technical details.
Database Design
   Microsoft SQL Server 2008 R2
Application Technologies
   Microsoft ASP NET 4.0 Framework
   AJAX/JQUERY
Graphic User Interface
   Validated XHTML 1.1
   Validated CSS 2.1
   Designed for Ease of Use
      Drop down lists
      Check boxes
      Wizards
      Tab based sections
      Tree view structure
      Radio buttons
Data Collection Categories
   Identifying Information
      Personal/demographic
      Legal Status
   Subjective concerns and symptoms of the individual this month
   Identified Target Symptoms
   Interval History (past 30 days)
      Summary of Psychiatric progress
      Risk triggers/precautions/treatment
      Medical Problems
      Tests
      Labs
      Other tests
      Other test labs
      Consults
      Metabolic data
      Labs, consults, other tests obtained this month
      BMI, Waist Circumference
   Current treatments
      Pharmacological
         Current medications
         Routine medications
         PRN/Stats
         Psychopharmacology Rationale
         Effect of Medications
         Deviation from Psychotropic Guidelines
         Polypharmacy
         Medications with Elevated Risks
         Medications with Side Effects
         Relevant Side Effects
      Non-Pharmacological
         Behavioral guidelines/PBS plans
         Implications of psychiatric status to groups
         Other (e.g. individual therapy)
   Recent psychiatrist observations
      MSE
      MMSE Items
      MMSE
      AIMS Tests
      AIMS
   Assessment
      Current risk assessments
      Diagnosis All Five Axes
         Axis I
         Axis II
         Axis III
         Axis IV
         Axis V
      Medical concerns to be addressed next month
      Primary current barriers to discharge
   Plan for the coming month
      Change in medication
      Change in non-pharmacologic interventions
      Consults
      Planned labs or tests
      Other

A document generation module 175 may include a web application that manages users and service subscriptions. The document generation module 175 may include the following details.
Web Service Document Generator
   Document Template Design
   Generate Microsoft Word documents from database
   Generate PDF document from database

The administration module 160 may also manage users and services subscriptions. The administration module may include the following details.
Manage Users
   Register a user account
   Change user account information
   Activate/Deactivate accounts
   Reset user account credentials

The authentication module 155, 185 may include a web service that may authenticate user logins and validate their subscription status. The authentication module 155, 185 may include the following details.
User login security
Active subscription validation
Username and password reset
User profile management

A payment module (not shown) that may include a virtual shopping cart with, e.g., an authorize.net gateway (e.g., a payment gateway to accept credit cards for monthly recurring transaction) to enable customers to sign up for the software service via the web.
Custom Shopping Cart
Authorize.net
   ARP (Automated Recurring Payment) subscription
      User will create a payment subscription to pay via credit card automatically each month

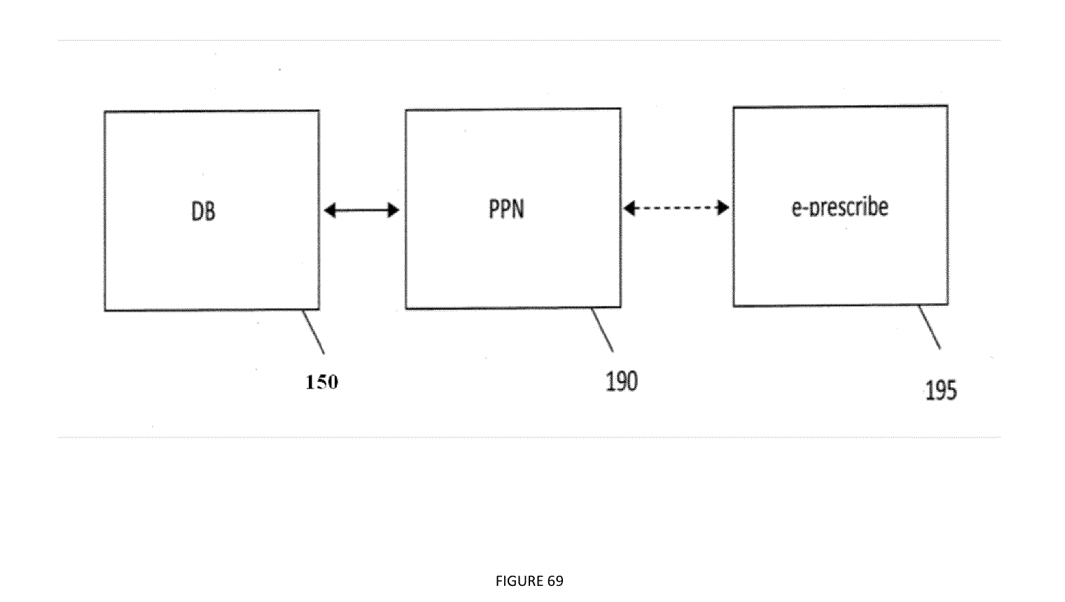

FIG. 69 is a block diagram showing a Physician's Psychiatric Progress Note (PPN) module 190, the database 150 and an electronic prescription service system or module 195. The Physician's Psychiatric Progress Note (PPN) module 190 may be configured with an interface to an electronic prescription prescribing system 195. The electronic prescription prescribing system 195 may be a separate and external system that the PPN module 195 interacts with, such as over a communications network, to provide a comprehensive and transparent operational interface to a user such as a doctor at a clinic 180. The electronic prescription prescribing system 195 may be a contracted service such as ALLSCRIPTS®, for example. Alternatively, the electronic prescription prescribing system 195 may be integrated with the PPN module 190 in the web application 170. The integration with the electronic prescribing system 195 permits doctors or licensed professionals to prescribe medications from the user computers 110. A single login by a user (e.g., doctor) at the system 100 also provides automatic login to the electronic prescribing system 195, which helps to improve the overall user experience by reducing the amount of user interaction overhead, e.g., extra logins. The PPN module 190 may be configured to control output, and process input from, for all, or part of, the graphical user interfaces of FIGS. 1-65.

Referring to FIG. 69, a Physician's Psychiatric Progress Note (PPN) module 190 (which may be a part of the web application 170 at server 140) is a database driven software program with the following features/characteristics:
The PPN module 190 allows a user (e.g. at a user computer 110) to complete an extensive evaluation of a patient, using, e.g., a computer, mouse, touchscreen, and/or keyboard. The outline format, extensive database and mouse-clickable selections may allow the user to enter the data with minimal typing; the user may complete a progress note in just a few minutes, and then generate a document that covers a broad range of areas with a level of detail that would be very difficult to accomplish by other methods. An advantage is that the PPN is an automated process of data collection and document generation, particularly in Psychiatry, that produces a physician's psychiatric progress note, utilizing Microsoft® SQL server 2008 R2 64 bit version, and Microsoft® Word 2010 R2, for example.
The modular, data-based format of the PPN module 190 is advantageous in that it allows other modules to be integrated together, including modules for psychology, behavioral treatment, rehabilitation therapists, social workers, nursing, patient scheduling, as well as a data-harvesting module. In the data-harvesting module the user is be able to collect/harvest data by simply setting various parameters (such as age, gender, symptoms, medication, dose range, behaviors/symptoms), then have the data displayed in various formats (Venn diagrams, pie-charts, bar graphs, etc.).
Web-based (Internet based) format, allowing access from any computer that can connect to the Internet via a secured (SSL) connection with login name and password.
Electronic prescribing software (e.g., AllScripts®) may be integrated with this PPN module 190, allowing a user (e.g., a doctor) to prescribe medications, check for side effects, check for drug-drug interactions and electronically transmit the prescription to whichever pharmacy the user selects on behalf of a patient.
Single sign-on, so that the user (once AllScripts® verifies that the user has an active license to prescribe, e.g. a physician's licensee) may log in to this PPN module 190 and automatically be logged in to AllScripts e-prescribing software.
The PPN module 190 covers a broad range of areas of interest, and each area of interest has a depth of information involving multiple selections that are available to describe each selection or a free-form text box.
The PPN module 190 is configured to be data-based driven, therefore, the available selections (depth of information) as well as the overall broad range of areas of interest can be easily expanded and customized to the user on an ongoing basis, in real-time, avoiding the problem of waiting for a new version (for example, avoiding waiting for an update from a ‘1.0’ version to a ‘2.0’ version).

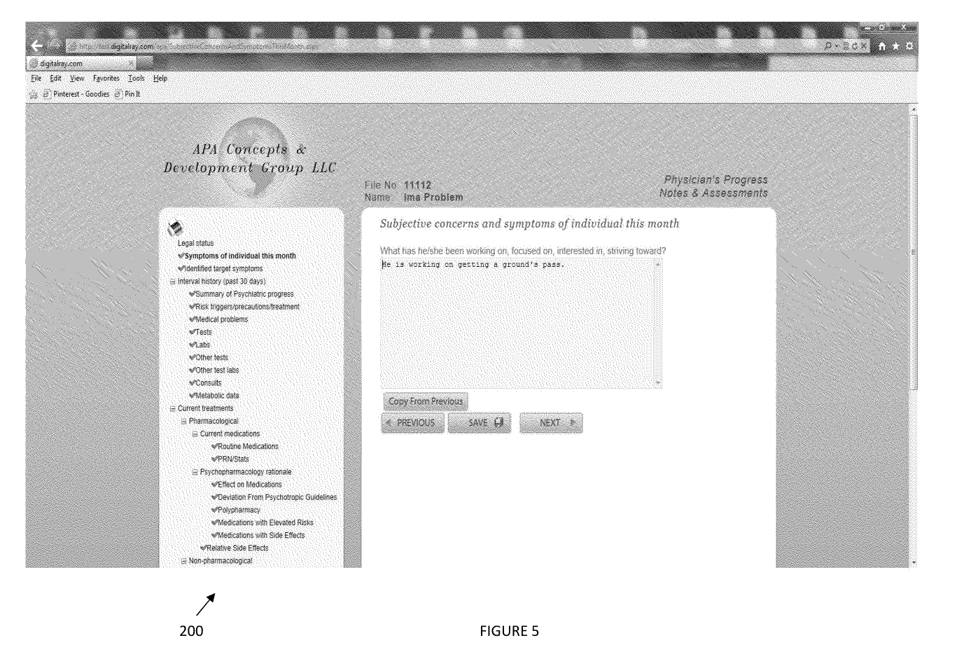

The graphical user interfaces of FIGS. 1-65 are exemplary interfaces to interact with a user to achieve a comprehensive system for medical offices and clinics for initial intakes, record assessment data, track clinical progress, offer e-prescribing capabilities, and maintain an individual patient's complete medical record (i.e., an electronic medical record—EMR) in a secure environment, and the like. The graphical user interfaces may be configured with a tree directory 200 (see, e.g., FIG. 5) such as those GUIs of FIGS. 5-65, which permits a user to directly access a particular topic area by selecting the particular entry.

FIG. 1 is an example of a Graphical User Interface showing a Patient Information page, according to principles of the invention. The GUI 150 allows a user (e.g., a doctor, nurse, staff person or clinician) to select a prior document, using a filter, as necessary, to search by patient name (e.g., “Ima Problem” or “John aaa” as shown) or admission date, open it, make any changes since the prior note, and save it as a new note with the current date. The “race” pull down menu may have 20 or more races or ethnic groups listed.

Once input or access is completed, the user may save the data of this section by mouse-clicking the ‘Save’ button (not shown) or similar button, and when ready to go onto the next section, the user may mouse-click the ‘Next’ button. Or the user may return to the prior section by mouse-clicking the ‘Previous’ button.

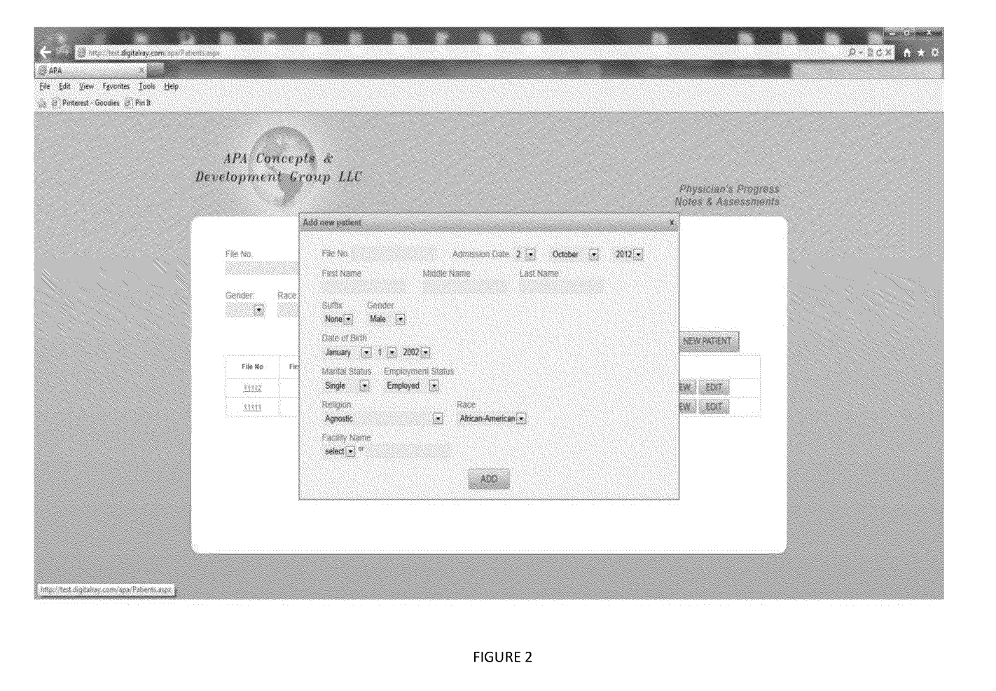

FIG. 2 is an example of a GUI showing an Add New Patient page, according to principles of the invention. This GUI may be configured to allow a user to select an admission date from a pull down menu. A user may enter a patient's first, middle and last name, in the fields as shown. This GUI may also allow a user to select suffix, date of birth, marital status, employment status, religion, gender, and transferring facility name, or one of 58 counties in California (the counties section is modifiable for each State in the USA), from pull down menus. The “religion” pull down menu may have all 19 major religions and/or religious positions listed, allowing a user to simply mouse-click the appropriate selection. Once all selections are made, the user may press the ‘Add’ button and the patient information is added.

Once that is completed, the user may save the section by mouse-clicking the ‘Save’ button, and when ready to go onto the next section, the user may mouse-click the ‘Next’ button. Or the user may choose to return to the prior section by mouse-clicking the ‘Previous’ button.

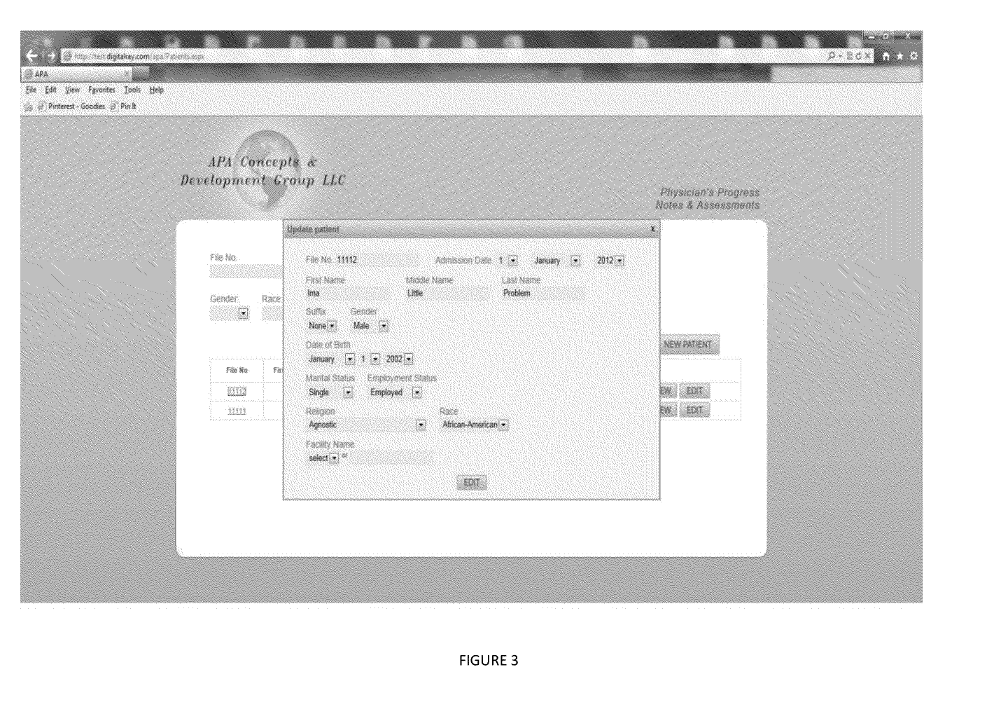

FIG. 3 is an example of a GUI showing Update Patient page being filled out, according to principles of the invention. This page permits editing of a patient record (e.g., file no. 11112) as perhaps saved in FIG. 2. The patient name is “Ima Little Problem.” Other fields are shown that may be completed.

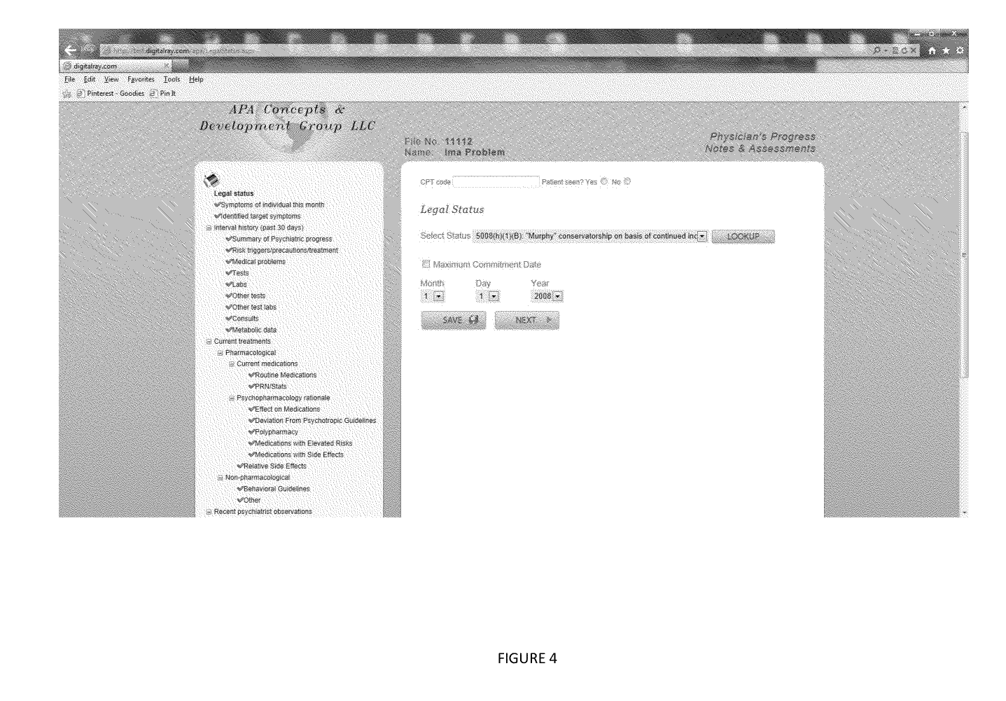

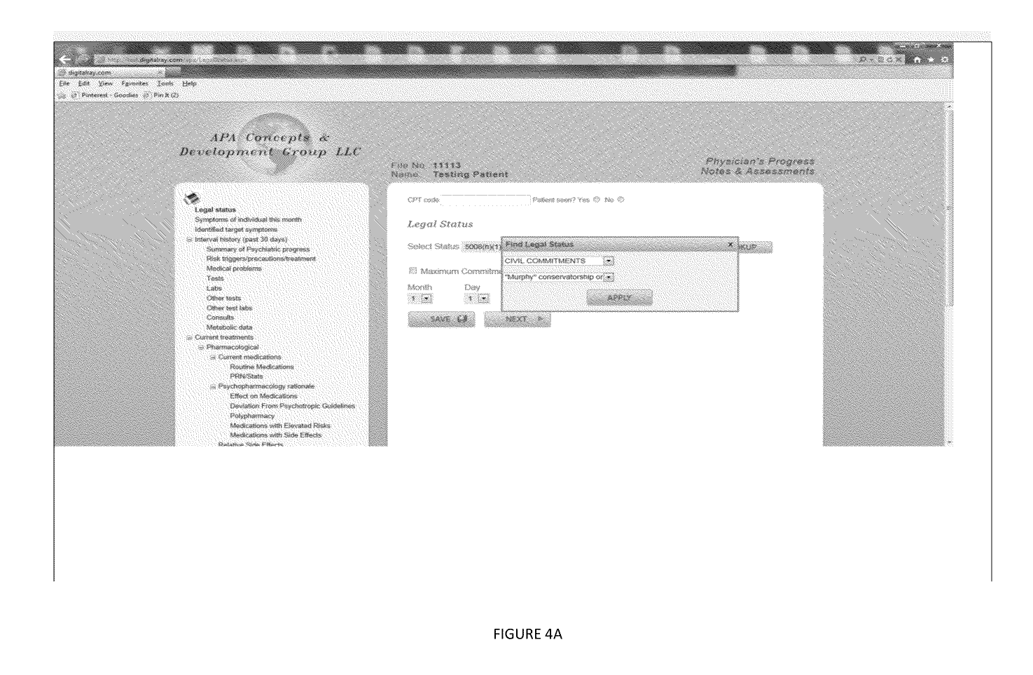

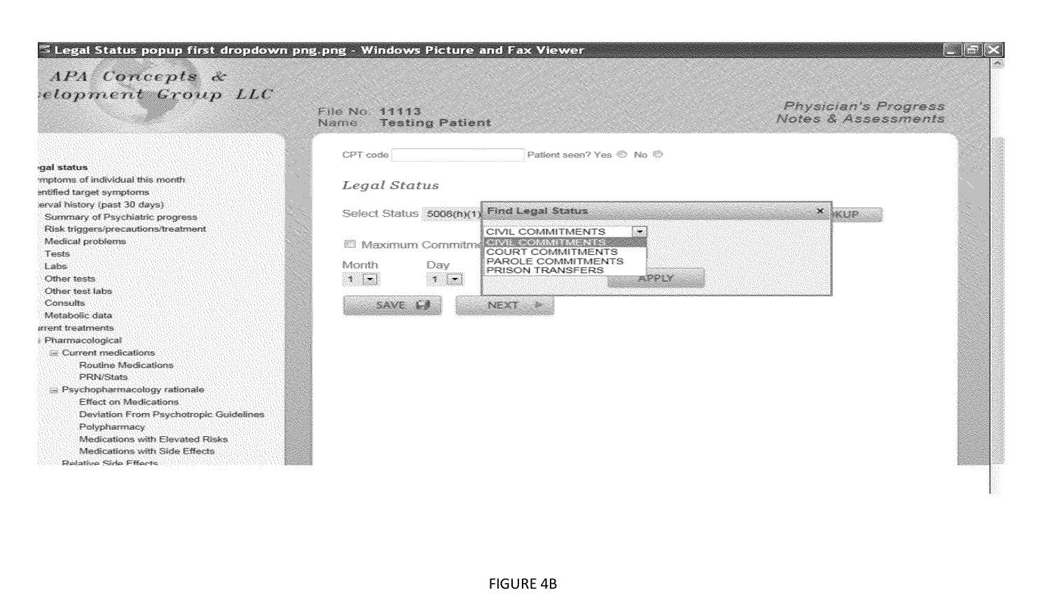

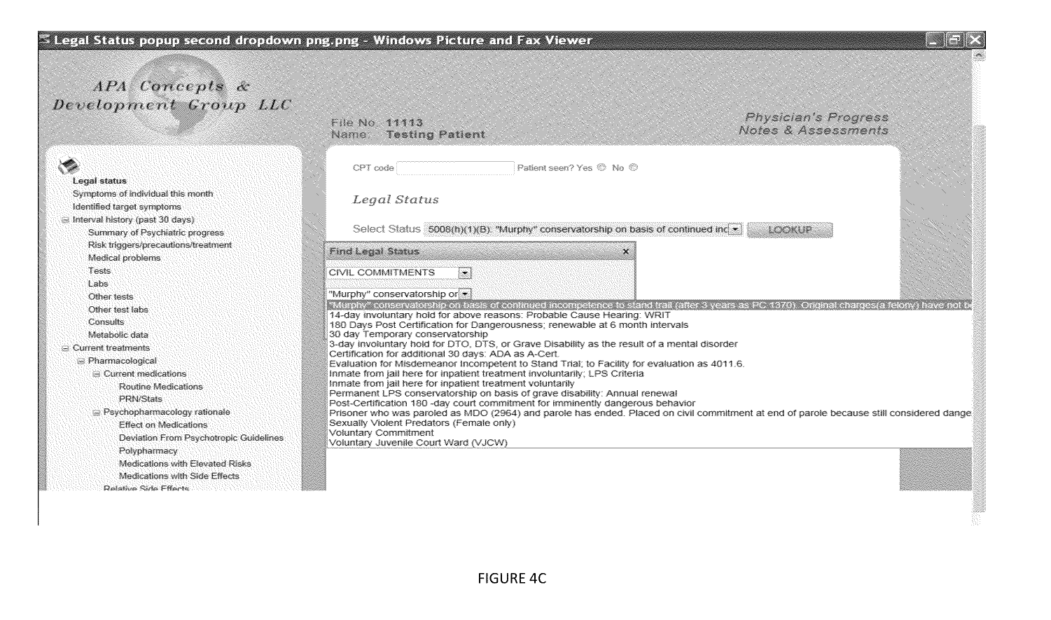

FIG. 4 is an example of a GUI showing Legal Status page, according to principles of the invention. The user may enter the CPT code in the top portion of the GUI and also select whether or not the patient was seen or not seen. This is also where the Maximum Commitment Date can be entered by first checking the checkbox, then entering the date using the pull-down menus for day, month and year. (As shown in FIGS. 4A-4C). This GUI is configured to allow a client to select among the legal status by displaying 5 types of court commitments, 3 types of parole commitments, 1 type of prison transfer and 15 types of civil commitments. The client may simply mouse-click the selection and moves on to the next selection.) Once that is completed, the client may save the section by mouse-clicking the ‘Save’ button, and when ready to go onto the next section, the client can mouse-click the ‘Next’ button. Or, the user may return to the prior section by mouse-clicking the ‘Previous’ button. FIG. 4A is an example of a GUI showing a Legal status pop-up, accessible form the GUI of FIG. 4, according to principles of the invention. In this GUI, the user may look up a legal status for a patient (the name illustratively denoted as “Testing Patient” in this example), simply by mouse-clicking the ‘Lookup’ button (FIG. 4), which then displays a pop-up of FIG. 4A showing Commitment groups in the top selection pull-down box. In the bottom selection pull-down box, the various commitments related to the Commitment groups are displayed. FIG. 4B is an example of GUI showing a Legal status first dropdown, according to principles of the invention. In this GUI, since the user has mouse-clicked the ‘Lookup’ button (as noted in FIG. 4A), the client may now select a particular commitment by first selecting from a group of commitments (e.g., Civil commitments, Court commitments, Parole commitments, and Prison commitments). FIG. 4C is an example of GUI showing a Legal status second dropdown, according to principles of the invention. In this GUI, since the client has mouse-clicked the ‘Lookup’ button (as noted in FIG. 4), and has already selected the Commitment group (i.e., FIG. 4B, CIVIL COMMITMENTS), the user may can now select a specific commitment type that is listed in the selected group.
Once that is completed, the user may save the section by mouse-clicking the ‘Apply’ button. When ready to go onto the next section, the client may mouse-click the ‘Next’ button. Or the client can return to the prior section by mouse-clicking the ‘Previous’ button.

FIG. 5 is an example of a GUI showing Subjective concerns and symptoms of individual this month, according to principles of the invention. This GUI allows the user to enter whatever they want in a text box, but also allows the user the option of copying the information from a prior document by simply mouse-clicking the link ‘Copy From Previous.’ Once that is completed, the user can save the section by mouse-clicking the ‘Save’ button, and when ready to go onto the next section, the user may mouse-click the ‘Next’ button. Or the user can return to the prior section by mouse-clicking the ‘Previous’ button.

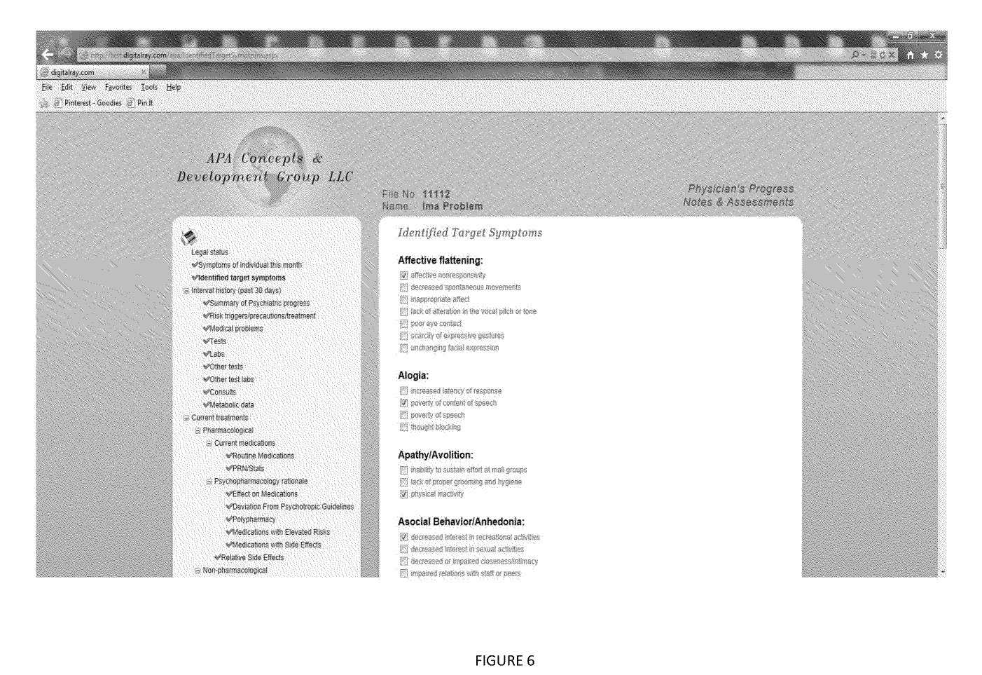

FIG. 6 is an example of a GUI showing Identified Target Symptoms, according to principles of the invention. This GUI allows a user to mouse-click multiple selections from 13 different categories containing e.g., a total of 86 descriptors:
7 descriptions of Affective flattening
4 descriptors of Alogia
3 descriptors of Apathy/Avolition
4 descriptors of Asocial Behavior/Anhedonia
3 descriptors of Assaultive/aggressive behavior
2 descriptors of Attention Impairment
4 descriptors of Auditory Hallucinations
5 descriptors of Bizarre Behavior
5 descriptors of Danger-to-self behaviors
11 descriptors of Delusions
10 descriptors of Depressed mood
8 descriptors of Formal Thought Disorder
20 descriptors of Manic Symptoms
   Once this entry has been completed, the user can save the section by mouse-clicking the ‘Save’ button, and when ready to go onto the next section, the user can mouse-click the ‘Next’ button. Or the user can return to the prior section by mouse-clicking the ‘Previous’ button. The extensive descriptor database is flexible; but also advantageous in that, since the software program is data-based, additional descriptors may be requested by the user and these descriptors may be dynamically added into the database in real-time (e.g., by an Administrator), thereby allowing customization of the software to fulfill the needs of the user.

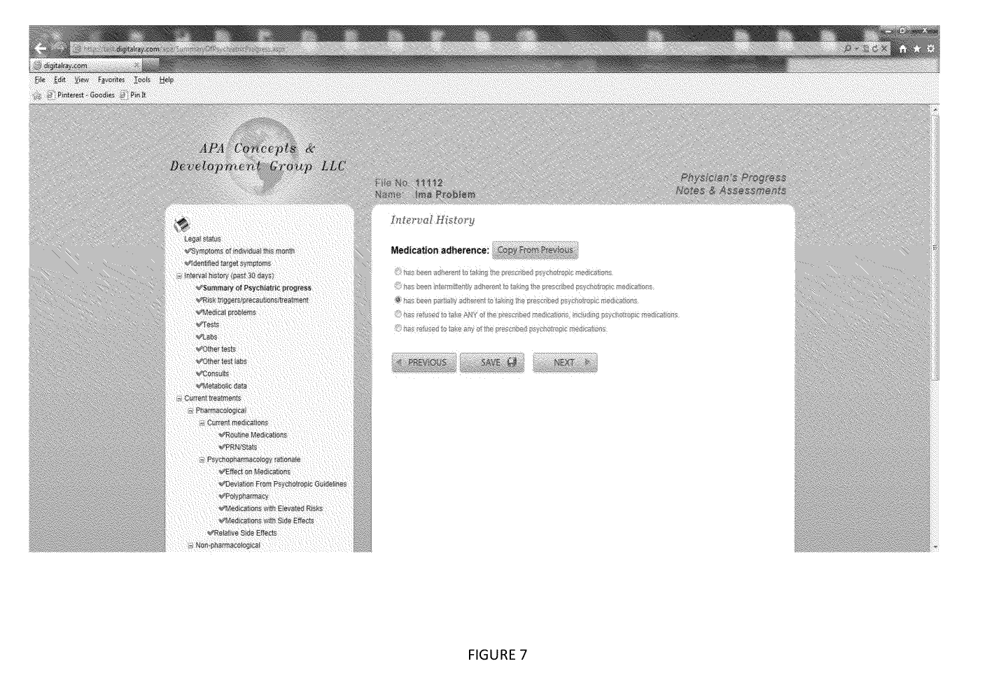

FIG. 7 is an example of a GUI showing Medication Adherence, according to principles of the invention. This GUI is configured to allow a user to either mouse-click the ‘Copy from Previous’ button to automatically enter the data from the most recent progress note, or alternatively to select among 5 standardized phrases to describe the adherence of the patient.

Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

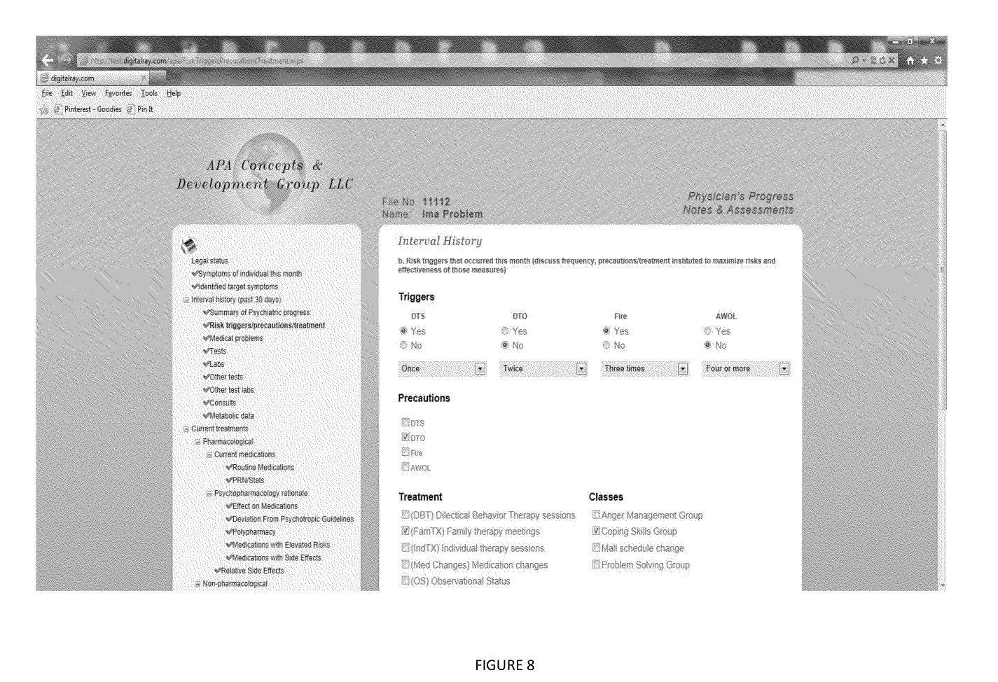

FIG. 8 is an example of a GUI showing Interval History, according to principles of the invention. Under the heading of Triggers, this section allows the user to select from 4 types of behavior; DTS (danger to-self), DTO (danger-to-others), Fire (fire-setting) or AWOL (absent without leave) behaviors. For each section, the user may select either ‘No’ if there was no behavior of that type, or ‘Yes’ if the patient exhibited that type of behavior and then select, from a pull-down menu, the frequency of the occurrence of that particular behavior (once, twice, three times, four or more times). The user then may select from 4 types of ‘Precautions’, if any, on which they wish to place the patient.

The user then selects (none, one or more) types of ‘Treatment’ that they want for the patient. Finally, the user may select (none, one or more) types of ‘Classes’ to enroll the patient.

Once that is completed, the user may save the section by mouse-clicking the ‘Save’ button, and when ready to go onto the next section, the user can mouse-click the ‘Next’ button. Or the user can return to the prior section by mouse-clicking the ‘Previous’ button.

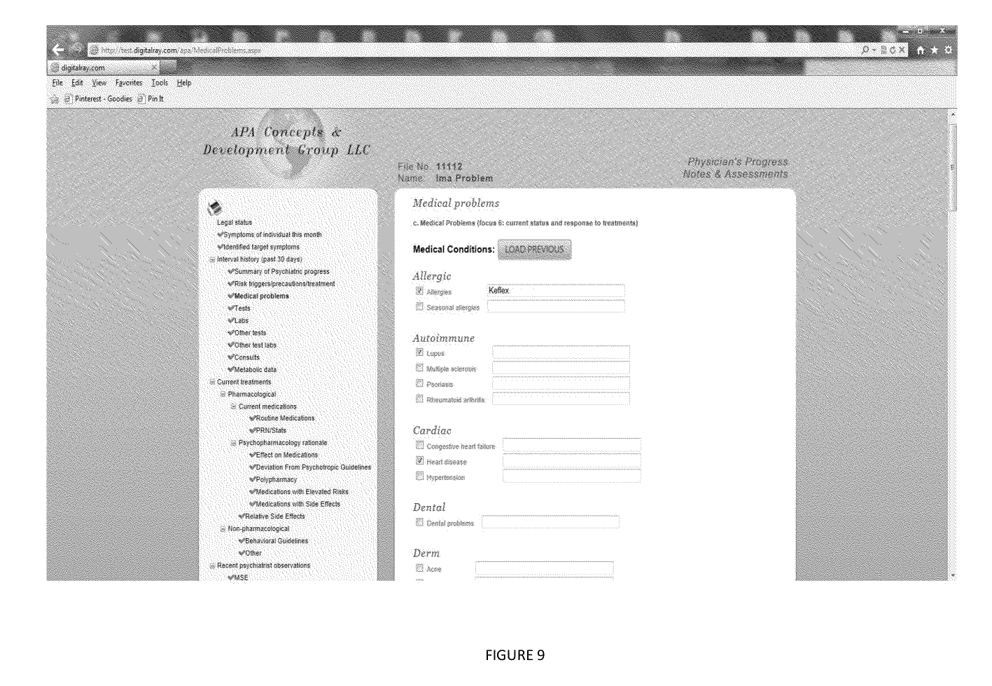

FIG. 9 is an example of a GUI showing Medical Conditions, according to principles of the invention. This GUI is configured to allow a user to either mouse-click the load Previous' button to automatically enter the data, regarding Medical Problems, from the most recent progress note. Alternatively, the user may select from various conditions/problems that are listed under multiple common problem groups, to describe the medical problems of the patient, and type in the current treatment. Once that is completed, the user may save the section by mouse-clicking the ‘Save’ button, and when ready to go onto the next section, the user can mouse-click the ‘Next’ button. Or the user can return to the prior section by mouse-clicking the ‘Previous’ button.

So, the features of this GUI permits a user to quickly load a list of previous medical problems and treatment, without having to retype these problems and treatment, and even then, the user can still edit the loaded data. Alternatively, the user can select from multiple common medical problems, instead of typing all such data into the document.

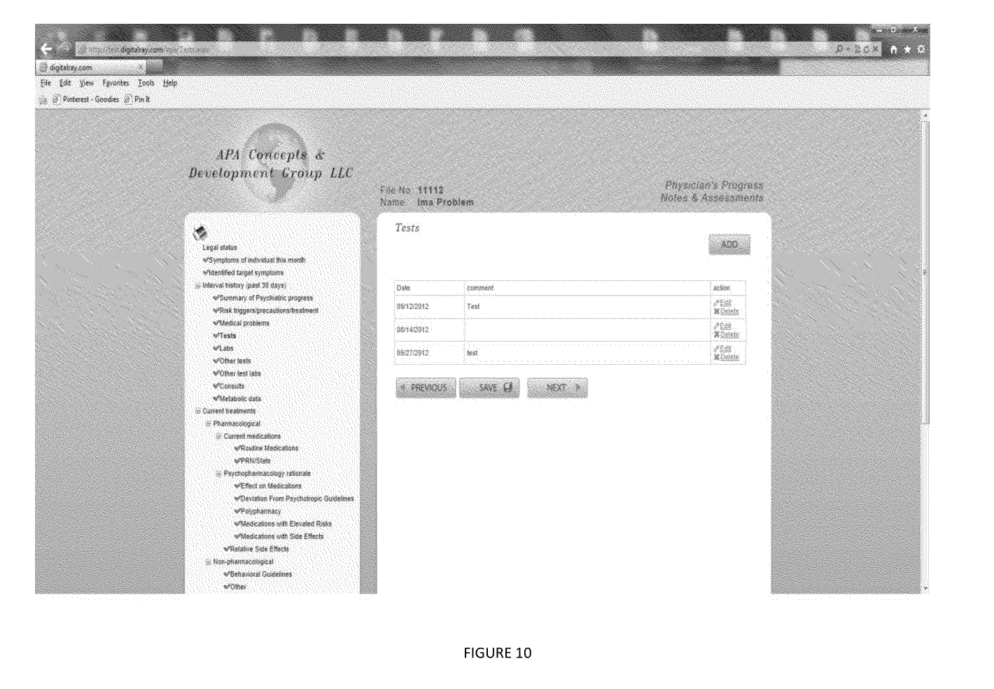

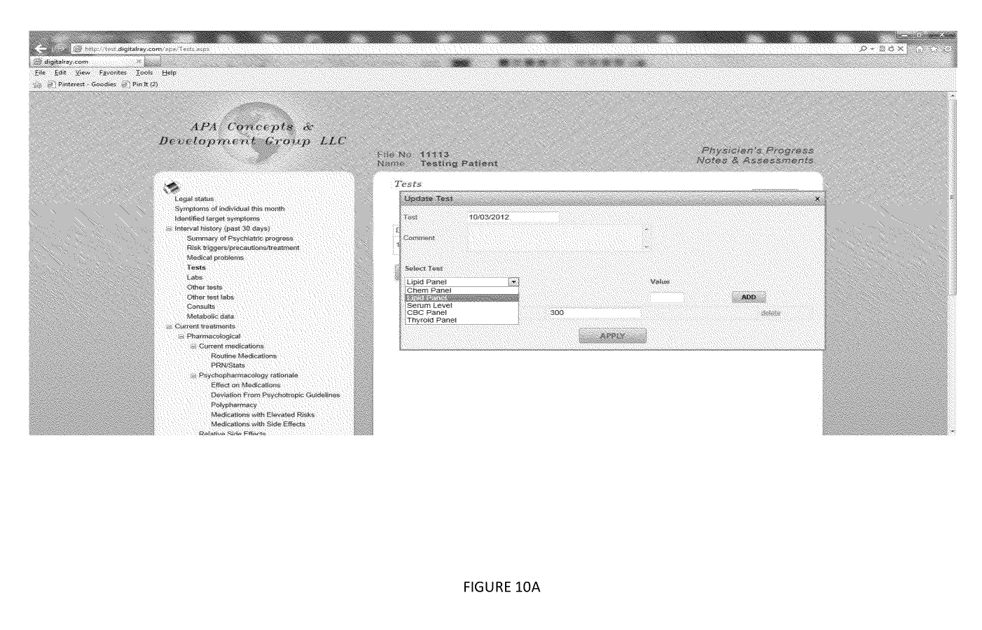

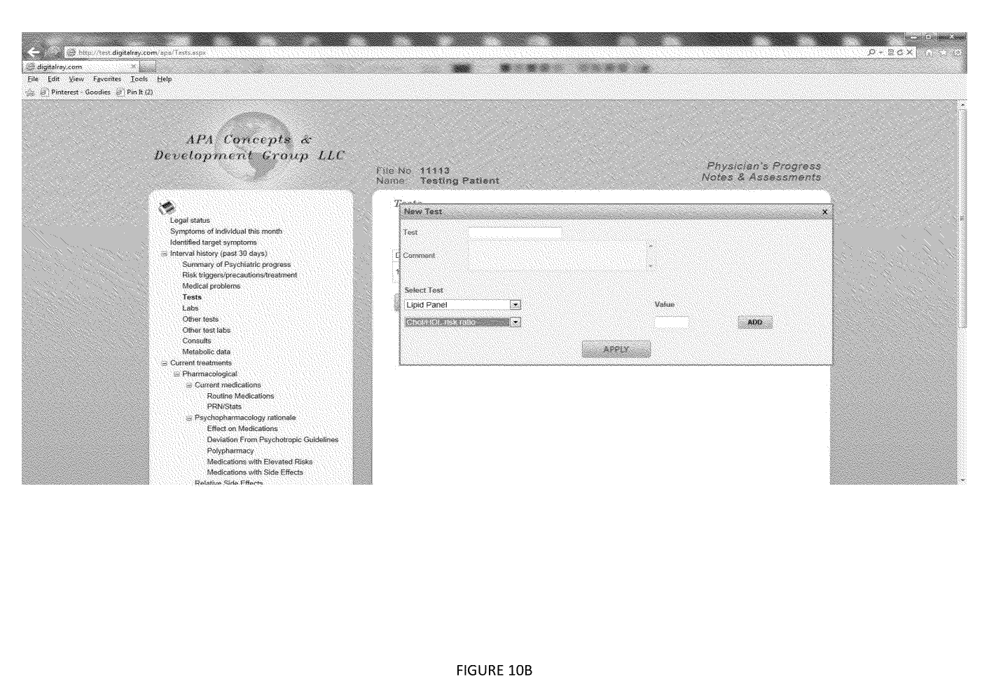

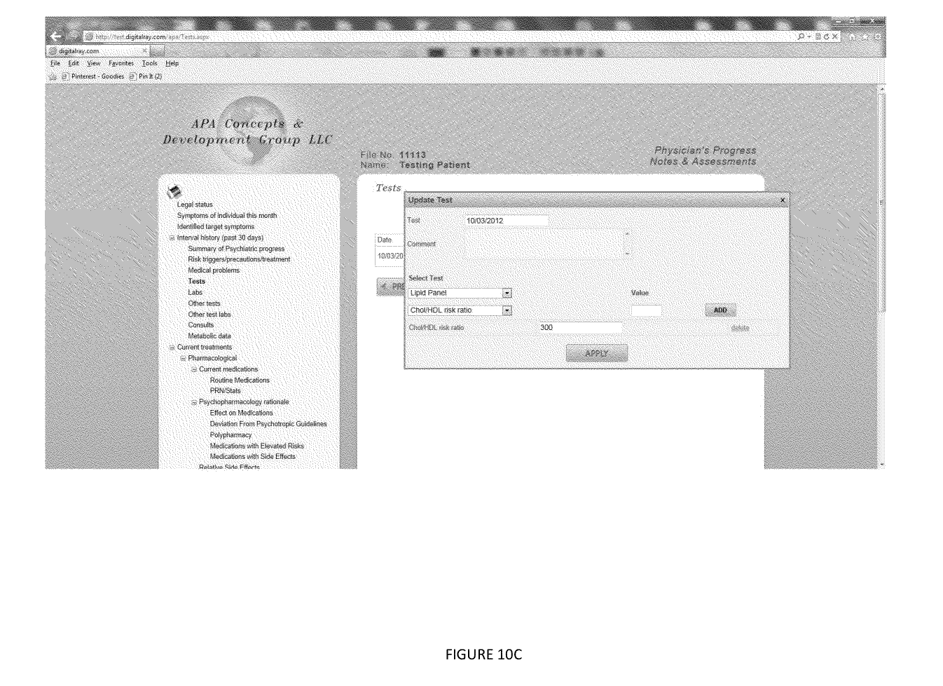

FIGS. 10, and 10A-10C are examples of a GUIs showing Tests, according to principles of the invention. In FIG. 10, a user may add a test for a patient (in this example, named ‘Ima Problem’) by mouse-clicking the ‘Add’ button, and then use a pop-up calendar (not shown) to enter the test date. The user may add any comments in text box (i.e., box labeled ‘Comment’). FIG. 10A is an example of a GUI showing a first dropdown, according to principles of the invention. In this GUI, the user has already mouse-clicked the ‘Add’ button (in FIG. 10), and here the user may select a panel of tests or serum level from the pull-down menu for a patient (in this example, named ‘Testing Patient’). FIG. 10B _is an example of a GUI showing a second dropdown, according to principles of the invention_In this GUI (FIG. 10B), the user has already mouse-clicked the ‘Add’ button (in FIG. 10), and has already selected a panel of tests or serum level from the pull-down menu (in FIG. 10A). Now, in this GUI of FIG. 10B, the user may select the specific test(s) they want to list and finally put in a lab value (i.e., field labeled ‘Value’). When the user then mouse-clicks the ‘Add’ button (FIG. 10B), the test and value will be listed on the screen. The client can then repeat the process as outlined in the above paragraphs for FIGS. 10A-10B, and continue to add tests and the lab value, which will then be added to the displayed list of tests and values. When the user is finished entering the tests and values, the client then can mouse-click ‘Apply’ and the test date will be saved and displayed on the prior screen, which can be edited or deleted as the client wishes. FIG. 10C is an example of a GUI showing an EDIT feature for Tests, according to principles of the invention. In this GUI of FIG. 10C, the user has previously selected a test to EDIT (from the GUI illustrated in FIG. 10), and may edit the data in the displayed fields, for example, to correct a data entry that was previously entered. Once the user has corrected or edited the data, the user may mouse-clicks the ‘APPLY’ button to save the data.

When the user then mouse-clicks or selects the ‘Add’ button, the test and value will be listed on the screen. The user can then repeat the process as outlined in the above paragraph, and continue to add tests and the lab value, which will then be added to the displayed list of tests and values. Once the user is finished entering the tests and values, the user then can mouse-click ‘Apply’ and the test date will be saved and displayed on the prior screen (which can be edited or deleted as the user wishes).

Once that is completed, the user may save the section by mouse-clicking the ‘Save’ button, and when ready to go onto the next section, the user can mouse-click the ‘Next’ button. Or the user can return to the prior section by mouse-clicking the ‘Previous’ button.

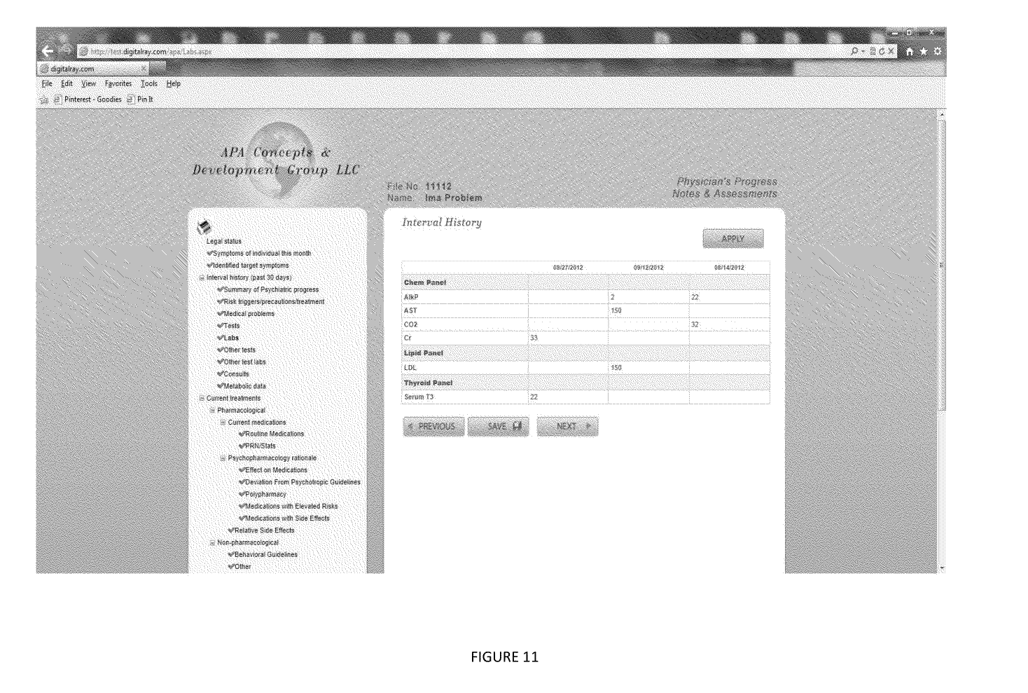

FIG. 11 is an example of a GUI showing Interval History, according to principles of the invention. This GUI is configures to allows a user to mouse-click the ‘Apply’ button to select the test dates, then it automatically enters the data into the table, with columns for each date.

Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

So, this GUI permits a user to quickly select whatever test dates are wanted, and project the data in a tabular form to allow the user to observe trends in the data.

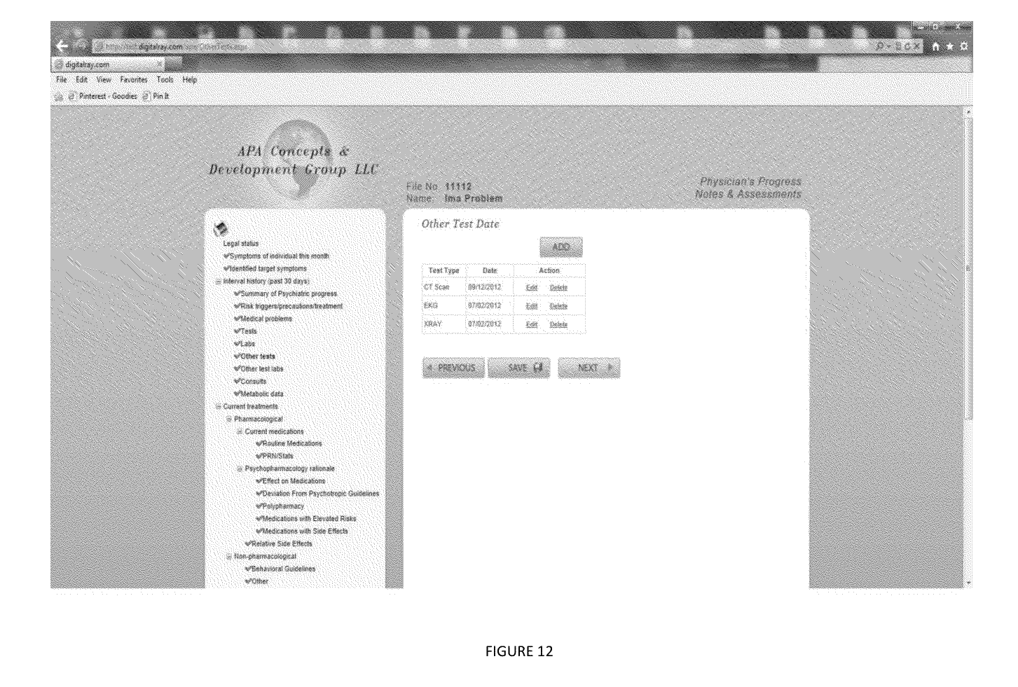

FIG. 12 is an example of a GUI showing Other Test Date, according to principles of the invention. This GUI and section may allow a user to pick which tests will be displayed in the document, and allows the user to pull up an individual test of a specific date and edit the information.

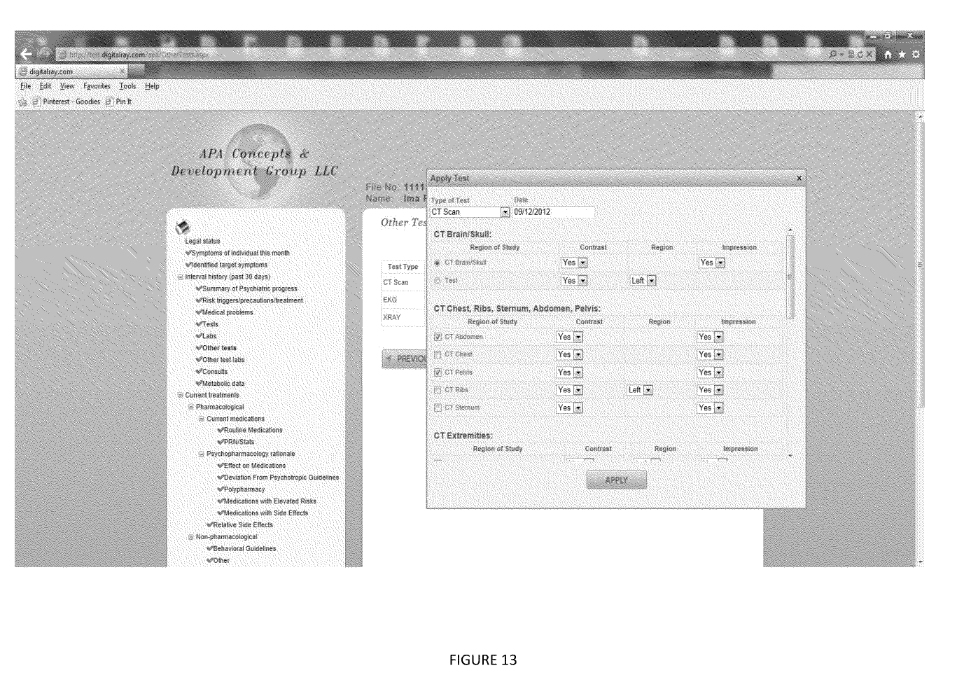

FIG. 13 is an example of a GUI showing Other Test Date, according to principles of the invention. This GUI and section allows a user to mouse-click the ‘Apply’ button to select the range of test dates of Other Tests (CT Scans, MRI Scans, etc.), by utilizing a pop-up Calendar, then the user can add in a new test or tests by type of test, pick the date of the test, the region of the test and add in impressions. Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button. So, what this GUI and section permits a user to quickly find a test by selecting a range of test dates, and add in new tests by type and region utilizing mouse-clicks instead of typing in the information.

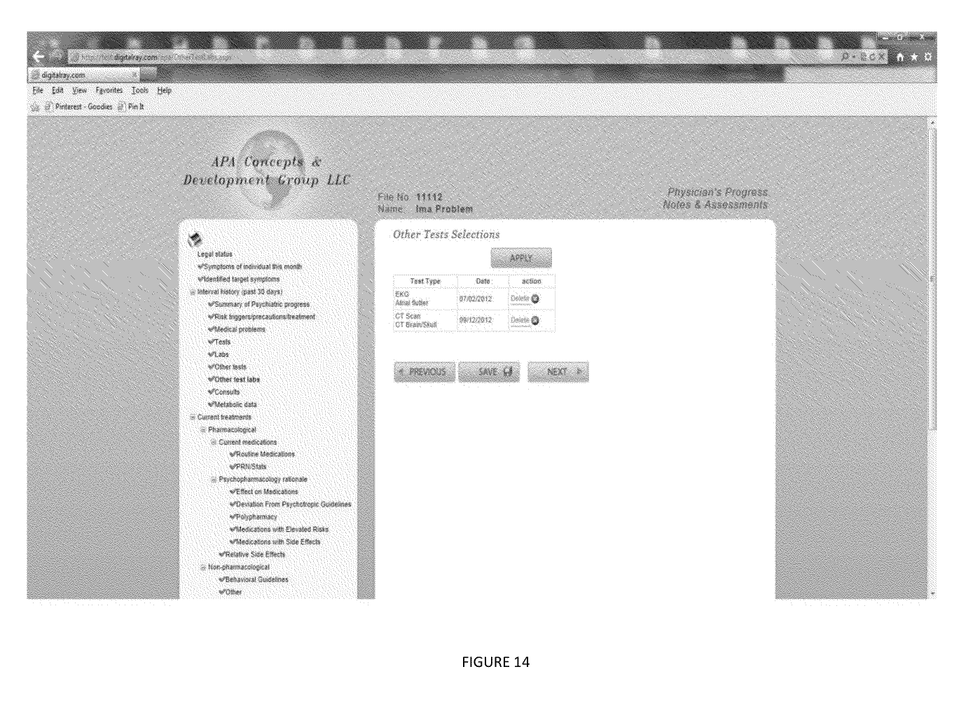

FIG. 14 is an example of a GUI showing Other Test Selections, according to principles of the invention. This section is configures to allow a user to mouse-click the ‘Apply’ button to select the range of test dates of Other Tests (CT Scans, MRI Scans, etc.), by utilizing a pop-up Calendar, then the user may search for tests by type of test pick from the list of tests performed during the selected period, delete specific tests already listed and display the resulting list of tests. Once that is completed, the user may save the section by mouse-clicking the ‘Save’ button, and when ready to go onto the next section, the user can mouse-click the ‘Next’ button. Or the user can return to the prior section by mouse-clicking the ‘Previous’ button.

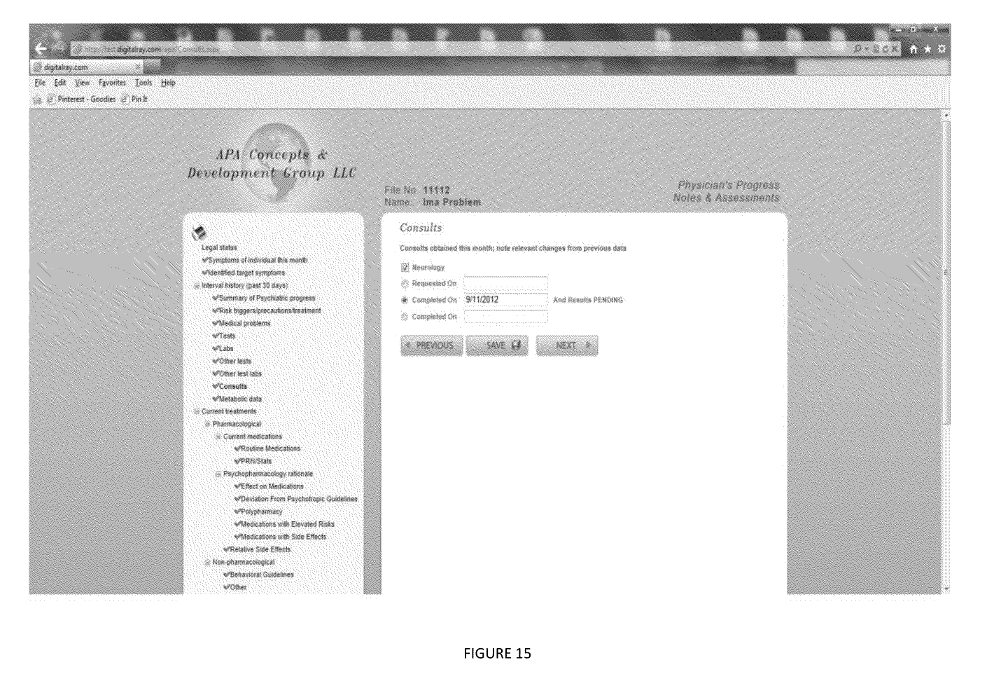

FIG. 15 is an example of a GUI showing Consults, according to principles of the invention. This GUI and section is configured to allow a user to mouse-click a type of consult, then mouse-click whether the consult is being requested, was done and results pending or if the consult was completed. In each case, the user may use the pop-up calendar to supply the date of the consult request or completion. Once that is completed, the user may save the section by mouse-clicking the ‘Save’ button, and when ready to go onto the next section, the user can mouse-click the ‘Next’ button. Or the user may return to the prior section by mouse-clicking the ‘Previous’ button.

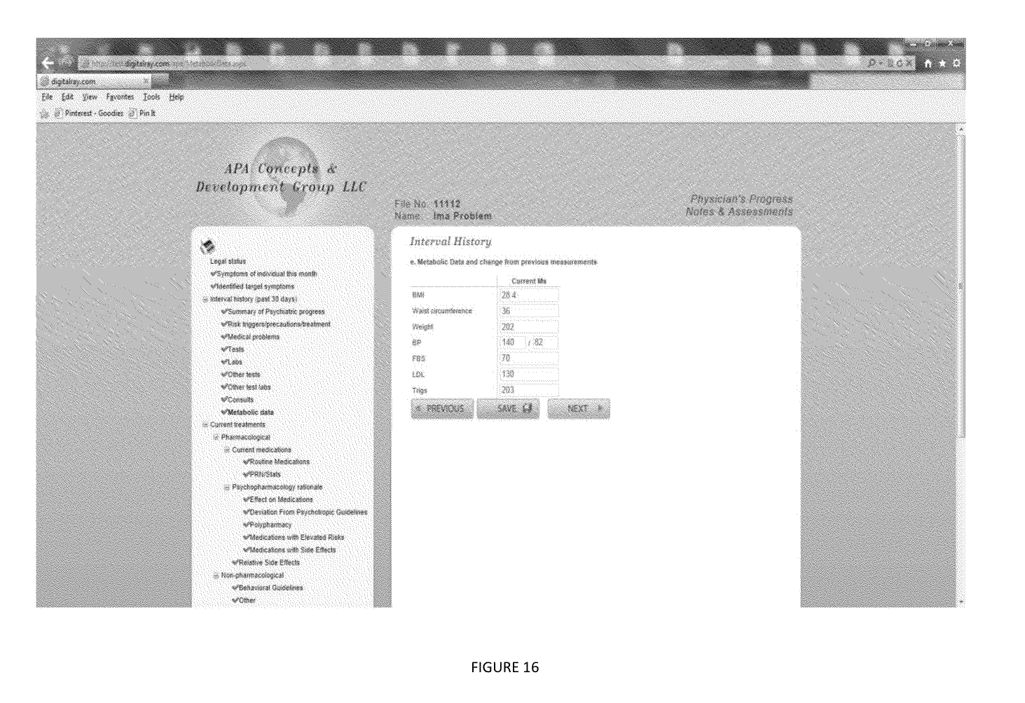

FIG. 16 is an example of a GUI showing Interval History—Metabolic panel, according to principles of the invention. This GUI and section is configured to allow a user to enter the patient's current BMI, waist circumference, weight, blood pressure (BP), fasting blood sugar (FBS), low density lipoproteins (LDL) and triglycerides (Trigs). Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

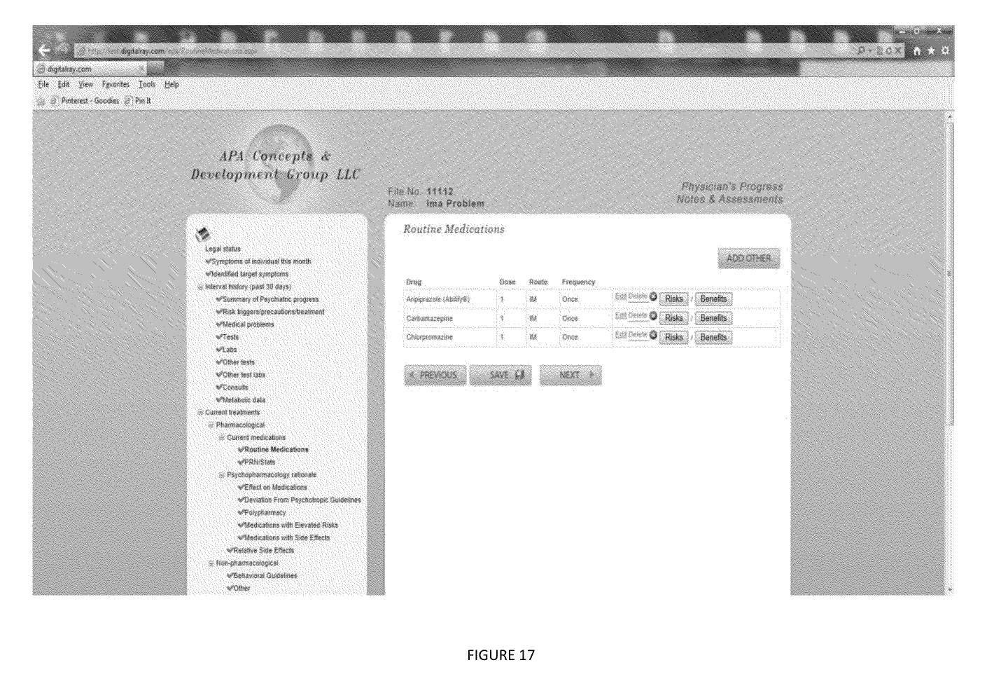

FIG. 17 is an example of a GUI showing Routine Medications, according to principles of the invention. This GUI section is configured to allow a user to display the patient's current medications. For a new patient, the user may add in the medications by clicking the ‘Add Other’ button and adding in the medications individually. For an existing patient, the user may delete the medications (listed on screen) that are no longer applicable and utilize the ‘Add Other’ button to add in new medications. This feature is unique in that the medication names, dose, route and frequency can all be entered with a mouse-click.

Once that is completed, the user may save the section by mouse-clicking the ‘Save’ button, and when ready to go onto the next section, the user can mouse-click the ‘Next’ button. Or the user may return to the prior section by mouse-clicking the ‘Previous’ button.

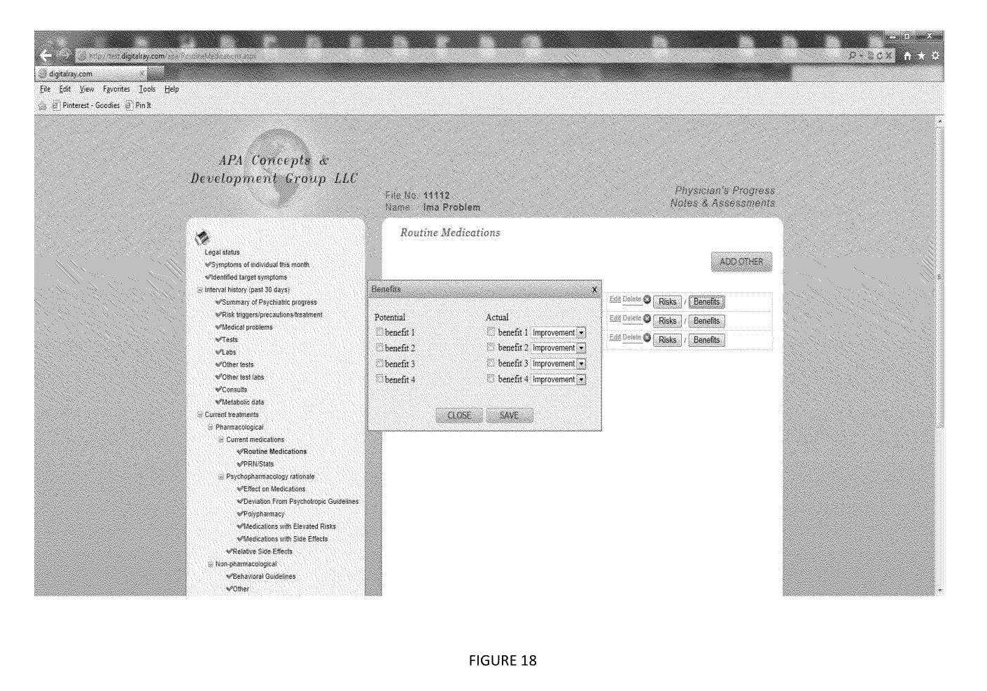

FIG. 18 is an example of a GUI showing Routine Medications—Risk/Benefit, according to principles of the invention. This GUI and section is configured to allow a user to select both applicable risks and benefits of each medication listed on the screen. Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

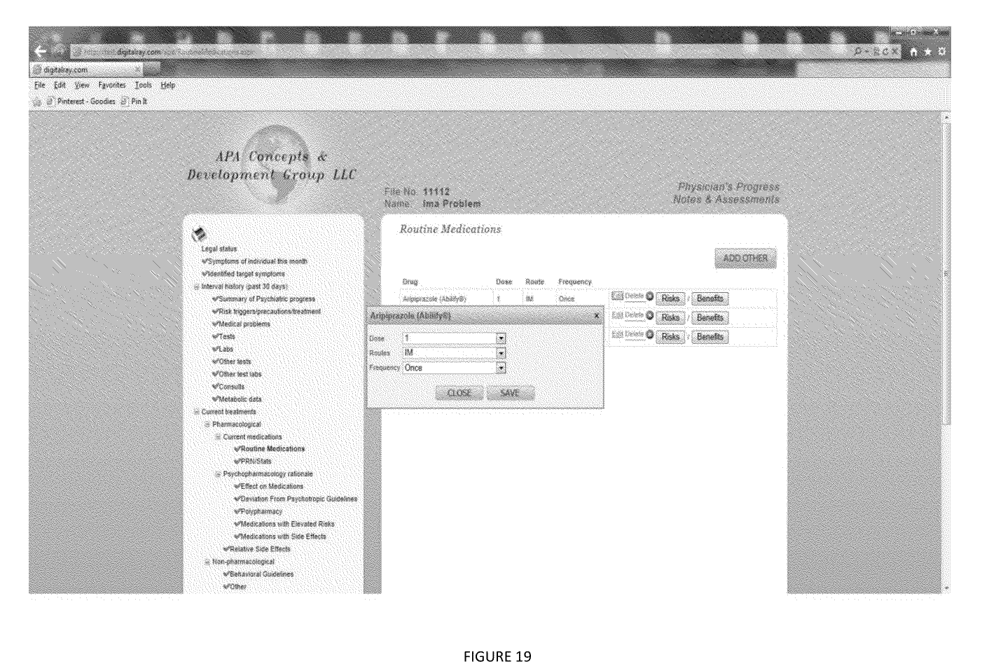

FIG. 19 is an example of a GUI showing Routine Medications, according to principles of the invention. This GUI and section is configured to allow a user to select and then edit medications in the drug list, including the risks and benefits of the selected medication, utilizing the ‘Risk/Benefit’ button or delete a currently displayed drug using the ‘Delete’ button. Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

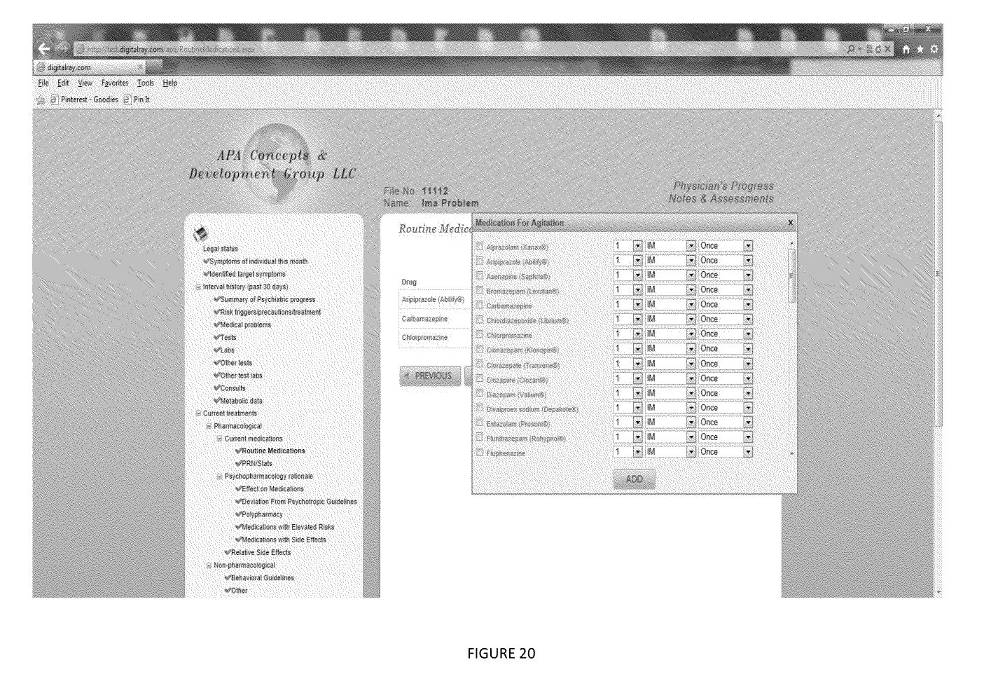

FIG. 20 is an example of a GUI showing Routine Medications, according to principles of the invention. This GUI and section is configured to allow a user to add a new drug using the ‘Add Other’ button; the user can modify the dose, route and/or frequency of any medication listed on the screen. The user may continue to add additional drugs by repeating this sequence.

Once that is completed, the user may save the section by mouse-clicking the ‘Save’ button, and when ready to go onto the next section, the user can mouse-click the ‘Next’ button. Or the user may return to the prior section by mouse-clicking the ‘Previous’ button.

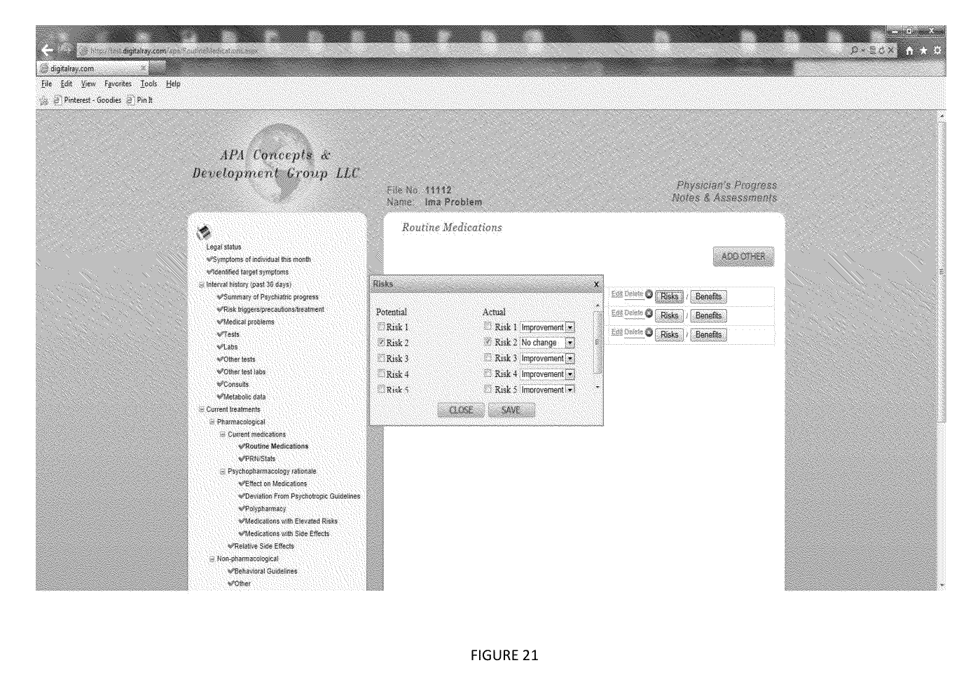

FIG. 21 is an example of a GUI showing Routine Medications, according to principles of the invention. This GUI and section is configured to allow a user to select and then edit the risks and benefits of the selected medication, utilizing the ‘Risk/Benefit’ button PRN/Stat medications in the drug list. Once that is completed, the user may save the section by mouse-clicking the ‘Save’ button, and when ready to go onto the next section, the user can mouse-click the ‘Next’ button. Or the user may return to the prior section by mouse-clicking the ‘Previous’ button.

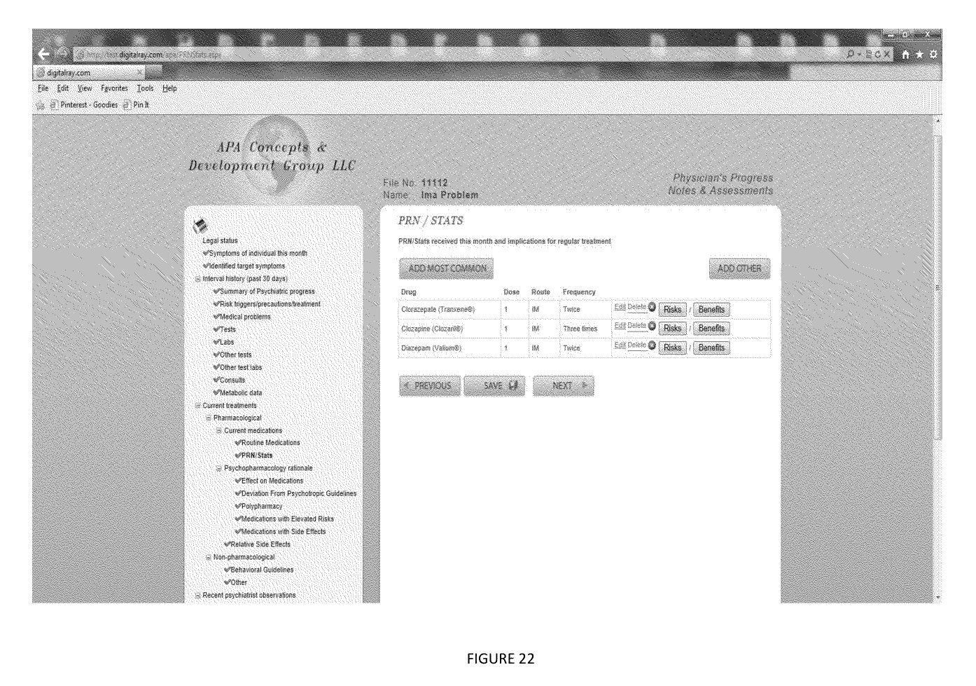

FIG. 22 is an example of a GUI showing PRN/STATS Medications, according to principles of the invention. This is a display of the list of PRN/Stat medications currently being prescribed for the patient. The GUI and section allows a user to select and then edit PRN/Stat medications in the drug list, including the risks and benefits of the selected medication, utilizing the ‘Risk/Benefit’ button or delete a currently displayed drug using the ‘Delete’ button. Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

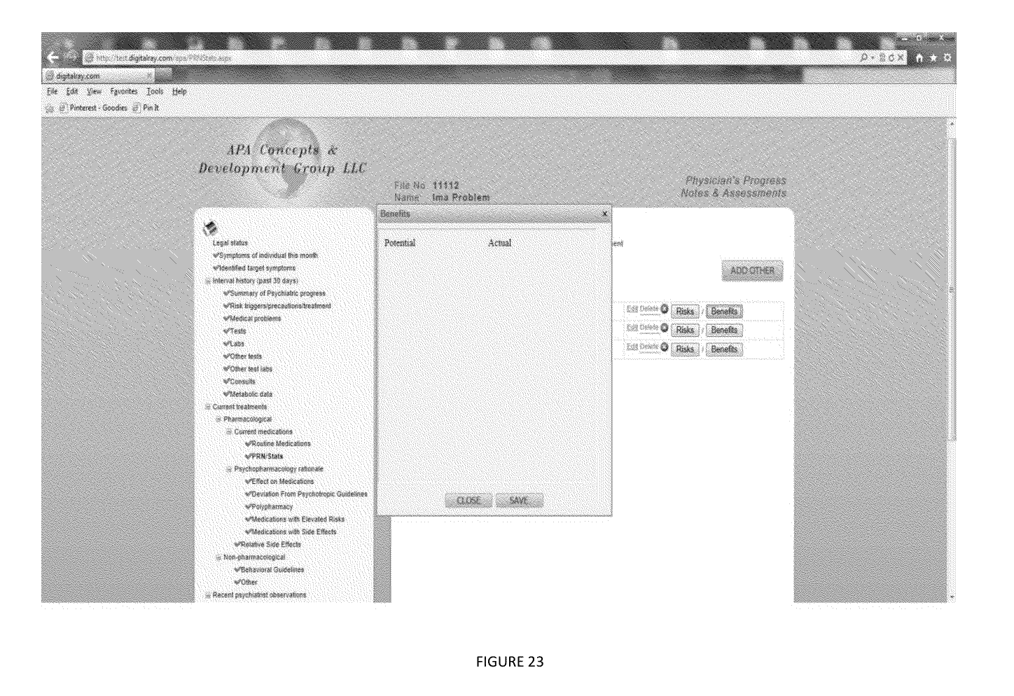

FIG. 23 is an example of a GUI showing Routine Medications, according to principles of the invention. This GUI and section allows a user to select and then edit the risks and benefits of the selected PRN/Stat medication, utilizing the ‘Risk/Benefit’ button. Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

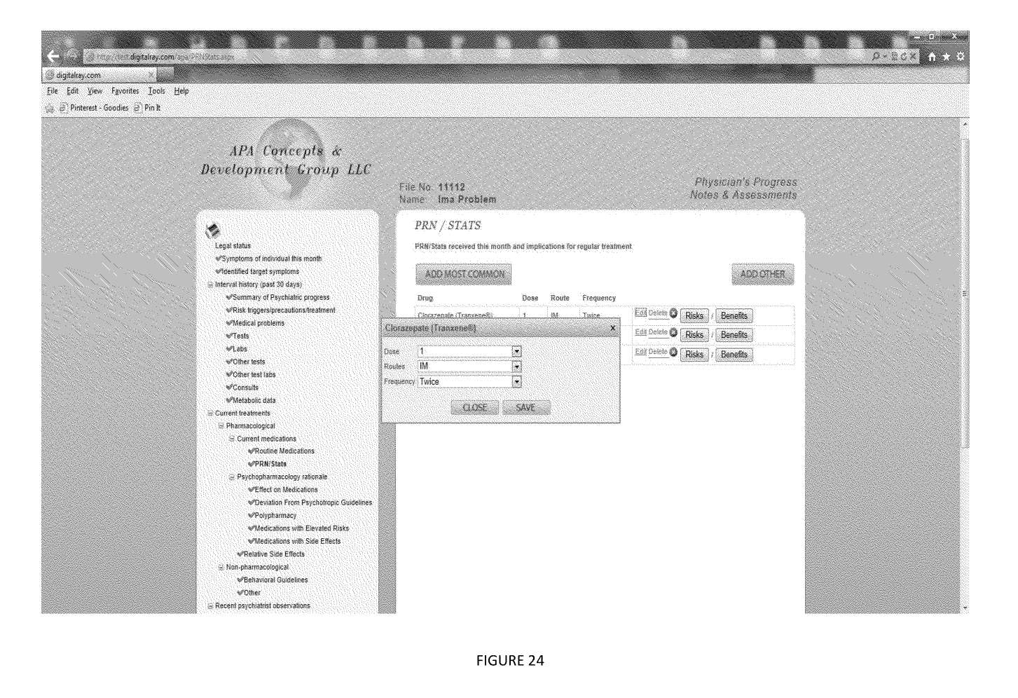

FIG. 24 is an example of a GUI showing PRN/Stats, according to principles of the invention. This GUI and section is configured to allow a user to select and then edit medications in the drug list, regarding dose, route and frequency. Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

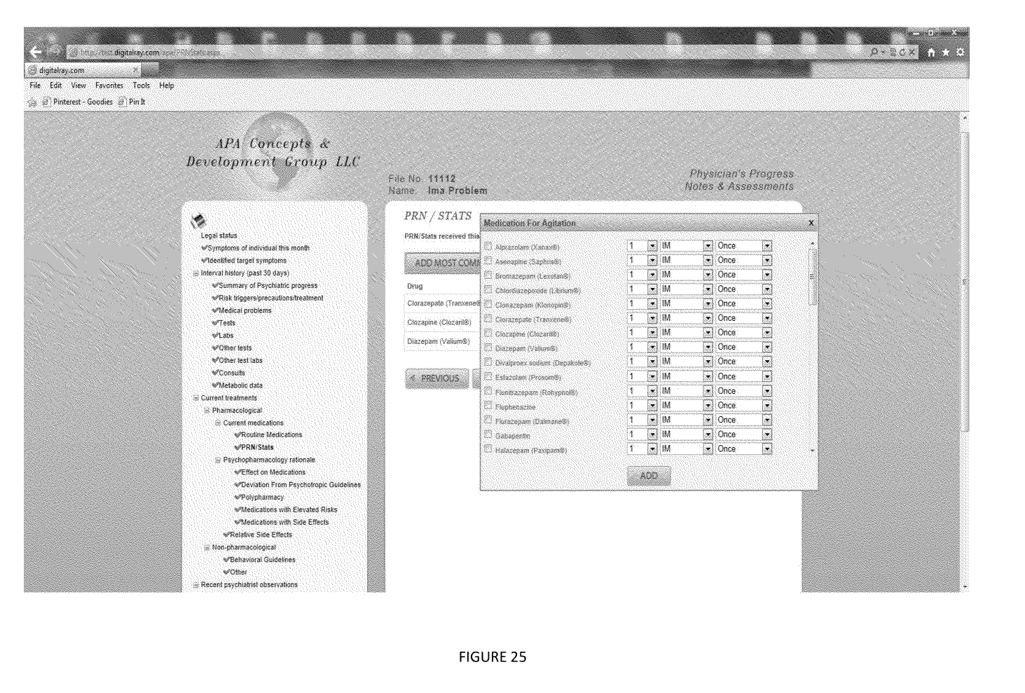

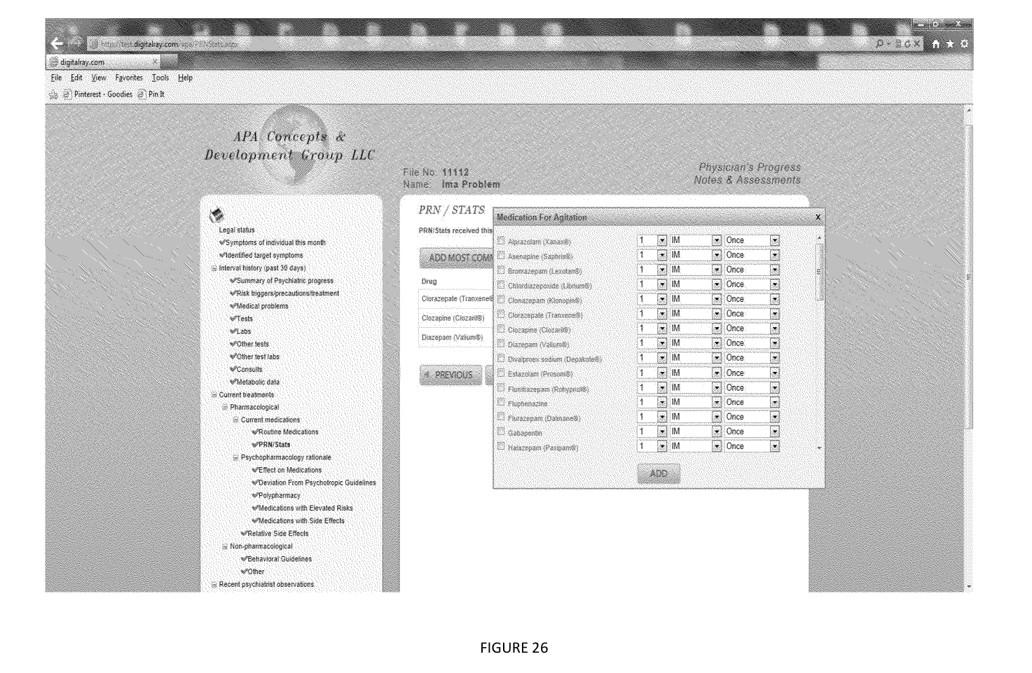

FIGS. 25 and 26 are an example of a GUI showing PRN/Stats, according to principles of the invention. This GUI and section is configured to allow a user to add a new PRN/Stat drug using the ‘Add Other’ button; the user can modify the dose, route and/or frequency of any medication listed on the screen. The user may continue to add additional drugs by repeating this sequence. Once that is completed, the user may save the section by mouse-clicking the ‘Save’ button, and when ready to go onto the next section, the user may mouse-click the ‘Next’ button. Or the user can return to the prior section by mouse-clicking the ‘Previous’ button.

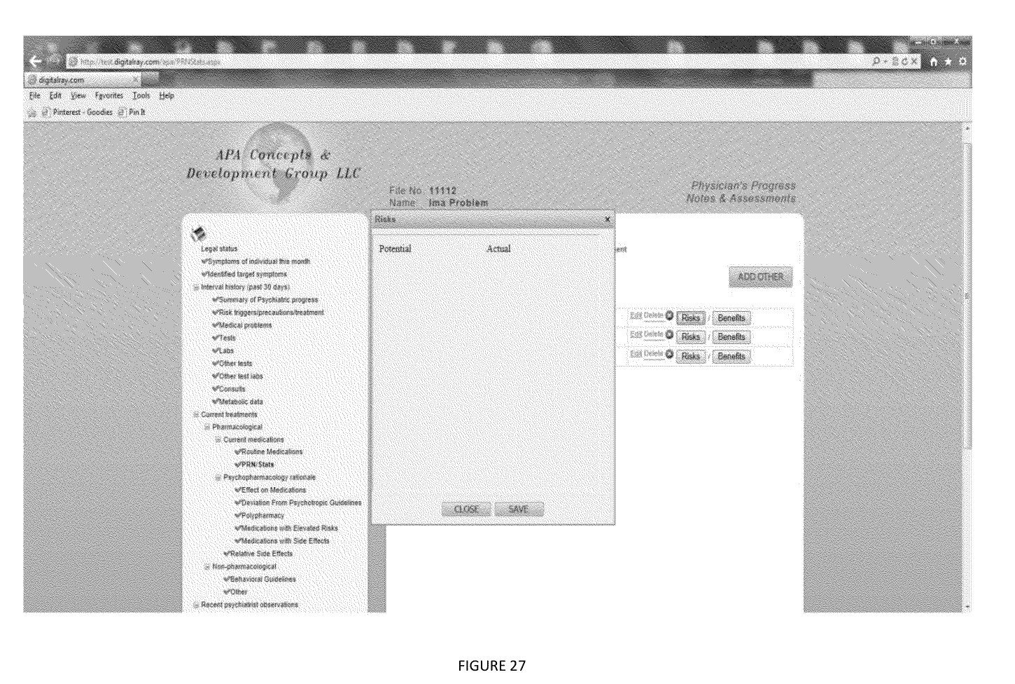

FIG. 27 is an example of a GUI showing PRN/Stat Medications, according to principles of the invention. This GUI and section is configured to allow a user to select and then edit PRN/Stat medications in the drug list, including the risks and benefits of the selected medication, utilizing the ‘Risk/Benefit’ button or delete a currently displayed drug using the ‘Delete’ button.

Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

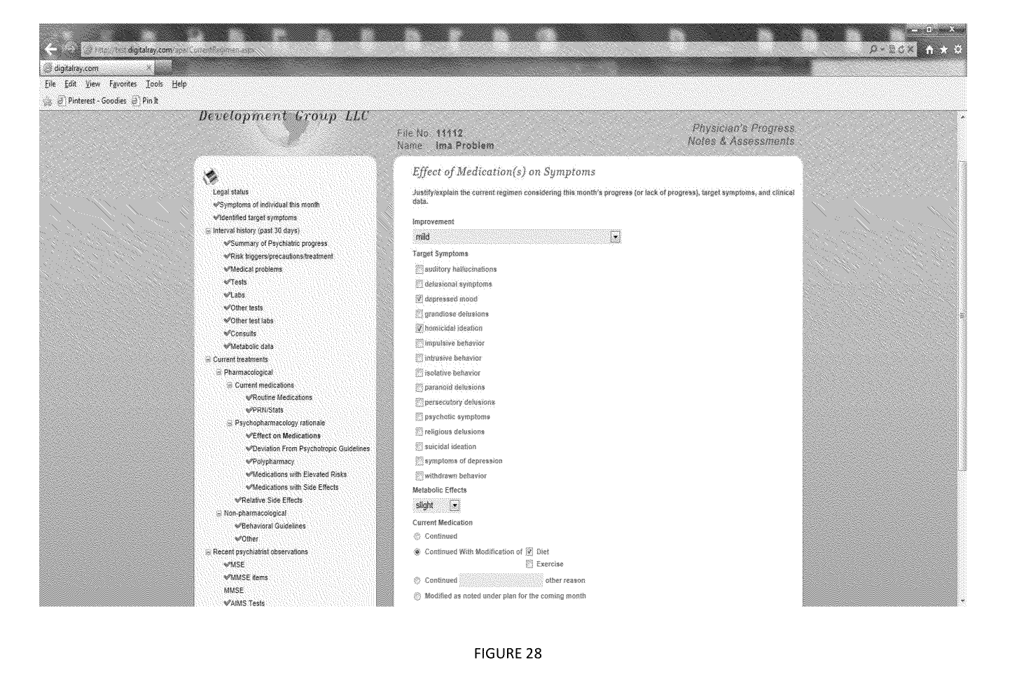

FIG. 28 is an example of a GUI showing Effect of Medications on Symptoms, according to principles of the invention. This GUI and section is configured to allow a user to select the level of improvement from a pull-down menu and then select the symptoms which are being described. In this example, Improvement has 7 selections, Target Symptoms has 15 selections, Metabolic Effects has 6 selections and Current Medication has 4 selections.

Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

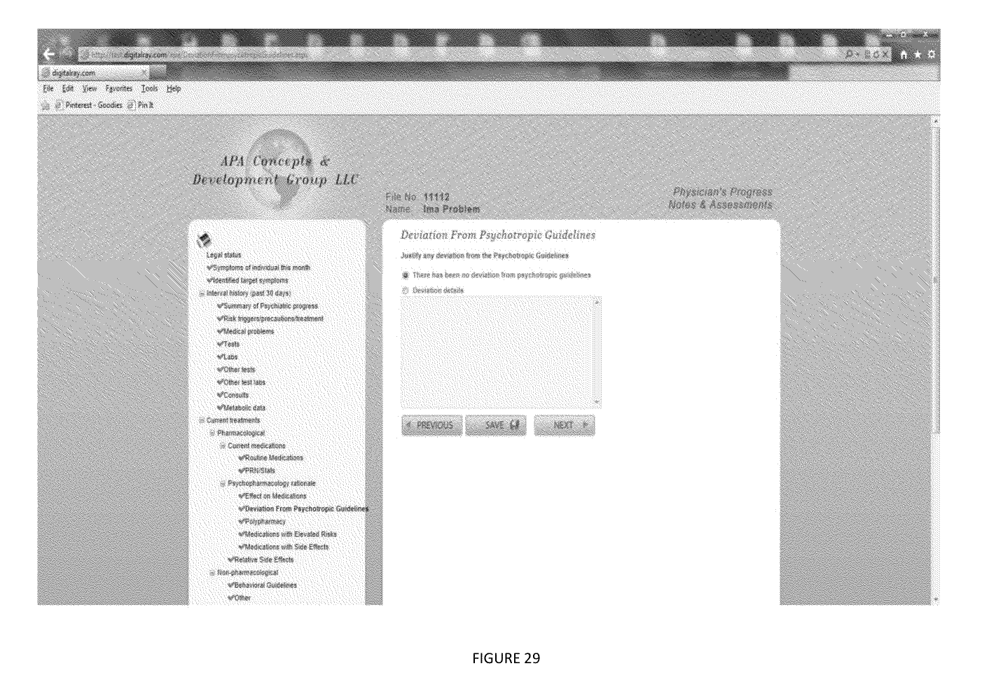

FIG. 29 is an example of a GUI showing Deviation from Psychotropic Guidelines, according to principles of the invention. This GUI and section allows a user to select either that there has been no deviation, or utilize a text box to comment on the deviation. Once that is completed, the user may save the section by mouse-clicking the ‘Save’ button, and when ready to go onto the next section, the user can mouse-click the ‘Next’ button. Or the user can return to the prior section by mouse-clicking the ‘Previous’ button.

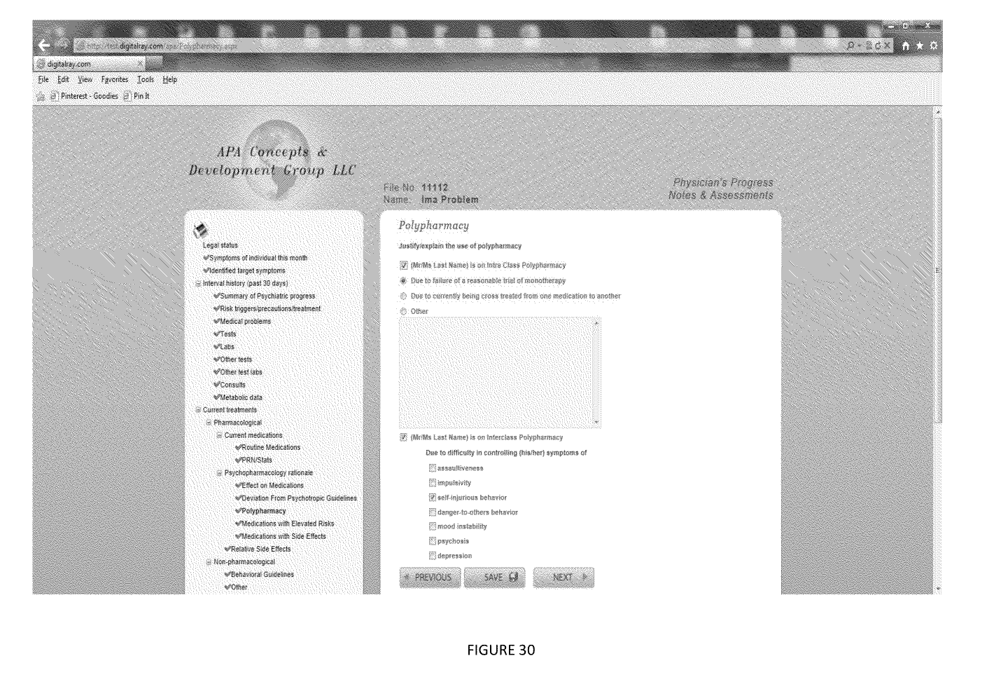

FIG. 30 is an example of a GUI showing Polypharmacy, according to principles of the invention. This GUI and section allows a user to select whether the patient is on intraclass polypharmacy by checking the checkbox; if the patient is on intraclass polypharmacy, then the user can select the reason for this from a selection of one of 2 standardized choices or use a textbox to type in the reasoning. This GUI and section also allows a user to select whether the patient is on interclass polypharmacy by checking the checkbox; if the patient is on intraclass polypharmacy, then the user can select the reason(s) for this from a selection of 7 standardized choices. Once this is completed, the user can save the section by mouse-clicking the ‘Save’ button, and when ready to go onto the next section, the user can mouse-click the ‘Next’ button. Or the user can return to the prior section by mouse-clicking the ‘Previous’ button.

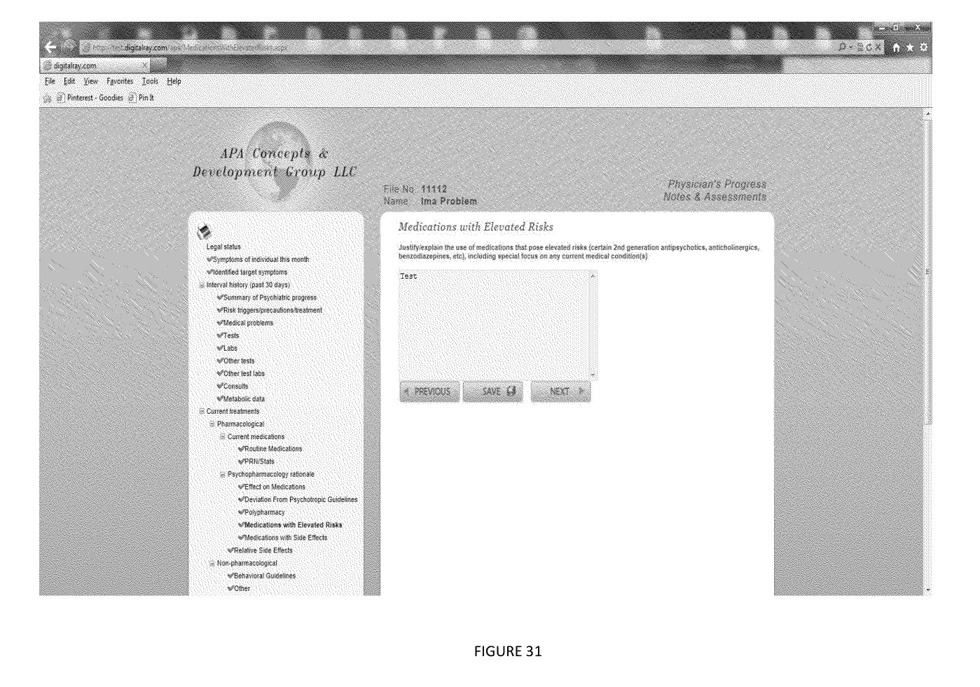

FIG. 31 is an example of a GUI showing Medications with Elevated Risks, according to principles of the invention. This GUI and section is configured to allow a user to justify/explain the use of medications that pose elevated risks, utilizing a textbox. Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

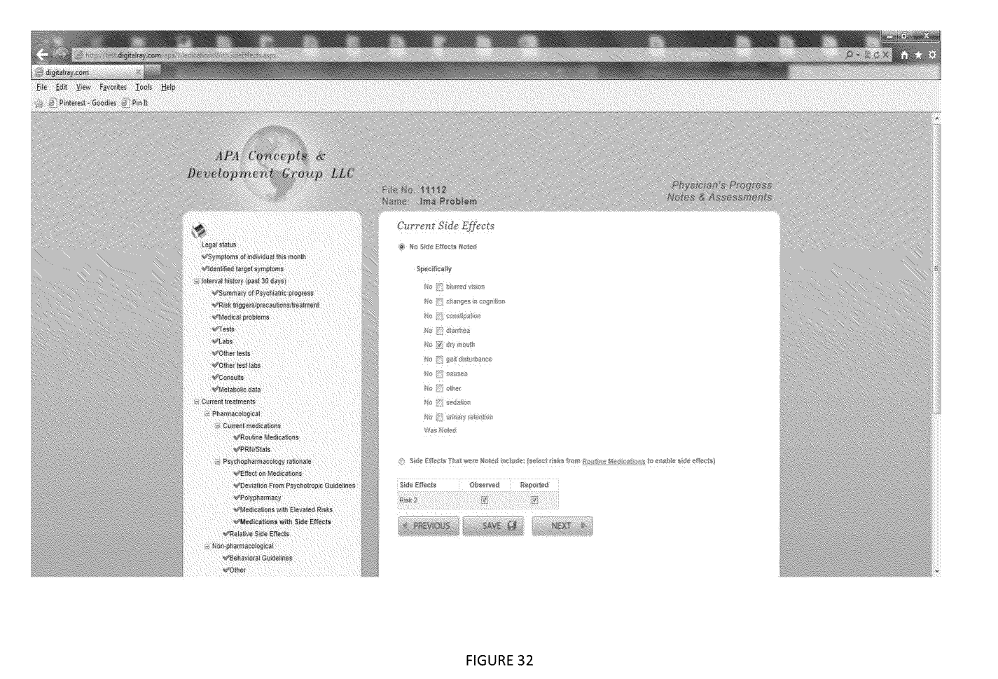

FIG. 32 is an example of a GUI showing Current Side Effects, according to principles of the invention. This GUI section is configured to allow a user to select either that there are no side effects or that there are side effects; these are the ‘radio buttons.’ If ‘No Side Effects Noted’ is specified, the user can then specify up to 10 descriptors of side effects that were specifically not noted. If ‘Side Effects That Were Noted include’ is specified, the user can then select which side effects were Observed and/or Reported, selecting from a list that is generated by the software program from the Routine Medications that were prescribed previously in the software program. Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

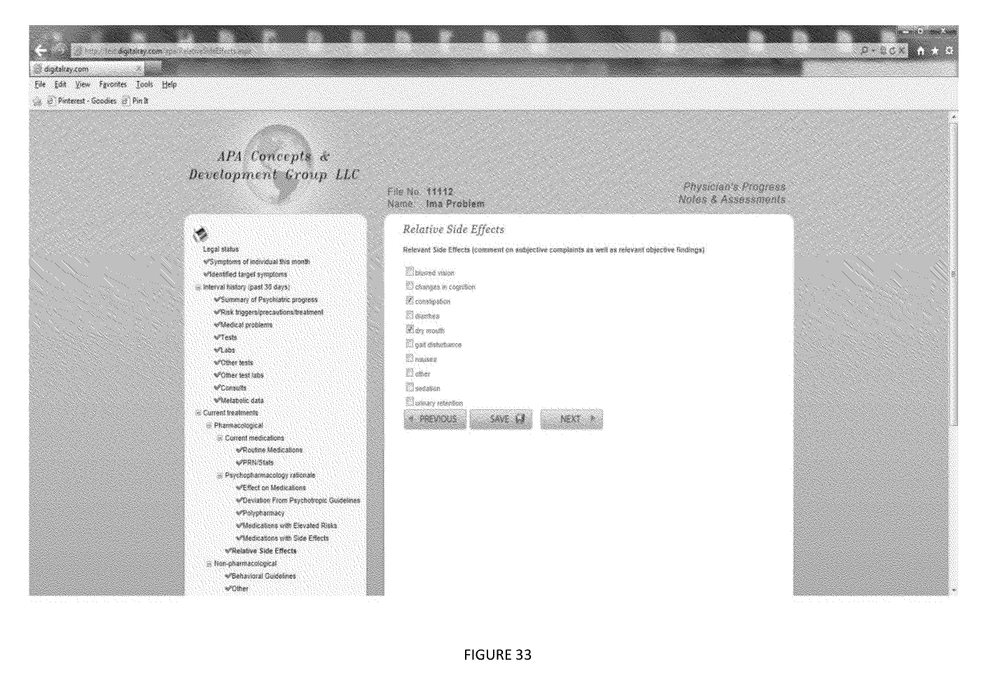

FIG. 33 is an example of a GUI showing relative side effects, according to principles of the invention. This GUI and section is configured to allow a user to select relevant side effects that may be commonly observed; in this manner, the user is reminded to pay attention to side effects common with benzodiazepines and anti-cholinergic medications in particular.

Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

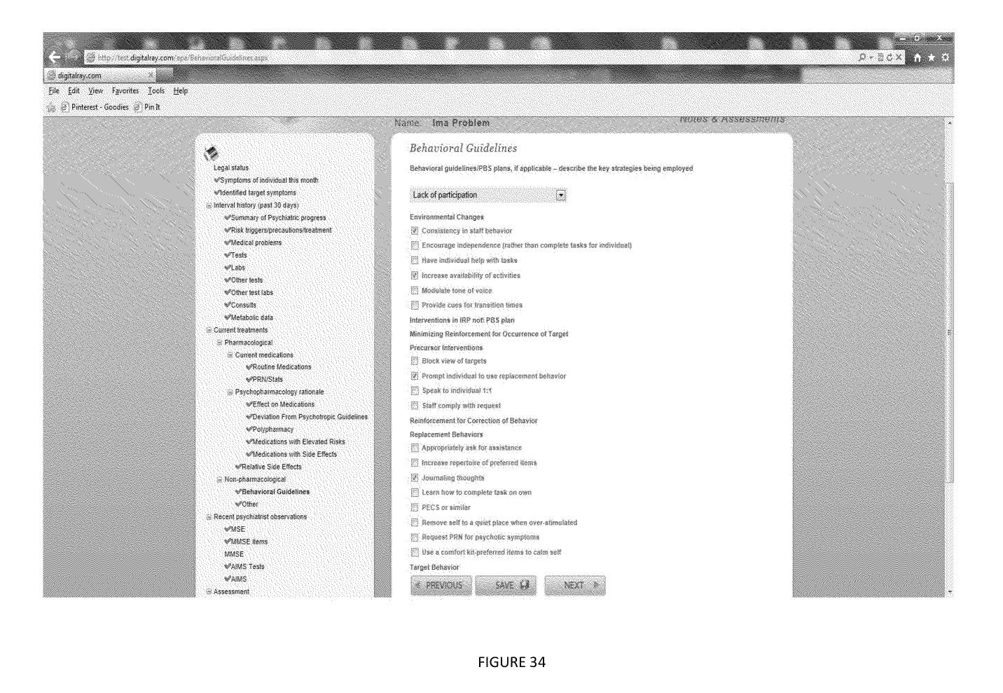

FIG. 34 is an example of a GUI showing Behavioral Guidelines, according to principles of the invention. This GUI and section allows a user to select a behavior from 7 selections in the pull-down menu (such as Lack of Participation).

Then the user can select from among:
a. 7 selections regarding Environmental Changes, and/or
b. 4 selections of Interventions in WRP not\ PBS plan, Minimizing Reinforcement for Occurrence of Target
c. Precursor Interventions, and/or
d. 8 selections of Reinforcement for Correction of Behavior Replacement Behaviors

Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

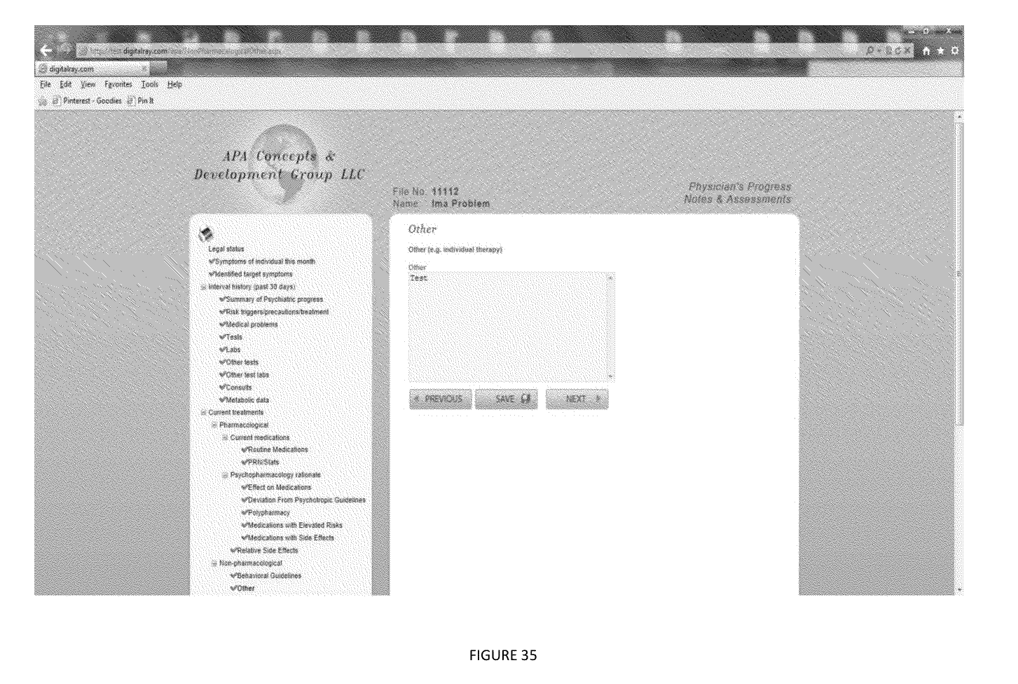

FIG. 35 is an example of a GUI showing Other, according to principles of the invention. This GUI and section allows a user to utilize a textbox to type in any other therapy(s) being utilized (for example, Individual Therapy). Once that is completed, the user can save the section by mouse-clicking the ‘Save’ button, and when ready to go onto the next section, the user can mouse-click the ‘Next’ button. Or the user can return to the prior section by mouse-clicking the ‘Previous’ button.

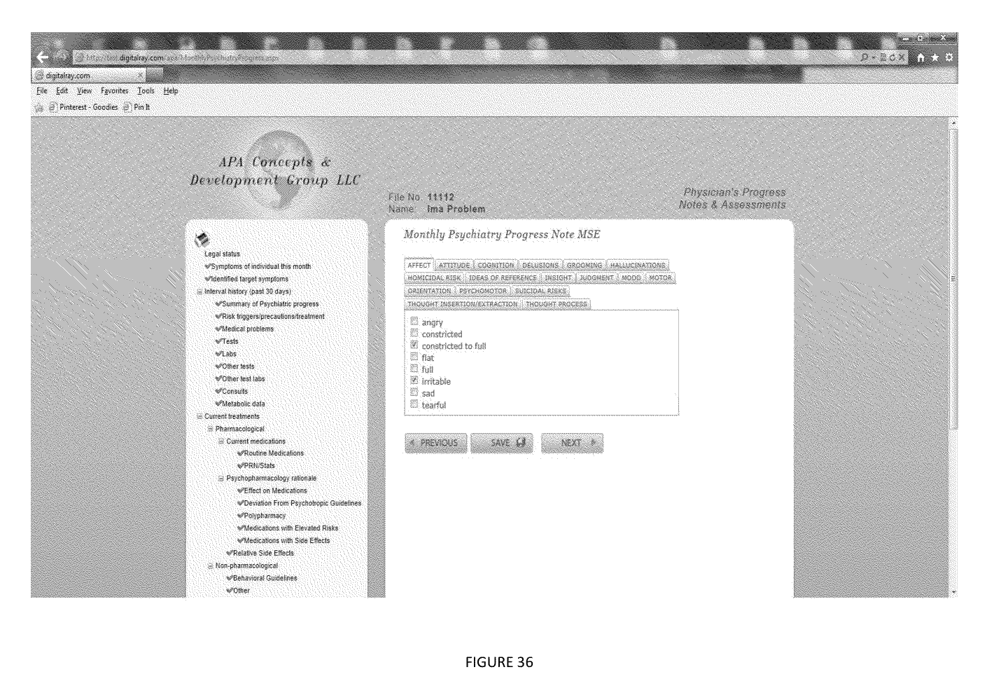

FIG. 36 is an example of a GUI showing Monthly Psychiatry Progress Note MSE, according to principles of the invention. This screenshot illustrates the MSE sections in a tab form. The tab selected in this GUI example is ‘Affect.’ The user has 8 choices to select from to describe the patient's affect. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

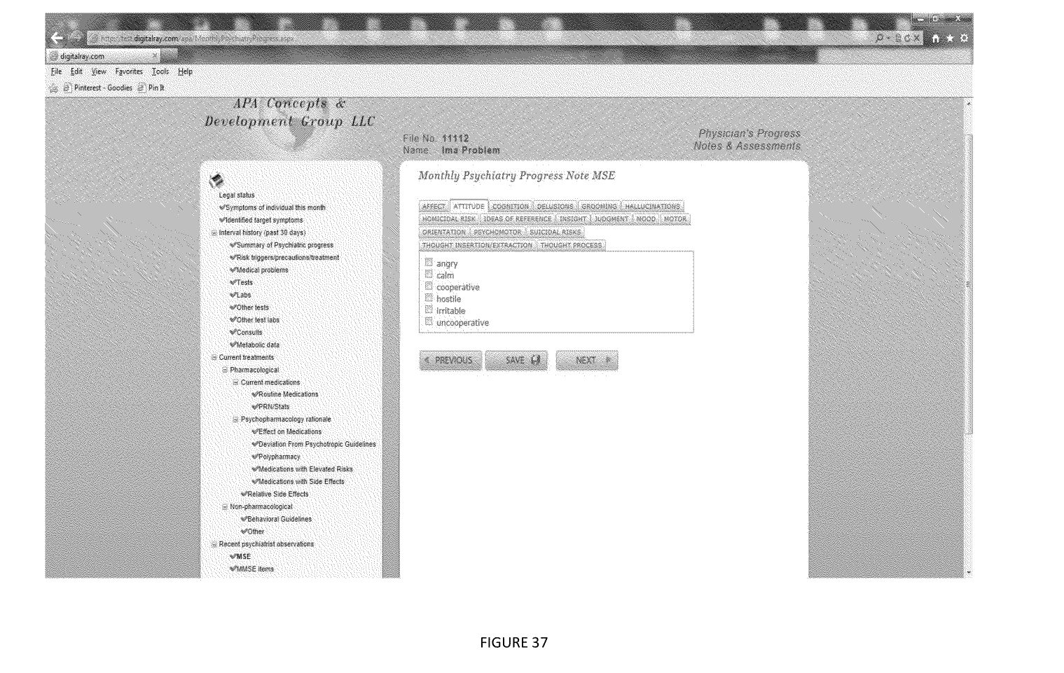

FIG. 37 is an example of a GUI showing Monthly Psychiatry Progress Note MSE, according to principles of the invention. This GUI illustrates the MSE sections in a tab form. The tab selected in this screenshot is ‘Attitude.’ The user has 6 choices to select from to describe the patient's attitude. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

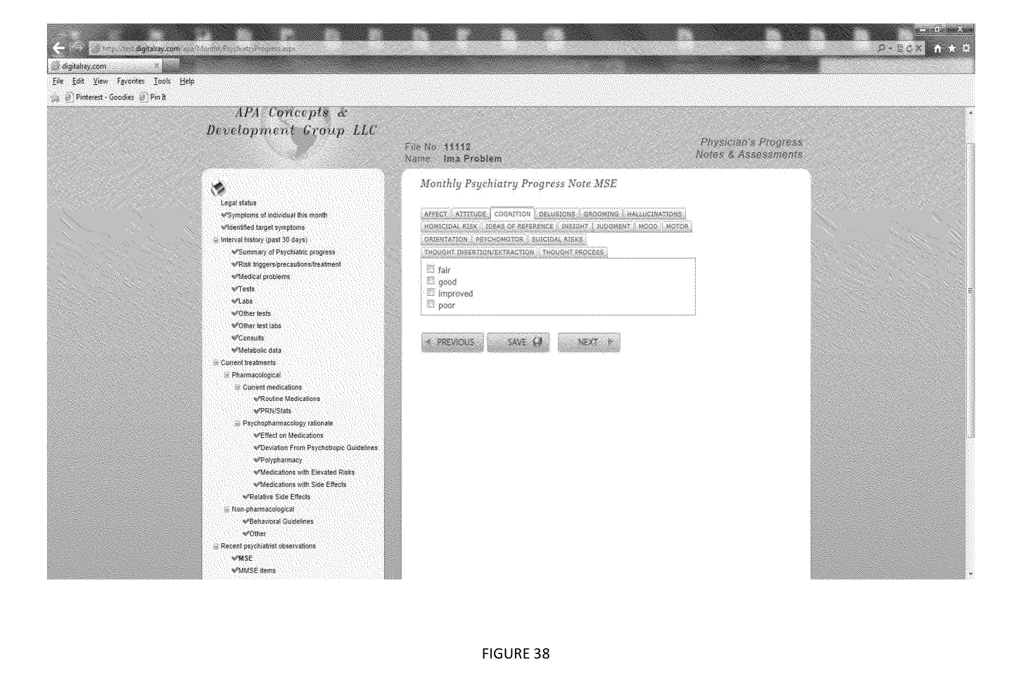

FIG. 38 is an example of a GUI showing Monthly Psychiatry Progress Note MSE, according to principles of the invention. This GUI illustrates the MSE sections in a tab form. The tab selected in this screenshot is ‘Cognition.’ The user has 4 choices to select from to describe the patient's cognition. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

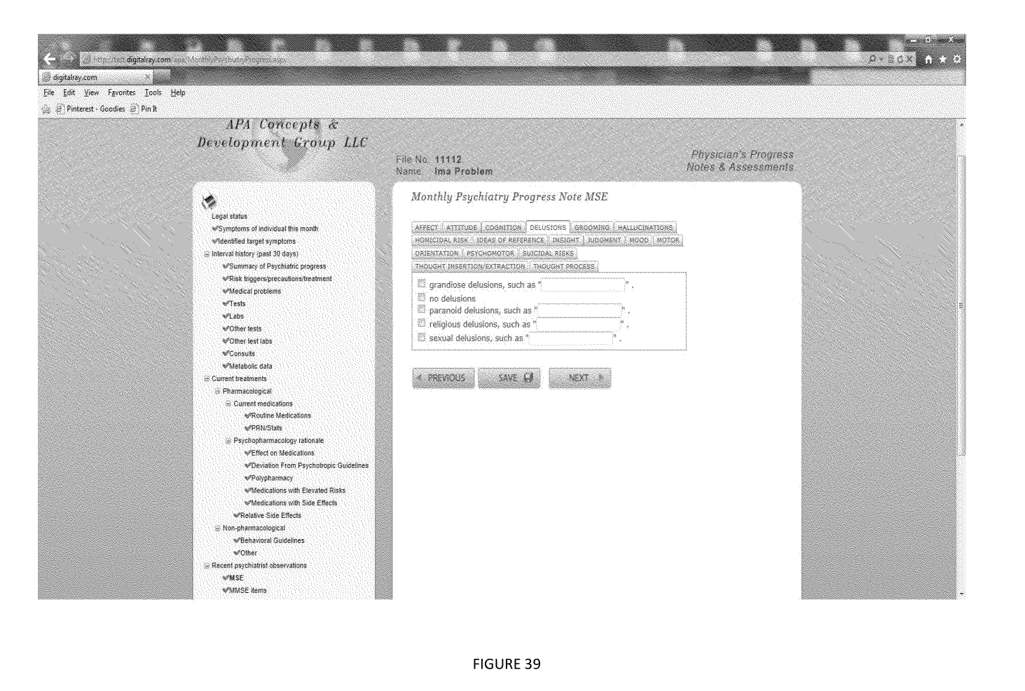

FIG. 39 is an example of a GUI showing Monthly Psychiatry Progress Note MSE, according to principles of the invention. This GUI illustrates the MSE sections in a tab form. The tab selected in this screenshot is ‘Delusions.’ The user has 5 choices to select from to describe the patient's delusions, of which 4 choices allow the user to add a further description in an associated textbox. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

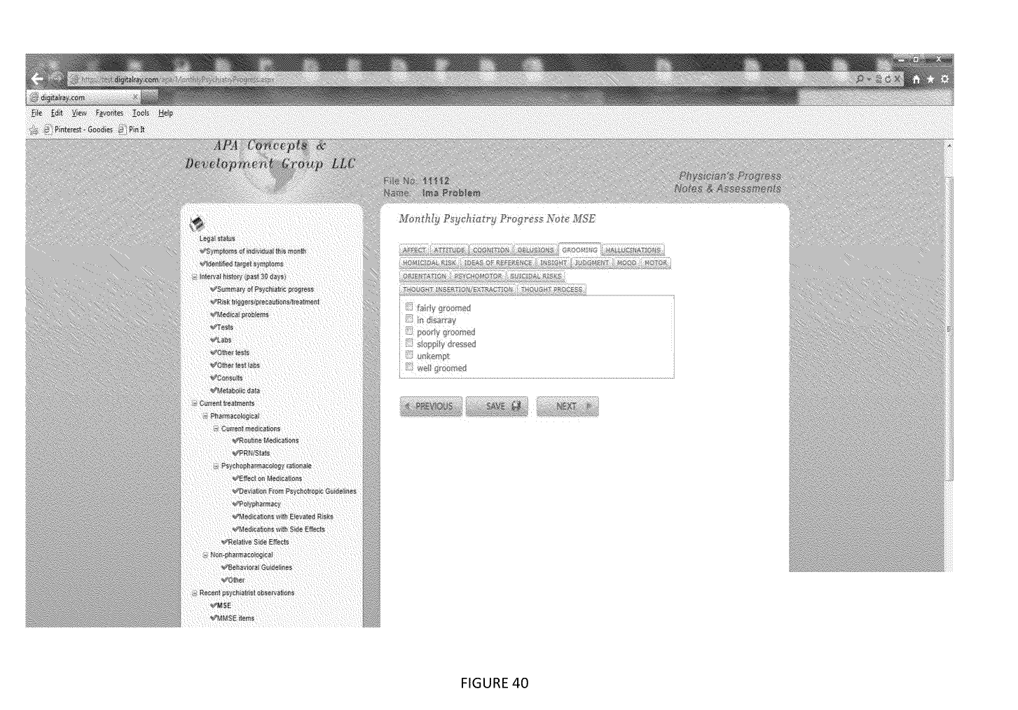

FIG. 40 is an example of a GUI showing Monthly Psychiatry Progress Note MSE, according to principles of the invention. This GUI illustrates the MSE sections in a tab form. The tab selected in this screenshot is ‘Grooming.’ The user has 6 choices to select from to describe the patient's grooming. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

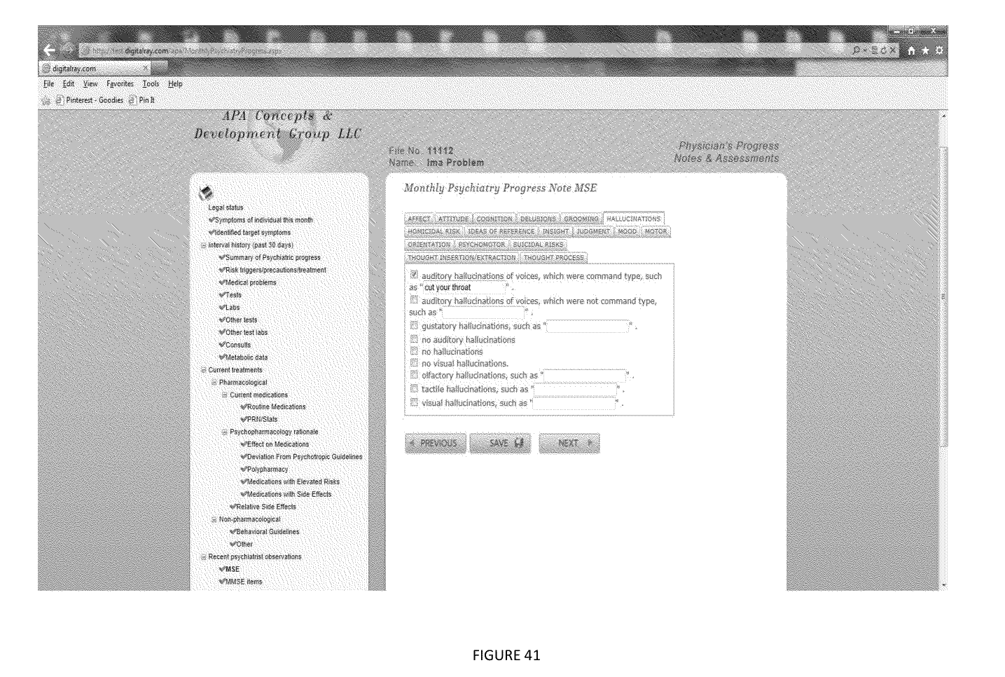

FIG. 41 is an example of a GUI showing Monthly Psychiatry Progress Note MSE, according to principles of the invention. This screenshot illustrates the MSE sections in a tab form. The tab selected in this screenshot is ‘Hallucinations.’ The user has 9 choices to select from to describe the patient's hallucinations, of which 6 choices allow the user to add a further description in an associated textbox. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

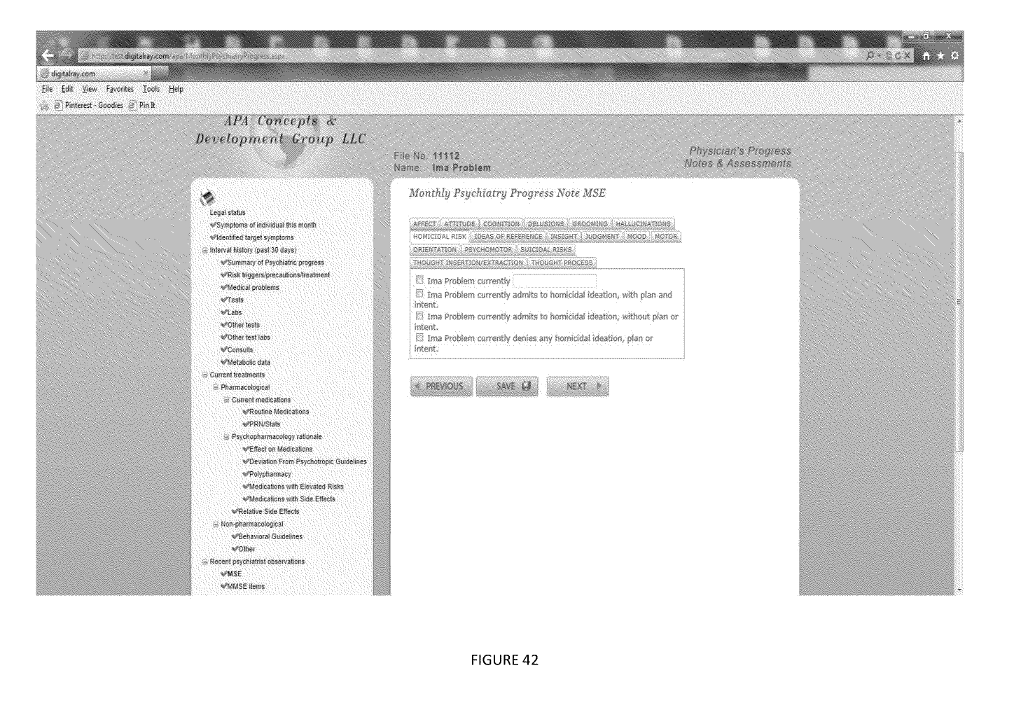

FIG. 42 is an example of a GUI showing Monthly Psychiatry Progress Note MSE, according to principles of the invention. This screenshot illustrates the MSE sections in a tab form. The tab selected in this screenshot is ‘Homicidal Risk.’ The user has 4 choices to select from to describe the patient's homicidal risk, of which 1 choice allows the user to add a further description in an associated textbox. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

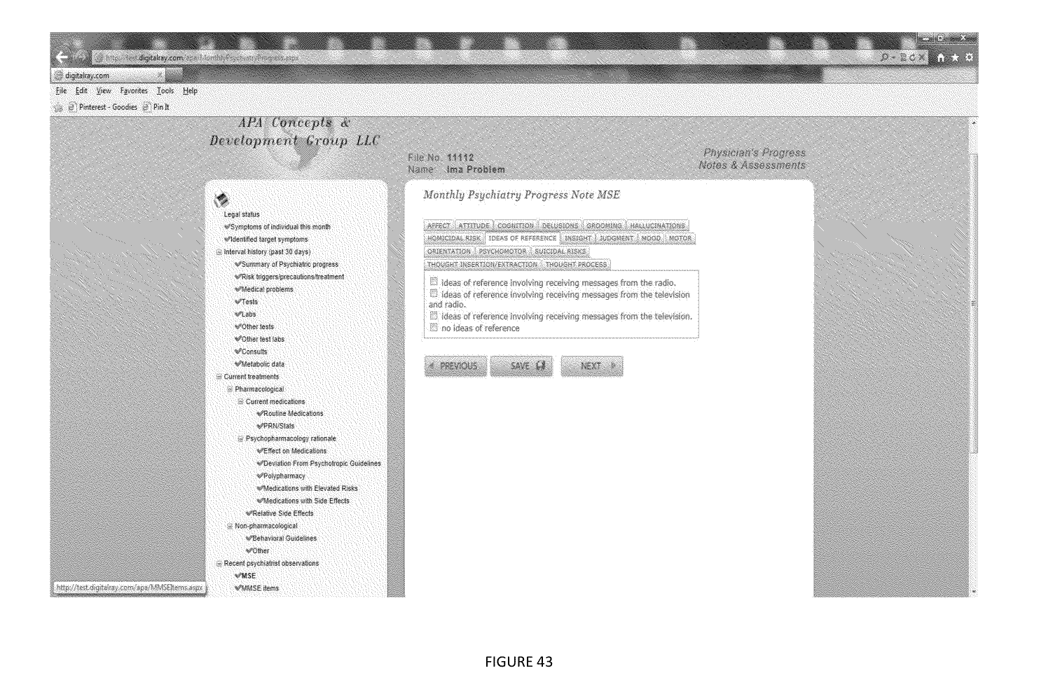

FIG. 43 is an example of a GUI showing Monthly Psychiatry Progress Note MSE, according to principles of the invention. This GUI illustrates the MSE sections in a tab form. The tab selected in this screenshot is ‘Ideas of Reference.’ The user has 4 choices to select from to describe the patient's ideas of reference. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

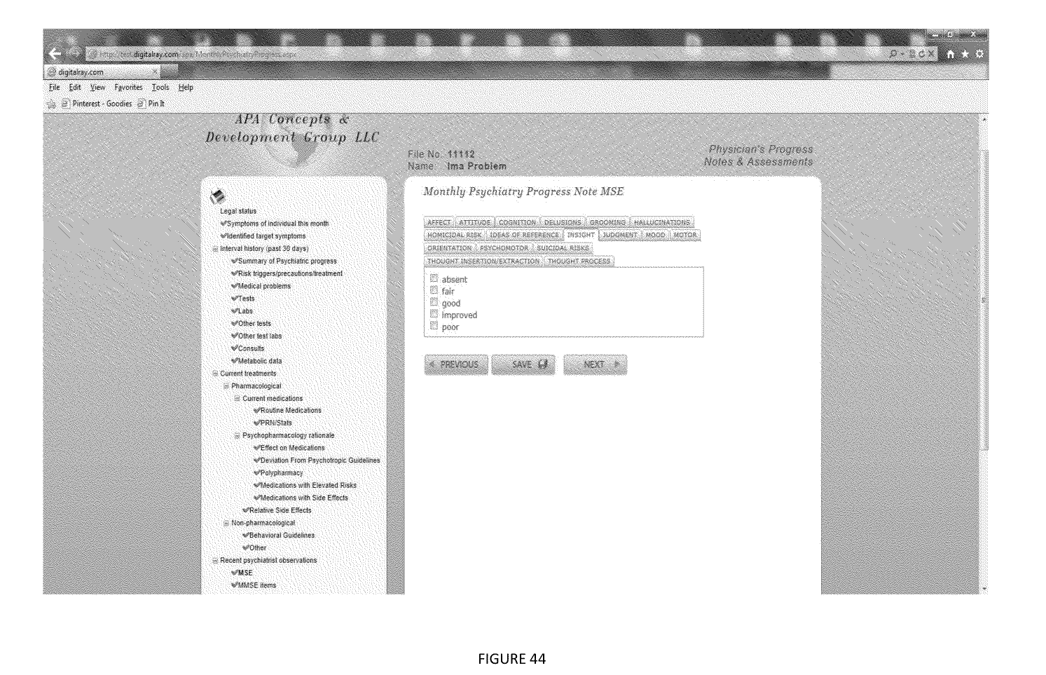

FIG. 44 is an example of a GUI showing Monthly Psychiatry Progress Note MSE, according to principles of the invention. This GUI illustrates the MSE sections in a tab form. The tab selected in this screenshot is ‘Insight.’ The user has 5 choices to select from to describe the patient's insight. Once that is completed, the user can save the section by mouse-clicking the ‘Save’ button, and continue on to the next tab in this MSE section. When ready to go onto the next section, the user may mouse-click the ‘Next’ button. Or the user can return to the prior section by mouse-clicking the ‘Previous’ button.

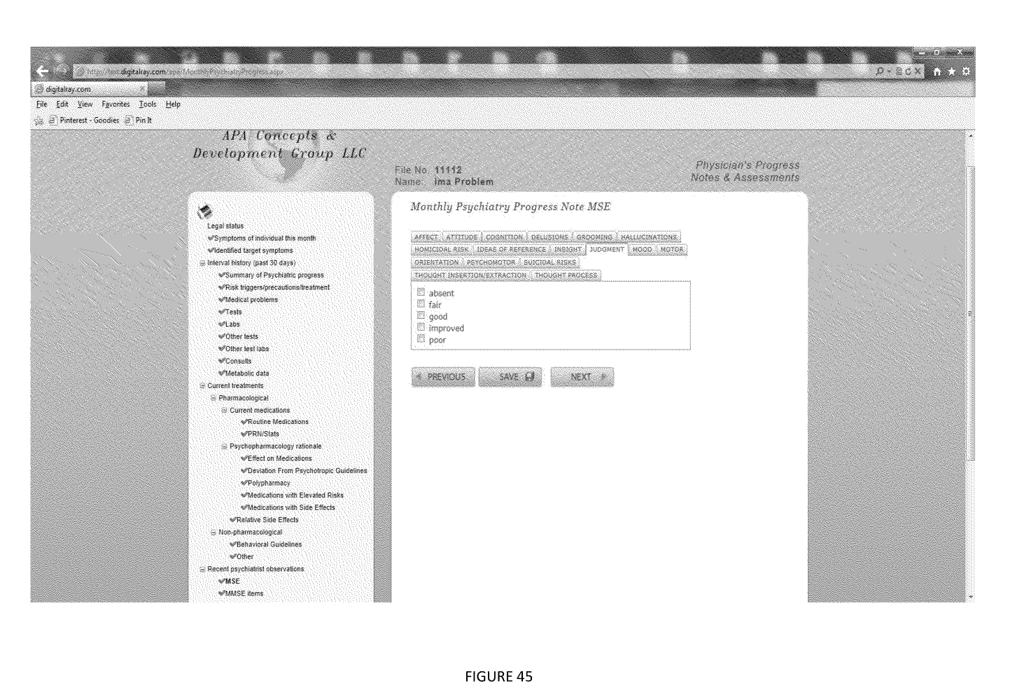

FIG. 45 is an example of a GUI showing Monthly Psychiatry Progress Note MSE, according to principles of the invention. This GUI illustrates the MSE sections in a tab form. The tab selected in this screenshot is ‘Judgment.’ The user has 5 choices to select from to describe the patient's judgment. Once that is completed, the user can save the section by mouse-clicking the ‘Save’ button, and continue on to the next tab in this MSE section. When ready to go onto the next section, the user may mouse-click the ‘Next’ button. Or the user can return to the prior section by mouse-clicking the ‘Previous’ button.

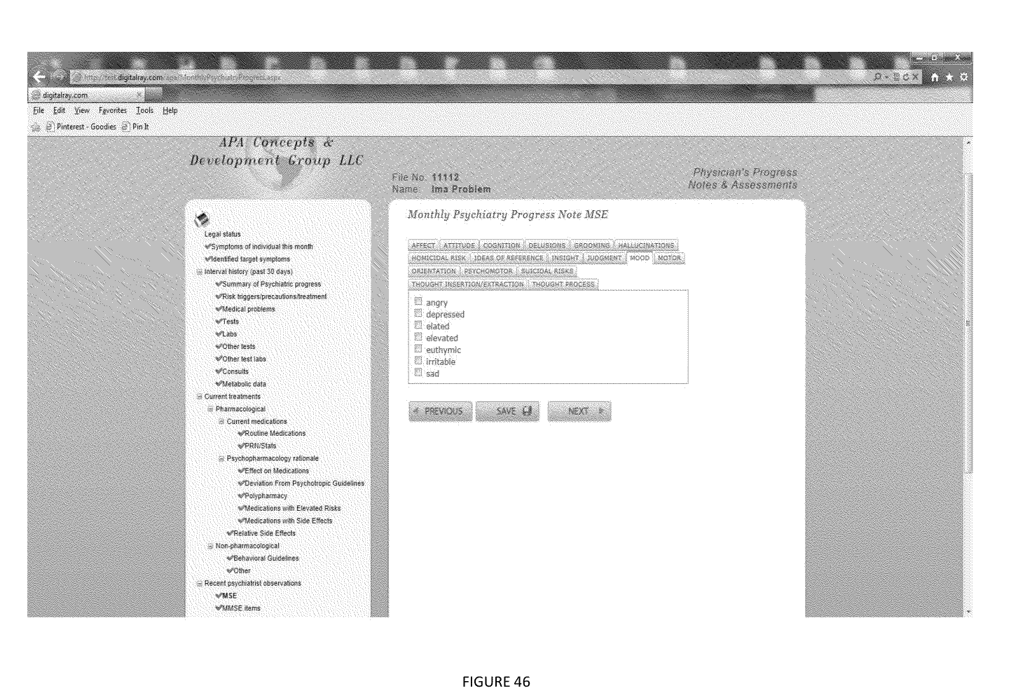

FIG. 46 is an example of a GUI showing Monthly Psychiatry Progress Note MSE, according to principles of the invention. This GUI illustrates the MSE sections in a tab form. The tab selected in this screenshot is ‘Mood.’ The user has 7 choices to select from to describe the patient's mood. Once that is completed, the user can save the section by mouse-clicking the ‘Save’ button, and continue on to the next tab in this MSE section. When ready to go onto the next section, the user may mouse-click the ‘Next’ button. Or the user can return to the prior section by mouse-clicking the ‘Previous’ button.

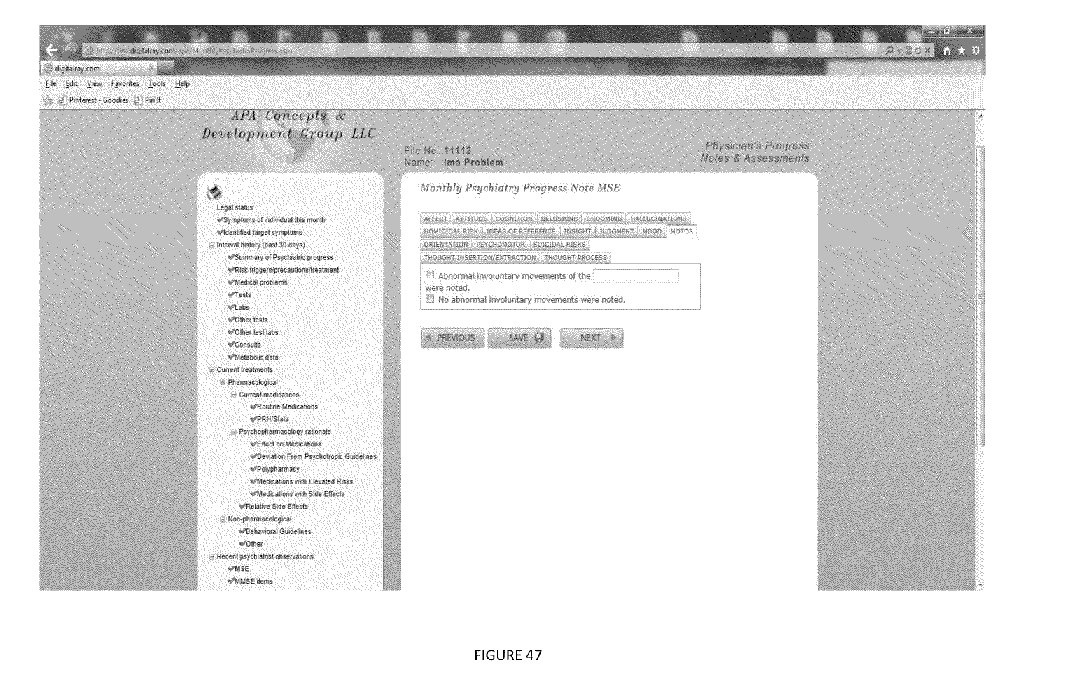

FIG. 47 is an example of a GUI showing Monthly Psychiatry Progress Note MSE, according to principles of the invention. This GUI illustrates the MSE sections in a tab form. The tab selected in this screenshot is ‘Motor.’ The user has 2 choices to select from to describe the patient's motor, of which 1 choice has an associated textbox available to add further description. Once that is completed, the user can save the section by mouse-clicking the ‘Save’button, and continue on to the next tab in this MSE section. When ready to go onto the next section, the user may mouse-click the ‘Next’ button. Or the user can return to the prior section by mouse-clicking the ‘Previous’ button.

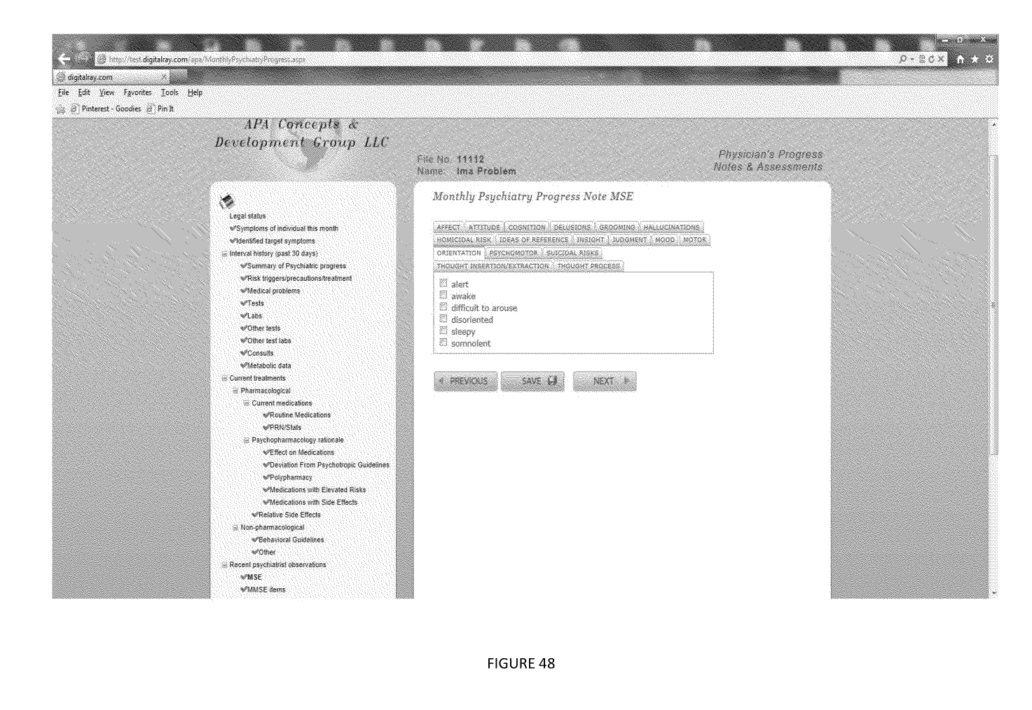

FIG. 48 is an example of a GUI showing Monthly Psychiatry Progress Note MSE, according to principles of the invention. This GUI illustrates the MSE sections in a tab form. The tab selected in this screenshot is ‘Orientation.’ The user has 6 choices to select from to describe the patient's orientation. Once that is completed, the user can save the section by mouse-clicking the ‘Save’ button, and continue on to the next tab in this MSE section. When ready to go onto the next section, the user can mouse-click the ‘Next’ button. Or the user can return to the prior section by mouse-clicking the ‘Previous’ button.

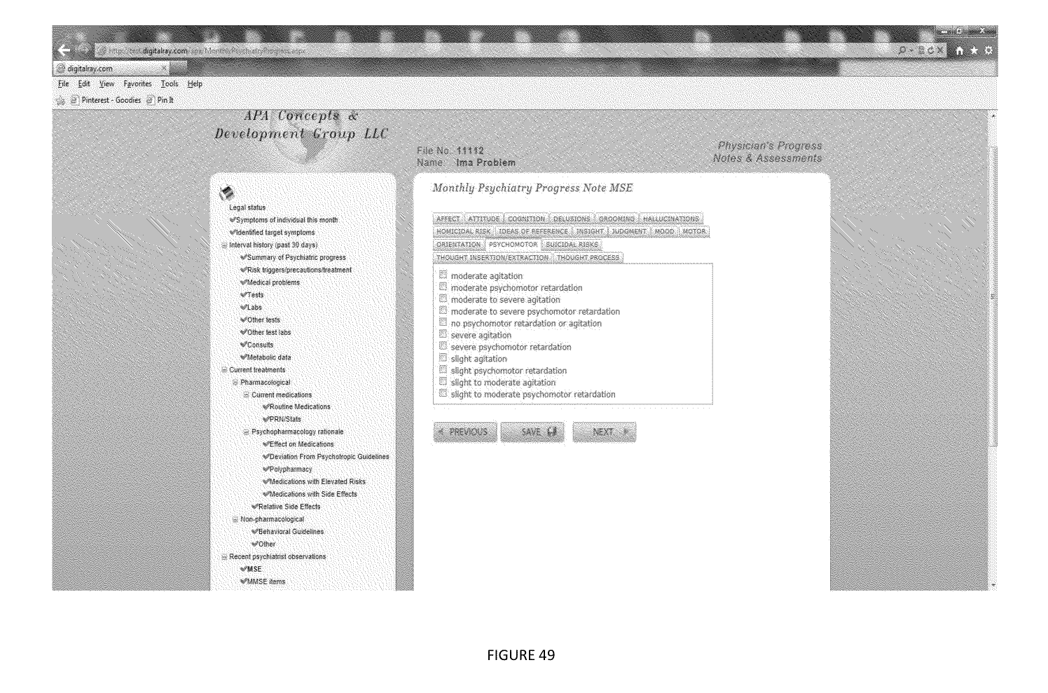

FIG. 49 is an example of a GUI showing Monthly Psychiatry Progress Note MSE, according to principles of the invention. This GUI illustrates the MSE sections in a tab form. The tab selected in this screenshot is ‘Psychomotor.’ The user has 11 choices to select from to describe the patient's psychomotor presentation. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

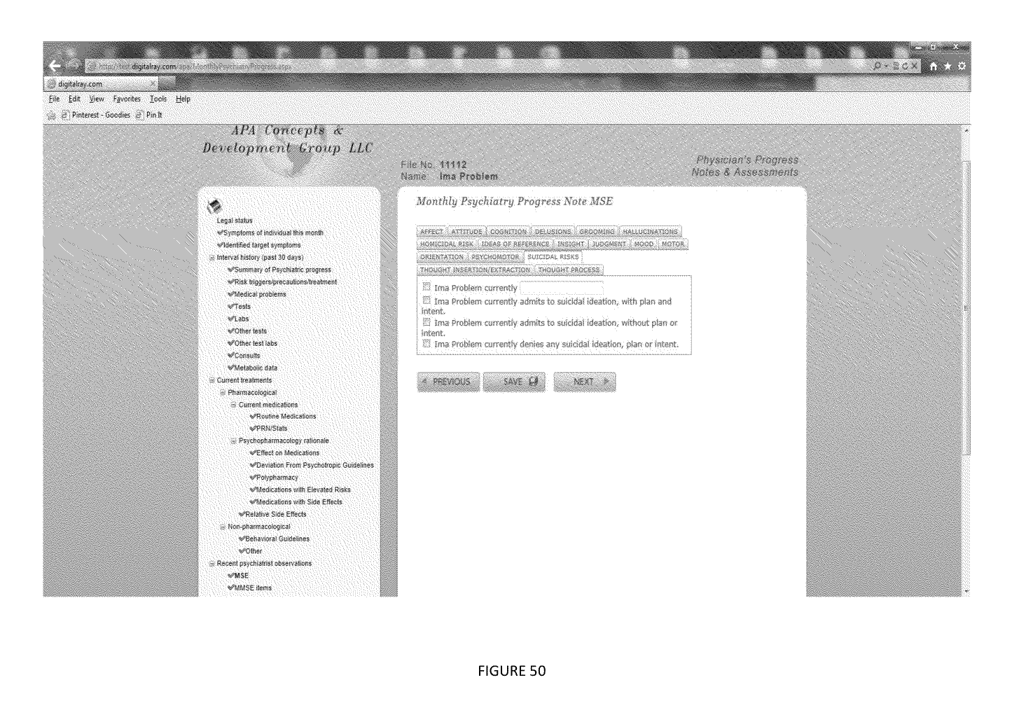

FIG. 50 is an example of a GUI showing Monthly Psychiatry Progress Note MSE, according to principles of the invention. This GUI illustrates the MSE sections in a tab form. The tab selected in this screenshot is ‘Suicidal Risk.’ The user has 4 choices to select from to describe the patient's suicidal risk, of which 1 choice allows the user to add a further description in an associated textbox. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

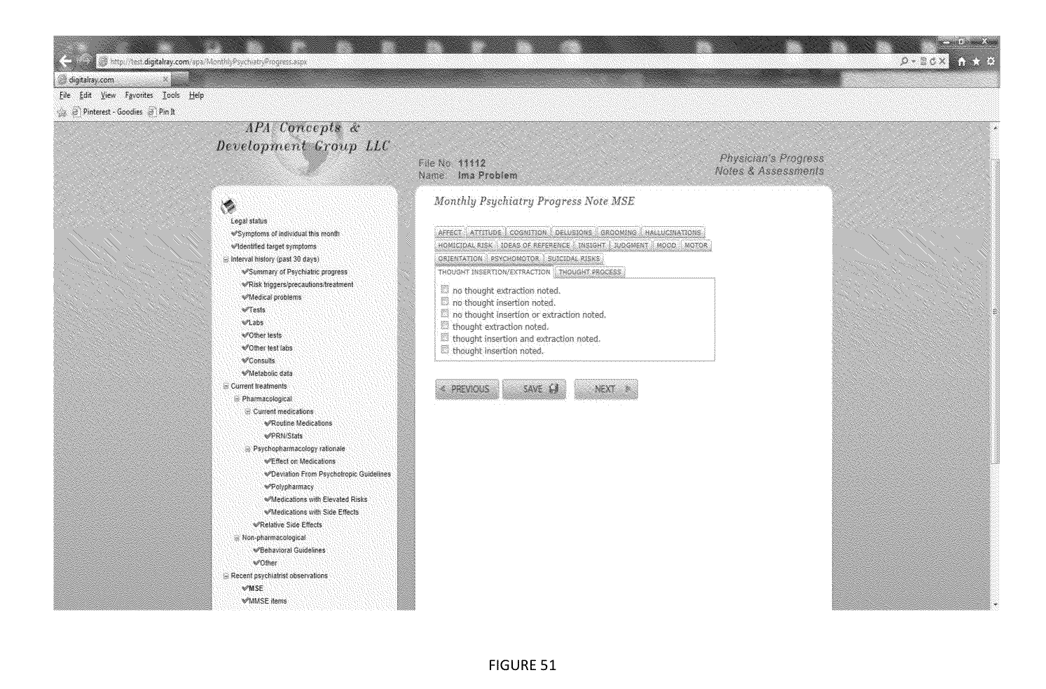

FIG. 51 is an example of a GUI showing Monthly Psychiatry Progress Note MSE, according to principles of the invention. This GUI illustrates the MSE sections in a tab form. The tab selected in this screenshot is ‘Thought Insertion/Extraction.’ The user has 6 choices to select from to describe the patient's thought insertion/extraction. Once that is completed, the user can save the section by mouse-clicking the ‘Save’ button, and continue on to the next tab (or any tab) in this MSE section. When ready to go onto the next section, the user may mouse-click the ‘Next’ button. Or the user can return to the prior section by mouse-clicking the ‘Previous’ button.

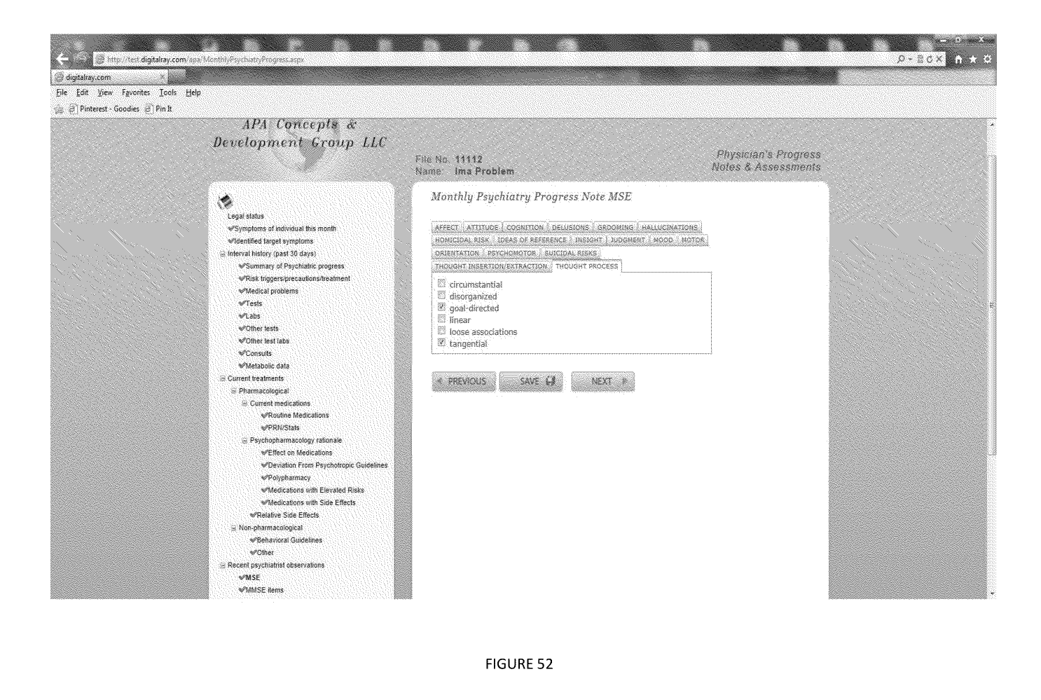

FIG. 52 is an example of a GUI showing Monthly Psychiatry Progress Note MSE, according to principles of the invention. This GUI illustrates the MSE sections in a tab form. The tab selected in this screenshot is ‘Thought Process.’ The user has 6 choices to select from to describe the patient's thought process. Once that is completed, the user can save the section by mouse-clicking the ‘Save’ button, and go to any one of the different tabs in this MSE section. When ready to go onto the next section, the user may mouse-click the ‘Next’ button. Or the user can return to the prior section by mouse-clicking the ‘Previous’ button.

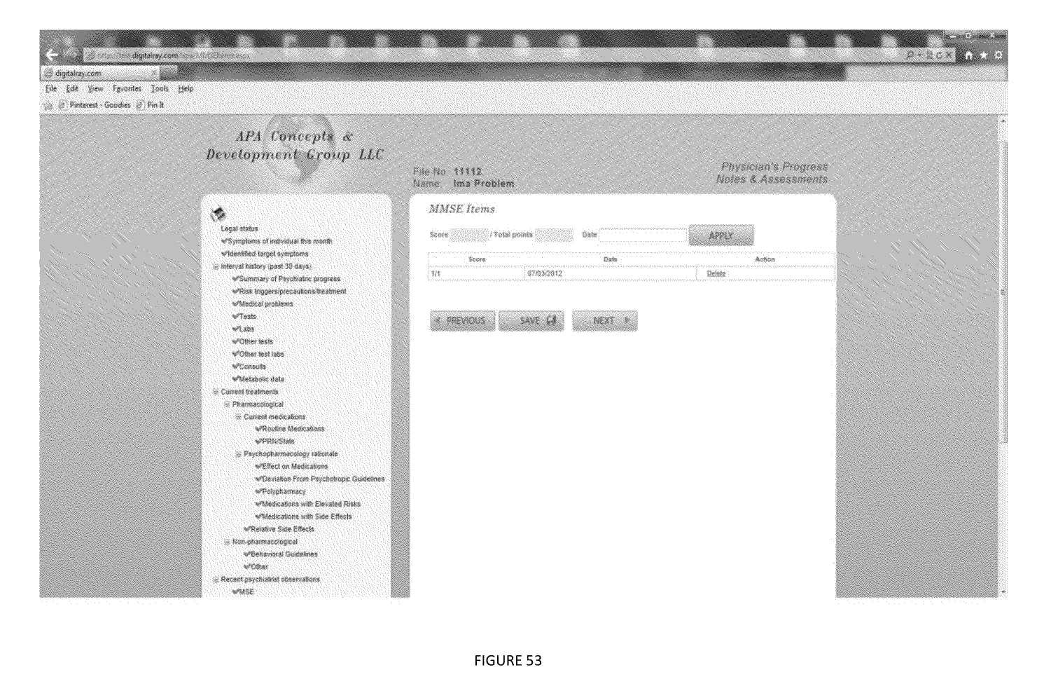

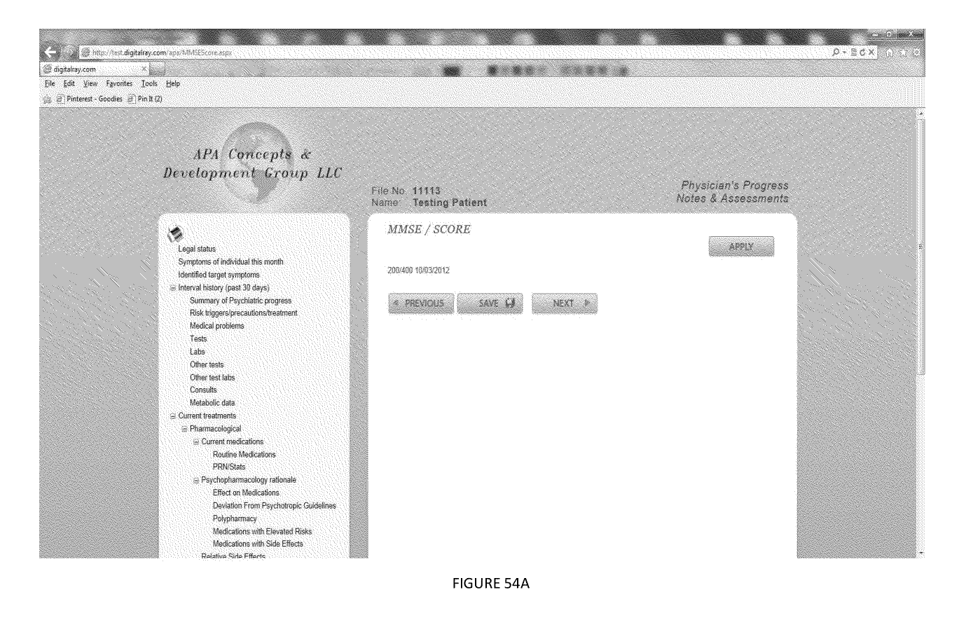

FIG. 53 is an example of a GUI showing minimum mental state exam (MMSE) Items, according to principles of the invention. In this GUI, the user can add in an MMSE by entering the numerator of an MMSE under ‘Score’ and entering the denominator of an MMSE under ‘Total points’ and then select a date for the MMSE (being referenced) utilizing the calendar pop-up under ‘Date.’ Once that data is entered, the user can mouse-click ‘Apply’ and then the table below will show the date and score (numerator/denominator) of the MMSE which has just been added. The user can also delete prior score/date entries, represented in the table, by mouse-clicking the ‘Delete’ selection in the ‘Action’ column. Once that is completed, the user can save the section by mouse-clicking the ‘Save’ button. When ready to go onto the next section, the user may mouse-click the ‘Next’ button. Or the user can return to the prior section by mouse-clicking the ‘Previous’ button. FIG. 54A is an example of a GUI showing MMSE/Score, according to principles of the invention. In this GUI, since the client is seeing the score and date of the MMSE that is currently being displayed [as a result of sometime previously entering the data, as noted in FIG. 54B. FIG. 54B is an example of a GUI showing MMSE/Score, APPLY pop-up according to principles of the invention. In this GUI, the user may see a selection of checkboxes, which are to the left of a list of MMSEs (showing the score and date of the particular MMSE). The user may mouse-click any number of checkboxes in order to select those MMSEs that the client wants to be displayed in the document. Once that is completed, the client can save the section by mouse-clicking the ‘Save’ button. When ready to go onto the next section, the client may mouse-click the ‘Next’ button. Or the client can return to the prior section by mouse-clicking the ‘Previous’ button.

In this GUI, the user can mouse-click ‘Apply’ which then pulls up a list of Scores and MMSE dates. The user can then determine which dates of MMSE scores to save to the document by mouse-clicking the checkbox(s). The user can then click ‘Apply’ and the screen will list the scores and dates selected. Once that is completed, the user can save the section by mouse-clicking the ‘Save’ button. When ready to go onto the next section, the user may mouse-click the ‘Next’ button. Or the user can return to the prior section by mouse-clicking the ‘Previous’ button.

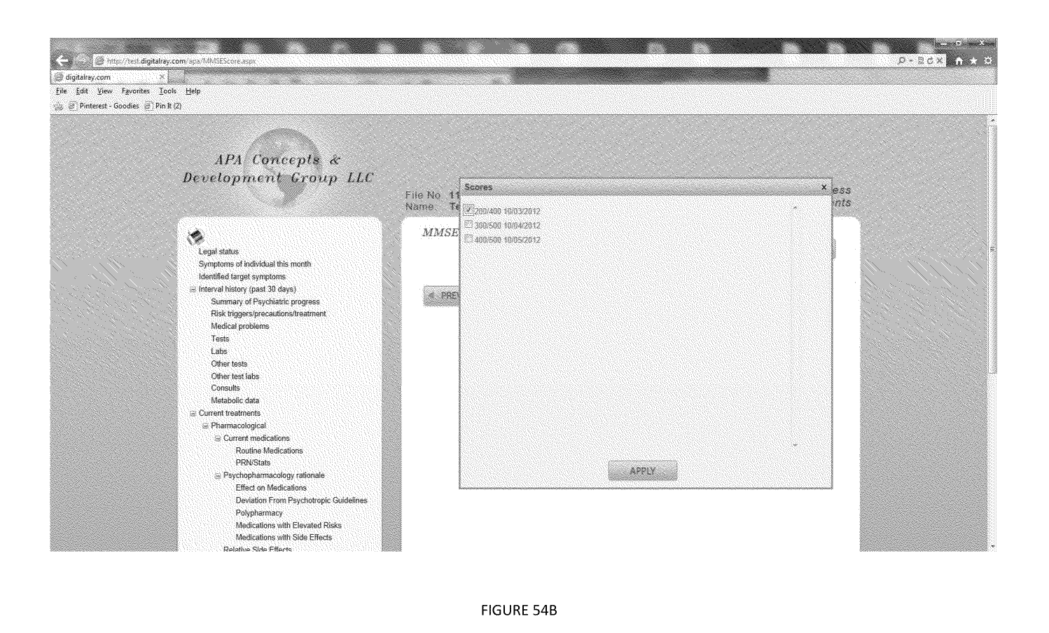

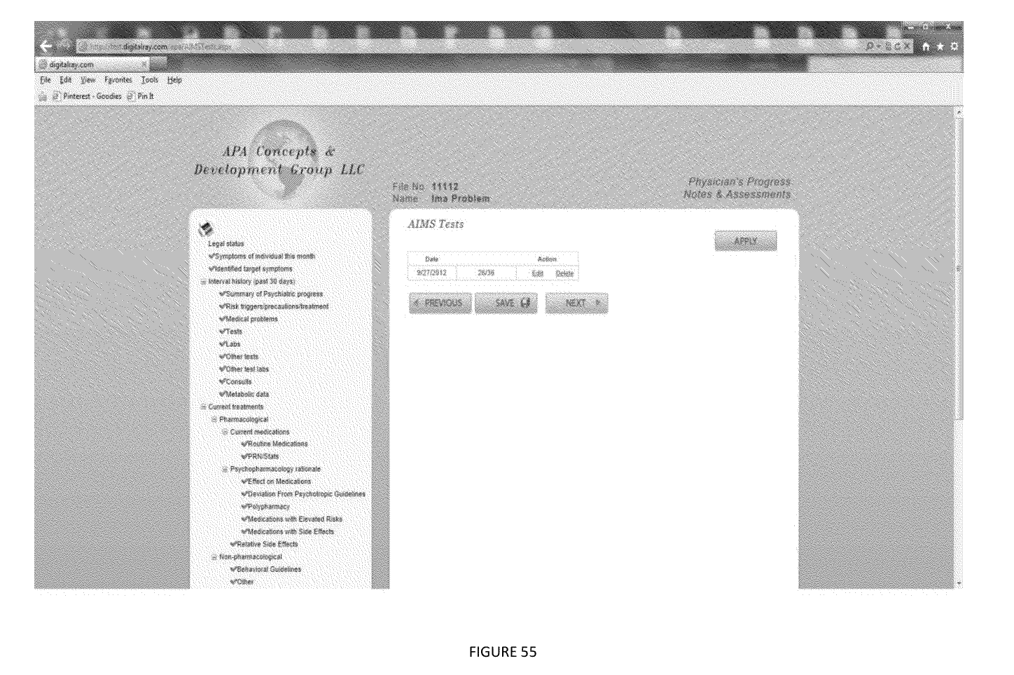

FIG. 55 is an example of a GUI showing AIMS tests, according to principles of the invention. In this screenshot, the user can view a table which lists all prior AIMS date and score entries; the user can edit the results by clicking the ‘Edit’ button, or delete the entry by clicking the ‘Delete’ button.

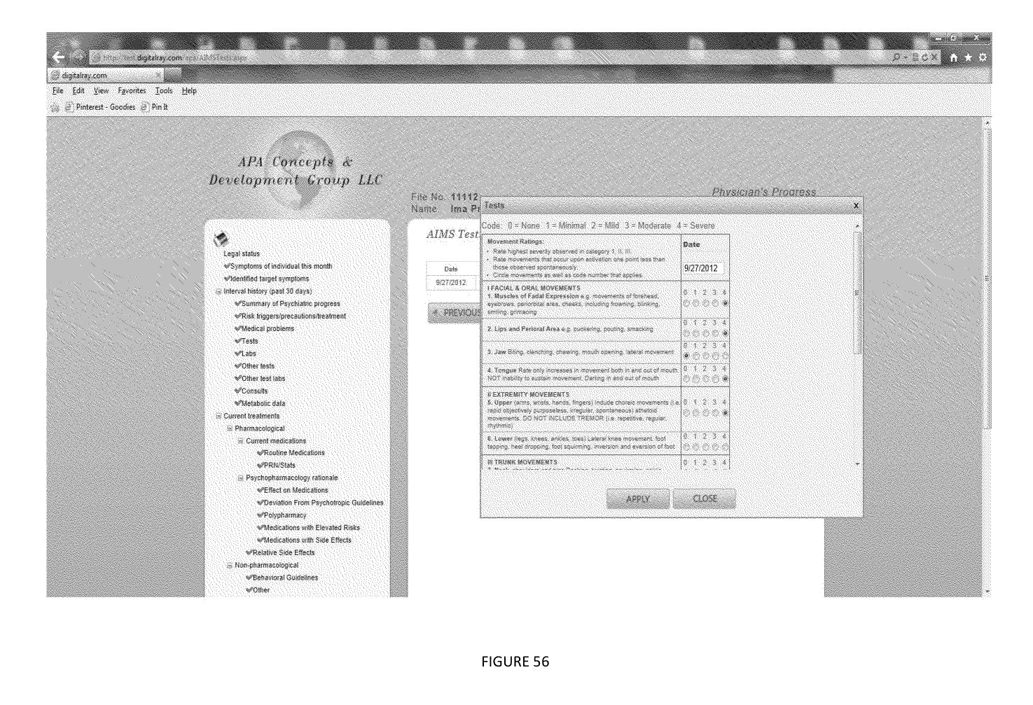

FIG. 56 is an example of a GUI showing AIMS tests, according to principles of the invention. This GUI illustrates how the user may add in an AIMS test by mouse-clicking the ‘Apply’ button; an AIMS (Abnormal Involuntary Movement Scale) form appears, and the user can click the ‘date’ area to pull up the calendar pop-up and enter a date. Then, the user can use the mouse to click the score for each numbered region of the test; numbers 1 through 10 can be each given a score from 0 to 4 and numbers 11 through 14 can be answered ‘yes’ or ‘No’. The user can then click ‘Apply’ to save the scoring, or click ‘Close’ to close the screen without scoring. The software program will automatically tabulate the total number for the numerator as well as tabulate the denominator and display it in the table; the user can edit the results by clicking the ‘Edit’ button, or delete the entry by clicking the ‘Delete’ button.

Once that is completed, the user can save the section by mouse-clicking the ‘Save’ button. When ready to go onto the next section, the user may mouse-click the ‘Next’ button. Or the user can return to the prior section by mouse-clicking the ‘Previous’ button.

FIG. 57 is an example of a GUI showing AIMS, according to principles of the invention. This GUI shows the current AIMS test and how it will appear when the document generator prints it out as an attachment to the PPN. This can be changes by the user mouse-clicking the ‘Apply’ button, selecting an AIMS test of a different date and clicking ‘Apply’ which will then cause the AIMS form, that will be printed as an attachment to the PPN, to be of the selected date.

Once that is completed, the user can save the section by mouse-clicking the ‘Save’ button. When ready to go onto the next section, the user may mouse-click the ‘Next’ button. Or the user can return to the prior section by mouse-clicking the ‘Previous’ button.

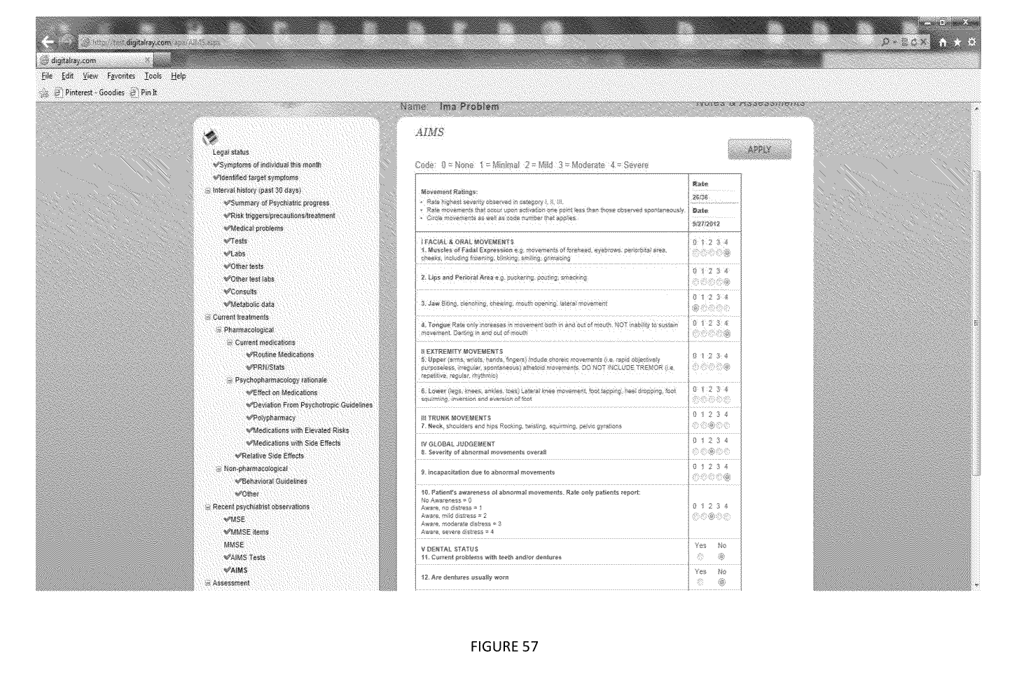

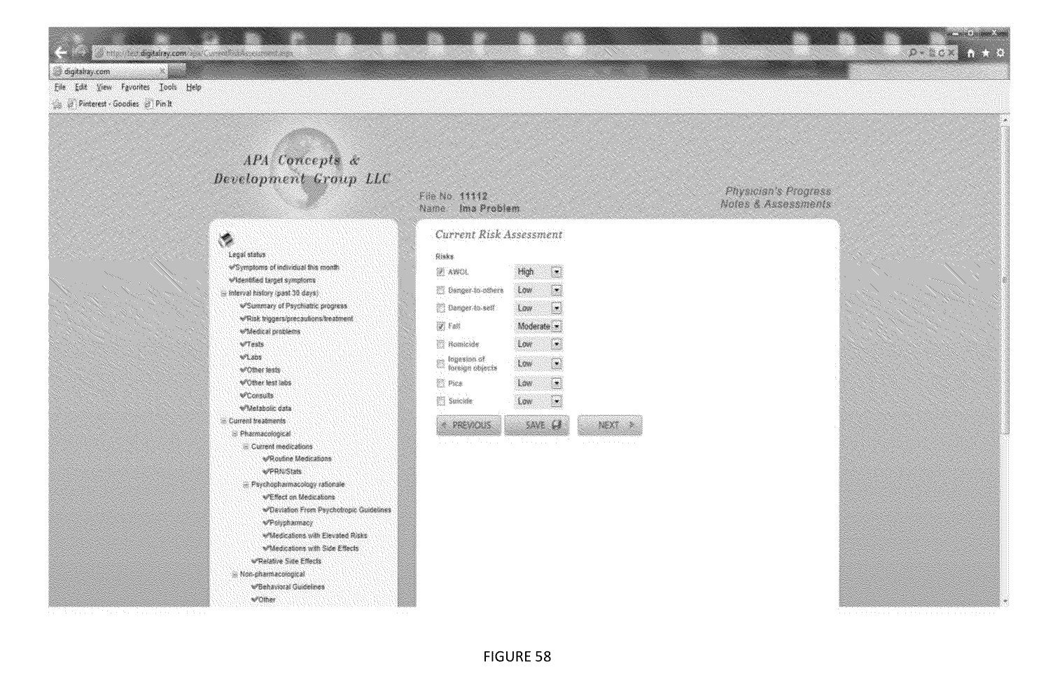

FIG. 58 is an example of a GUI showing Current Risk Assessment, according to principles of the invention. This GUI allows the user to select up to 8 choices of risk behaviors, and then by utilizing the pull-down menu across from each listed risk behavior, the user can rate each of these risks as either ‘High’, ‘Moderate’, or ‘Low’. Once that is completed, the user may save the section by mouse-clicking the ‘Save’ button. When ready to go onto the next section, the user may mouse-click the ‘Next’ button. Or the user can return to the prior section by mouse-clicking the ‘Previous’ button.

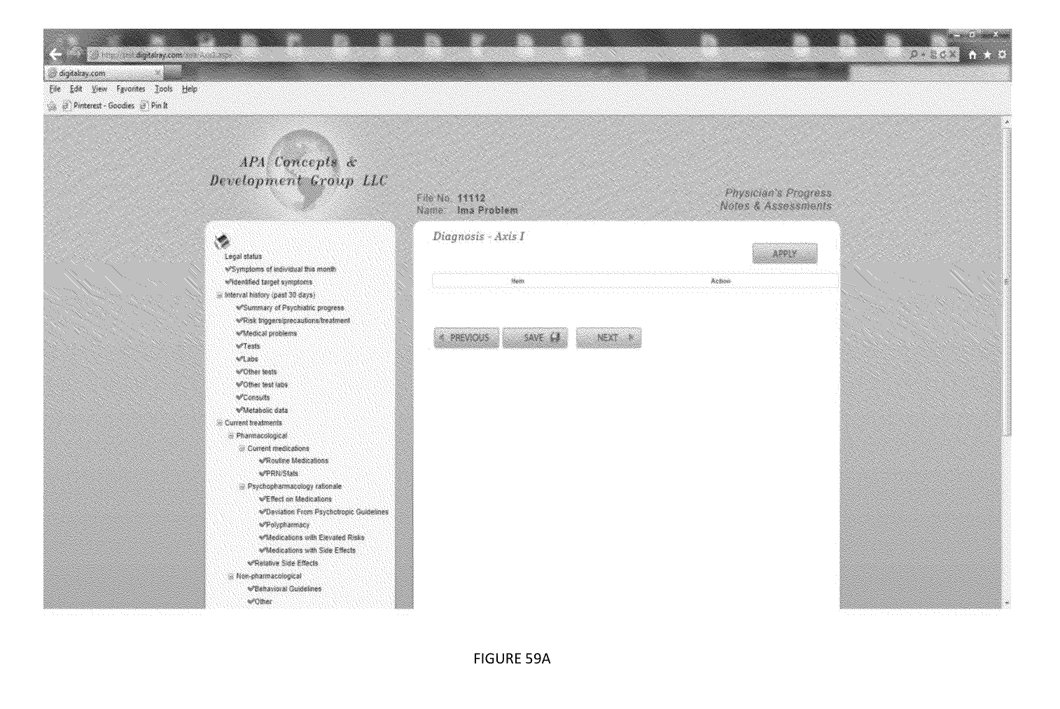

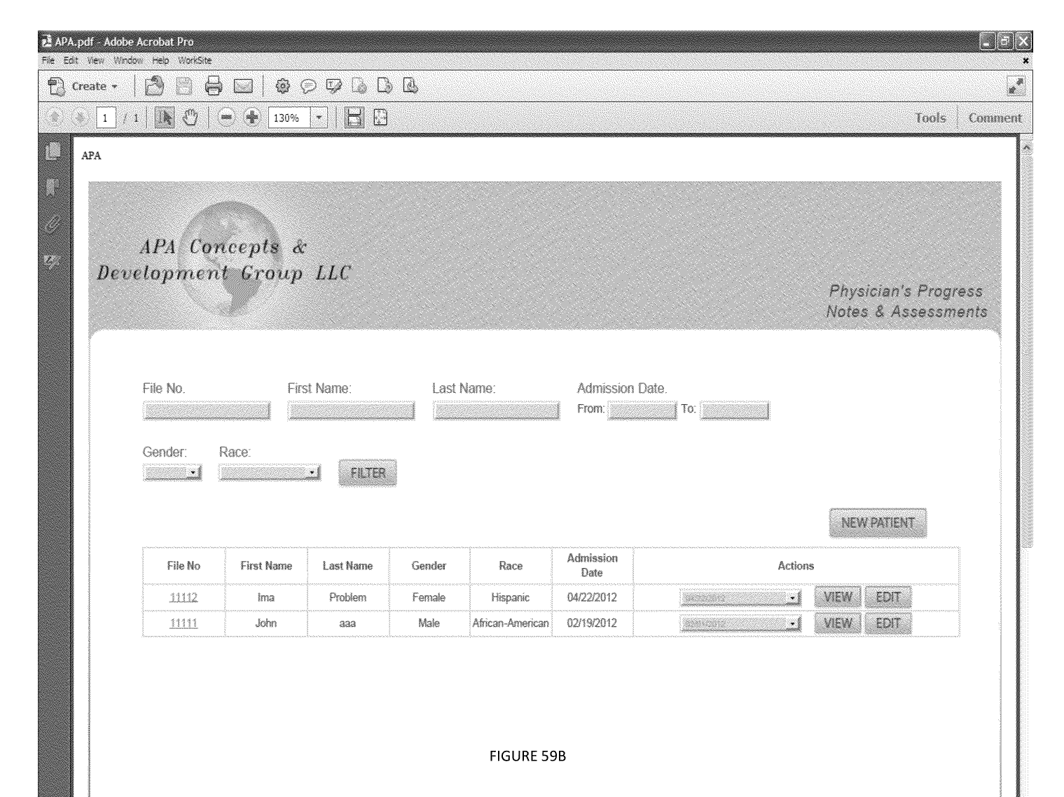

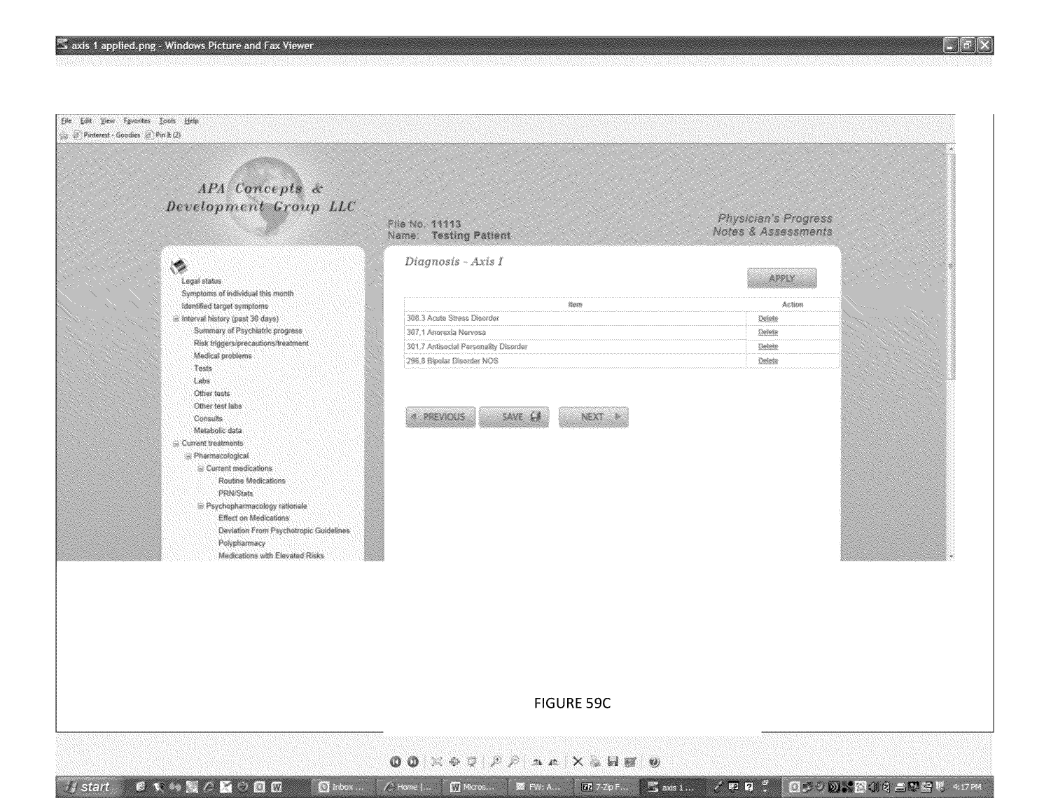

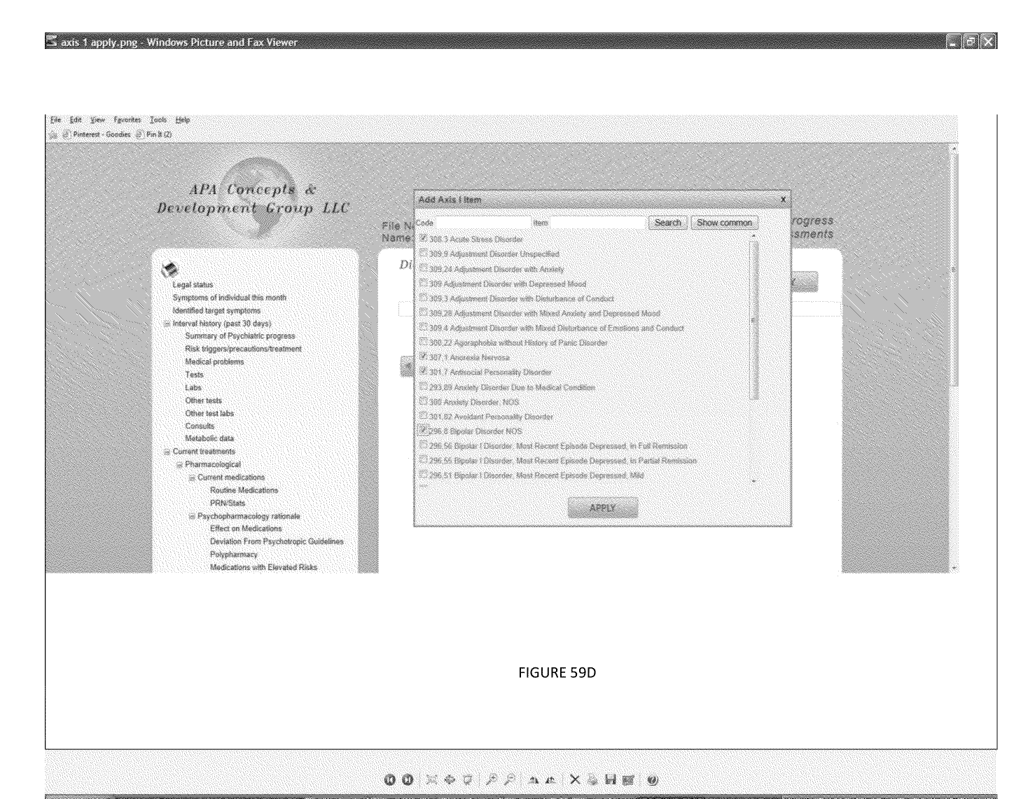

FIGS. 59a-59d are examples of GUIs showing DIAGNOSIS AXIS I, according to principles of the invention. In these GUIs, the user is able, by mouse-clicking the ‘Apply’ button, to select among all DSM IV-TR® Axis I diagnoses, uniquely, by NAME, CODE or from a list of Commonly used diagnoses. Once that is completed, the user can save the section by mouse-clicking the ‘Save’ button. When ready to go onto the next section, the user may mouse-click the ‘Next’ button. Or the user can return to the prior section by mouse-clicking the ‘Previous’.

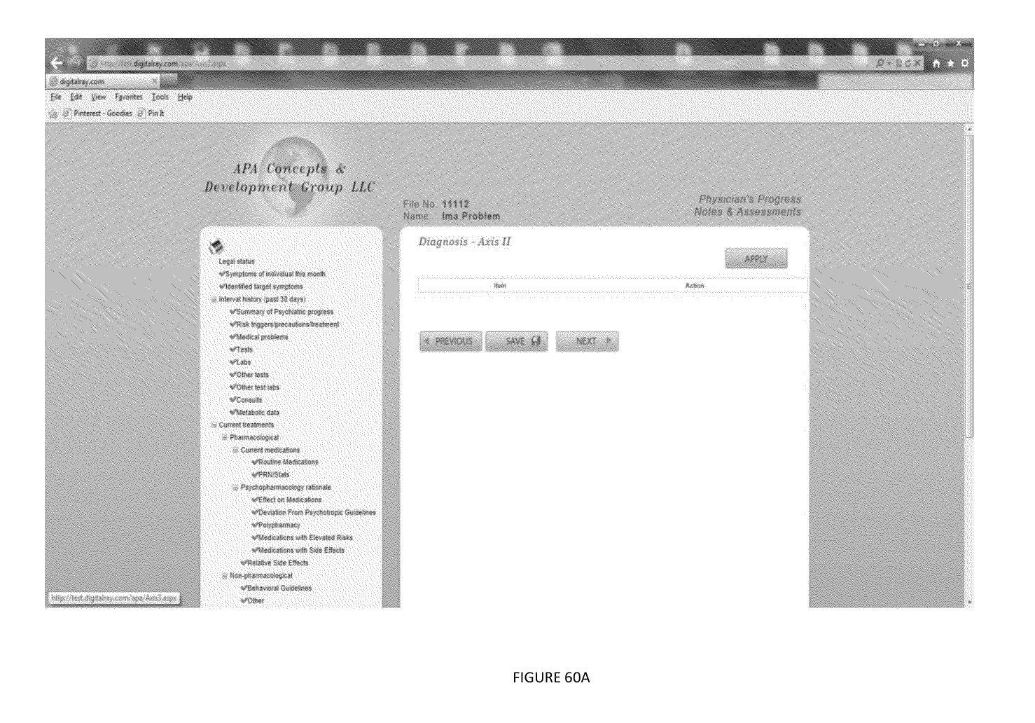

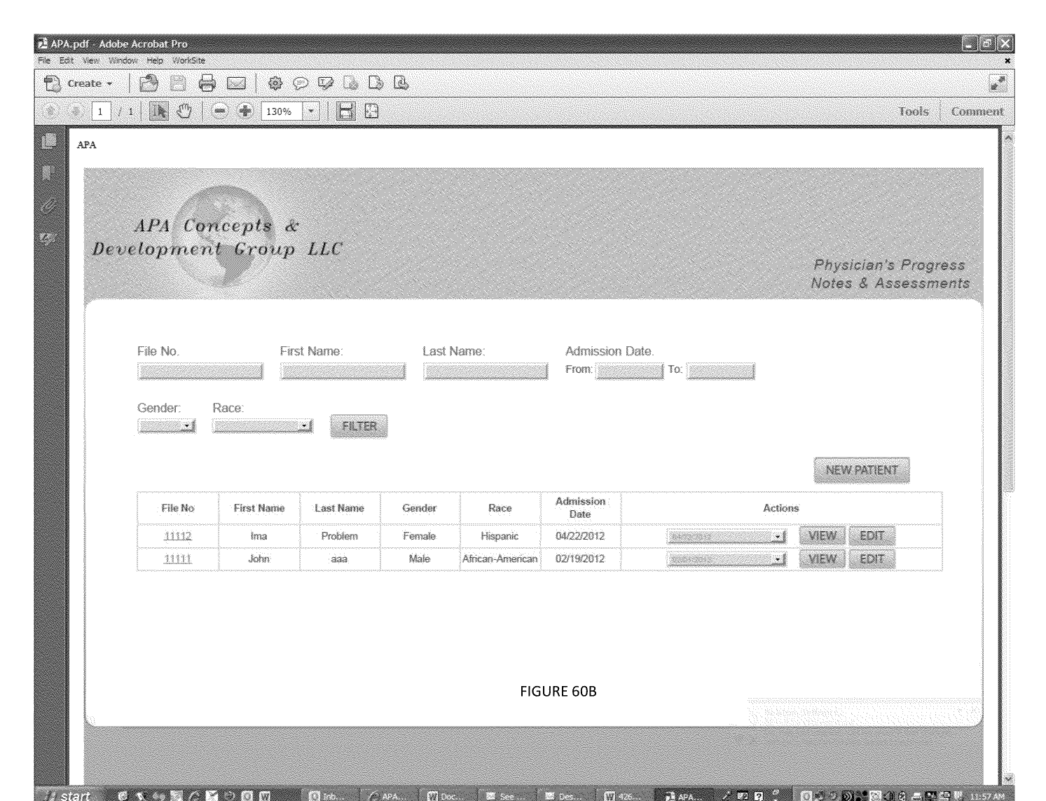

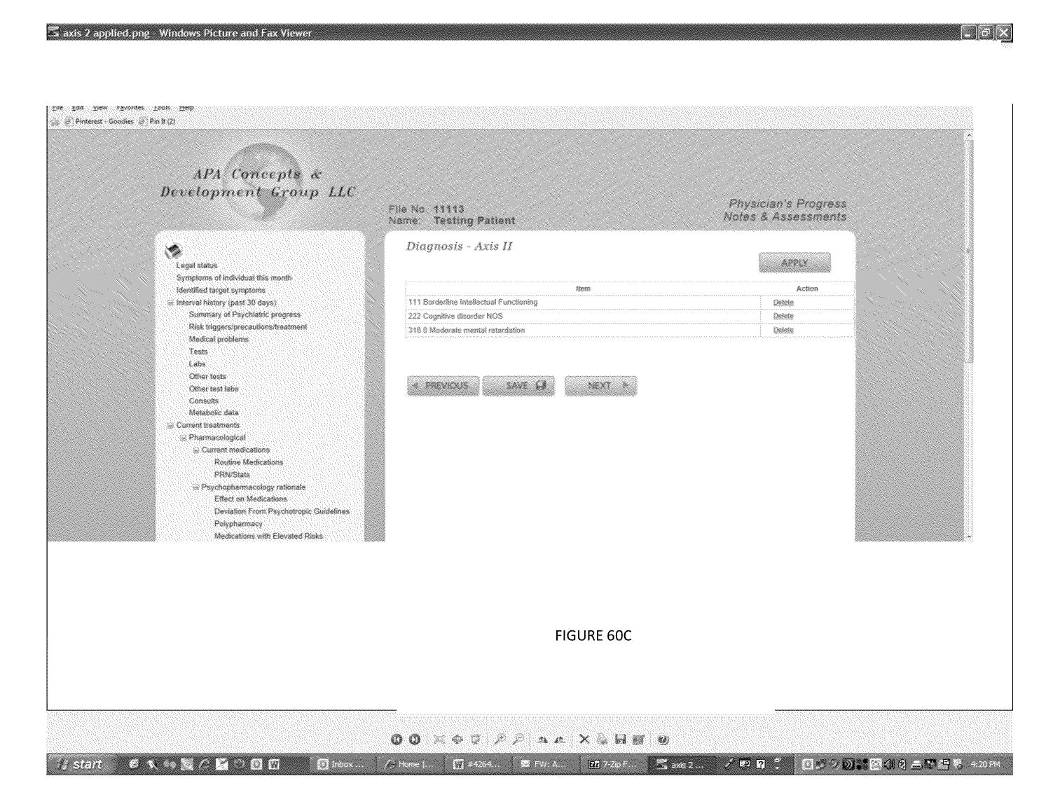

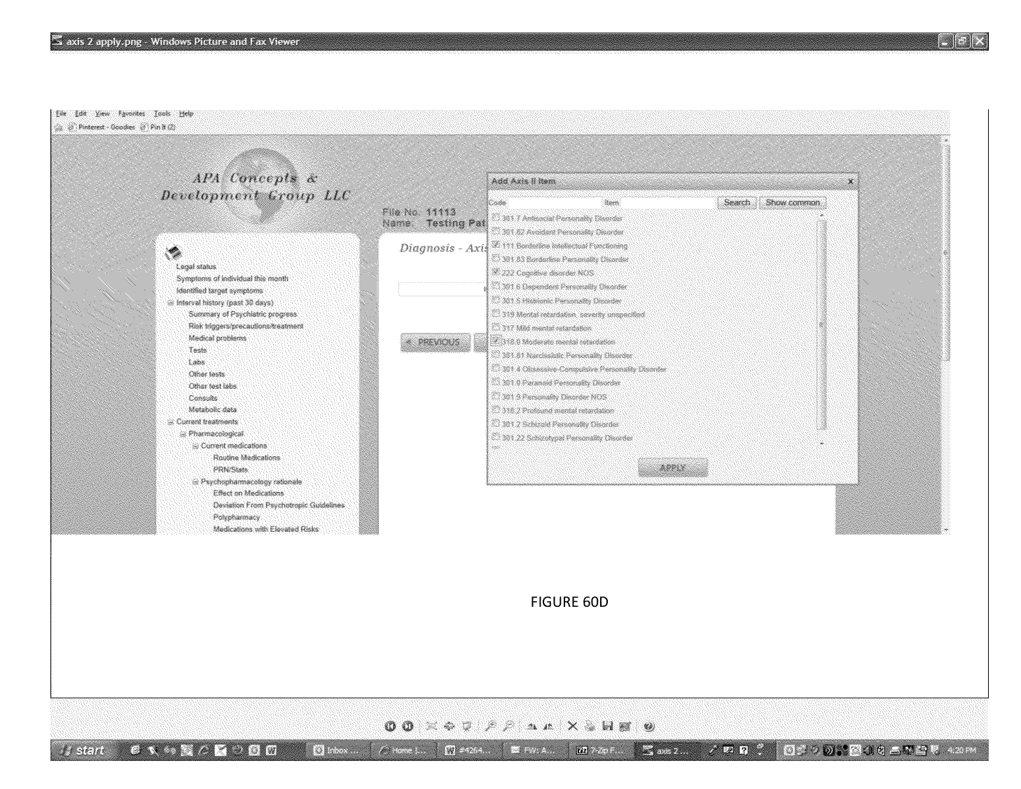

FIGS. 60a-60d are examples of GUIs showing DIAGNOSIS AXIS II, according to principles of the invention. In these GUIs, the user is able, by mouse-clicking the ‘Apply’ button, to select among all DSM IV-TR® Axis II diagnoses, uniquely, by NAME, CODE or from a list of Commonly used diagnoses.

Once that is completed, the user can save the section by mouse-clicking the ‘Save’ button. When ready to go onto the next section, the user may mouse-click the ‘Next’ button. Or the user can return to the prior section by mouse-clicking the ‘Previous’ button.

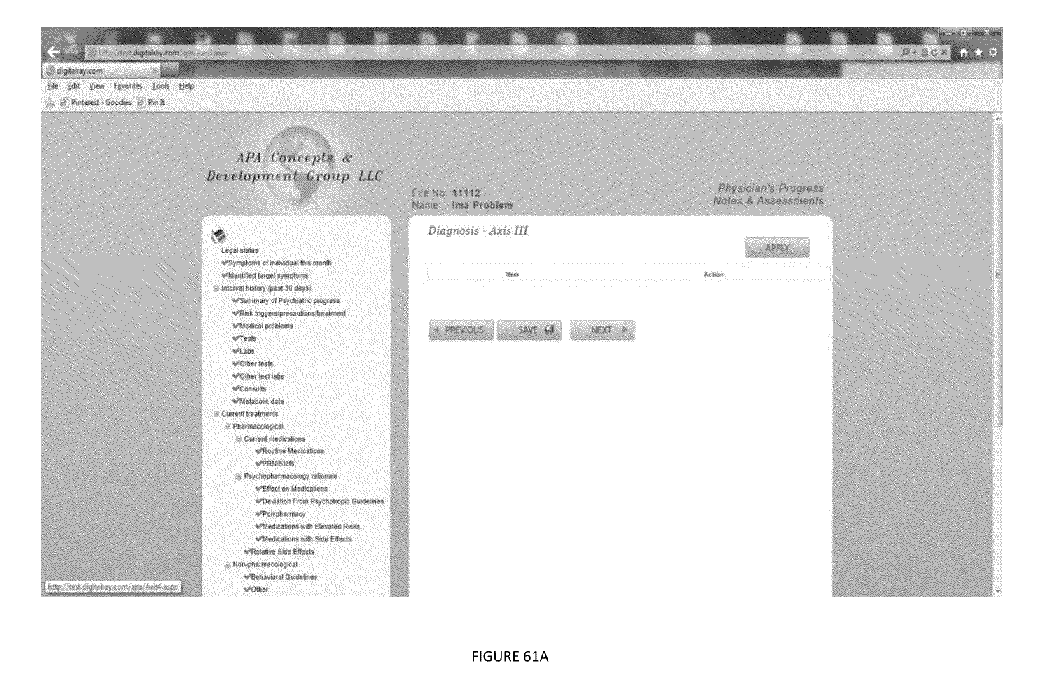

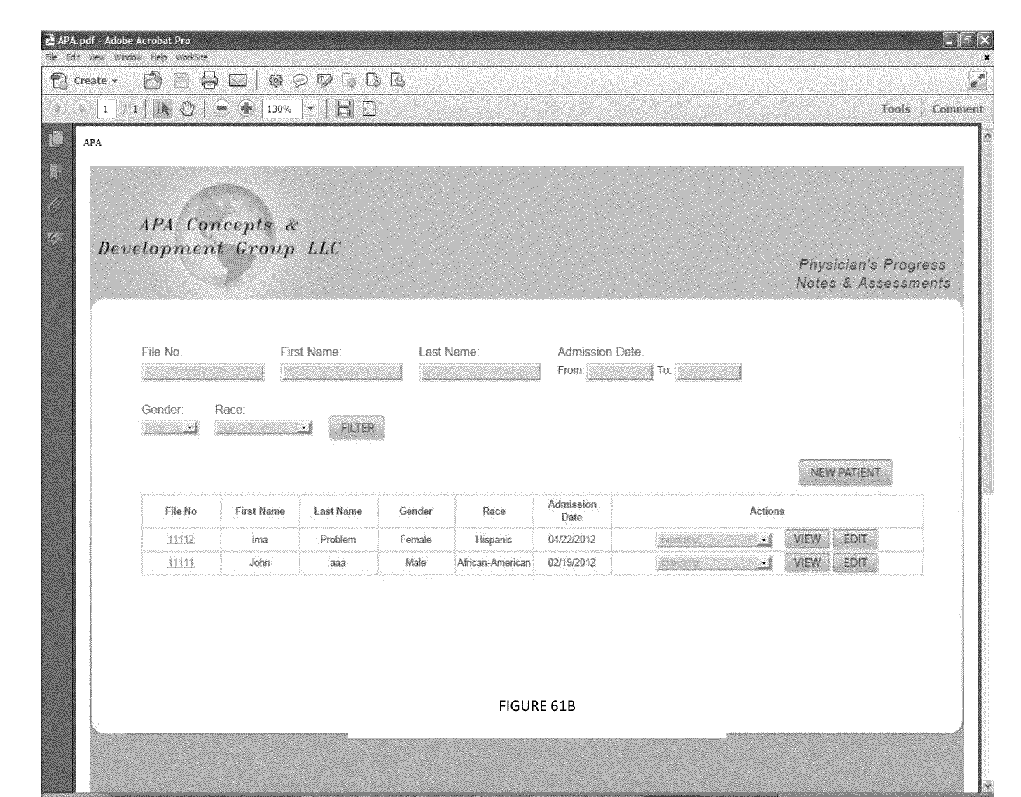

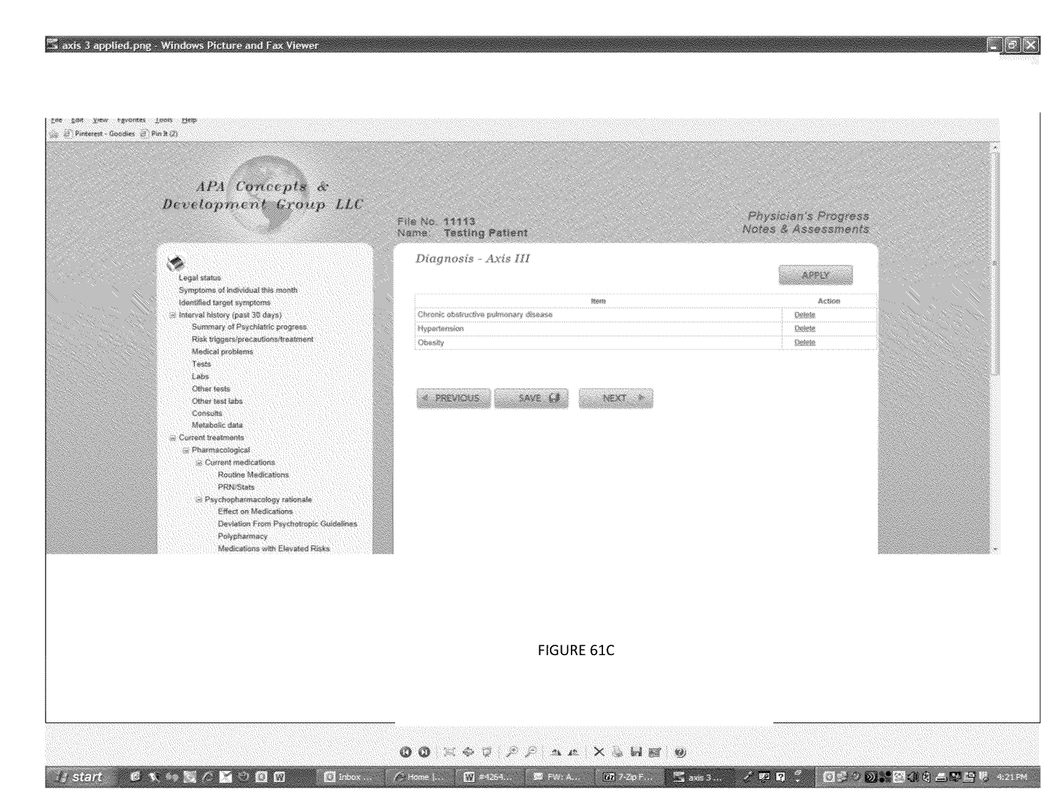

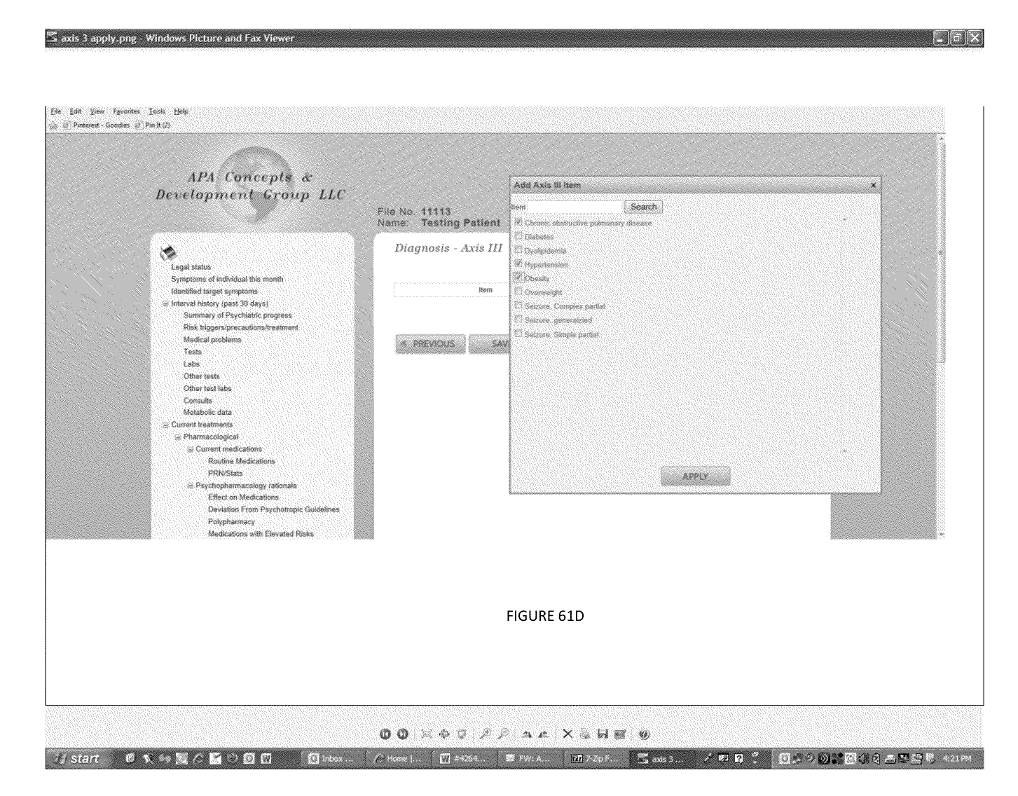

FIGS. 61a-61d are examples of GUIs showing DIAGNOSIS AXIS III, according to principles of the invention. In this GUI, the user is able, by mouse-clicking the ‘Apply’ button, to select from a list of commonly used medical conditions or direct entry in a textbox. Once that is completed, the user can save the section by mouse-clicking the ‘Save’ button. When ready to go onto the next section, the user may mouse-click the ‘Next’ button. Or the user can return to the prior section by mouse-clicking the ‘Previous’ button.

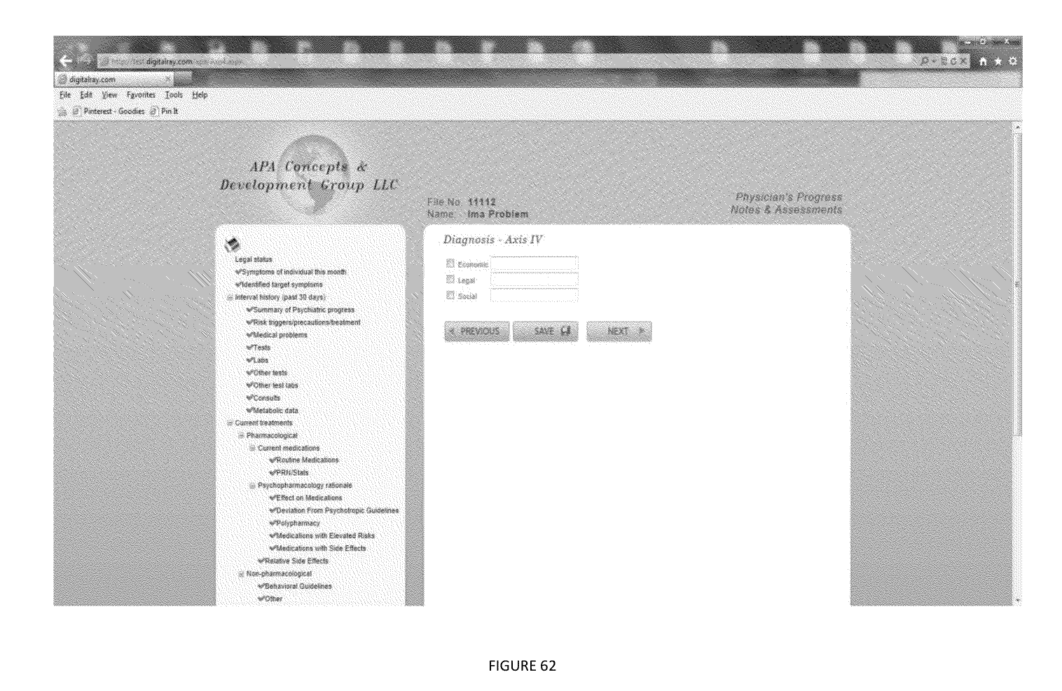

FIG. 62 is an example of a GUI showing DIAGNOSIS AXIS IV, according to principles of the invention. In this GUI, the user is able to select any or all of the checkboxes and utilize the textboxes for supplying further information. Once that is completed, the user can save the section by mouse-clicking the ‘Save’ button. When ready to go onto the next section, the user may mouse-click the ‘Next’ button. Or the user can return to the prior section by mouse-clicking the ‘Previous’ button.

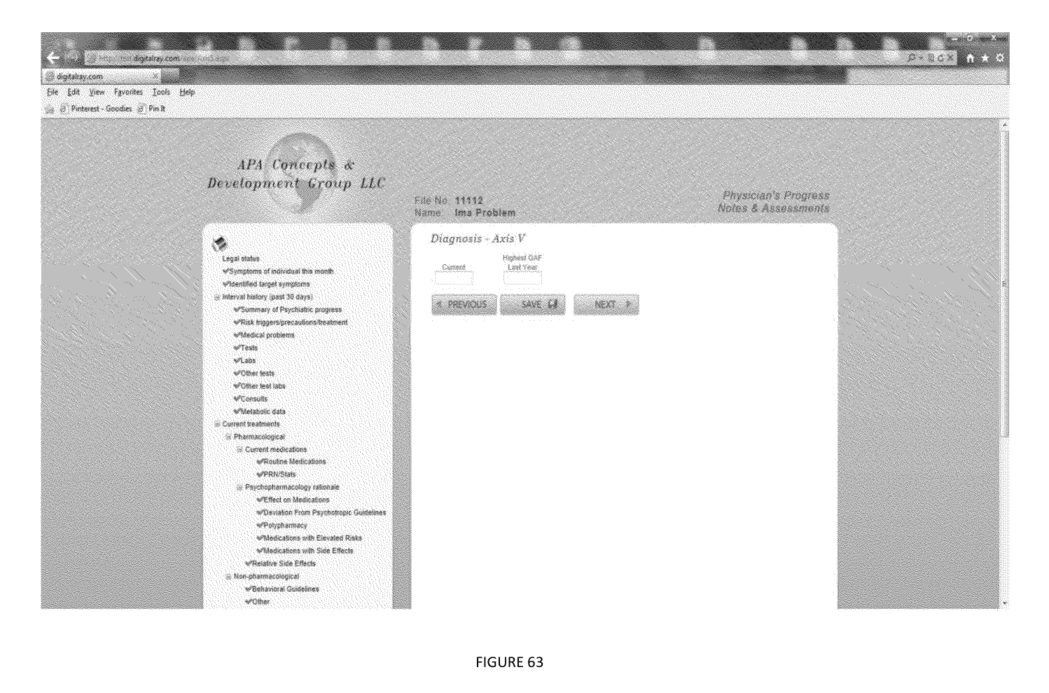

FIG. 63 is an example of a GUI showing DIAGNOSIS AXIS V, according to principles of the invention. In this screenshot, the user is able to enter a score for the GAF by mouse-clicking the space and typing in the numerical score; then the score for the Highest GAF in the Last Year can be entered in the same manner. Once that is completed, the user can save the section by mouse-clicking the ‘Save’ button. When ready to go onto the next section, the user may mouse-click the ‘Next’ button. Or the user can return to the prior section by mouse-clicking the ‘Previous’ button.

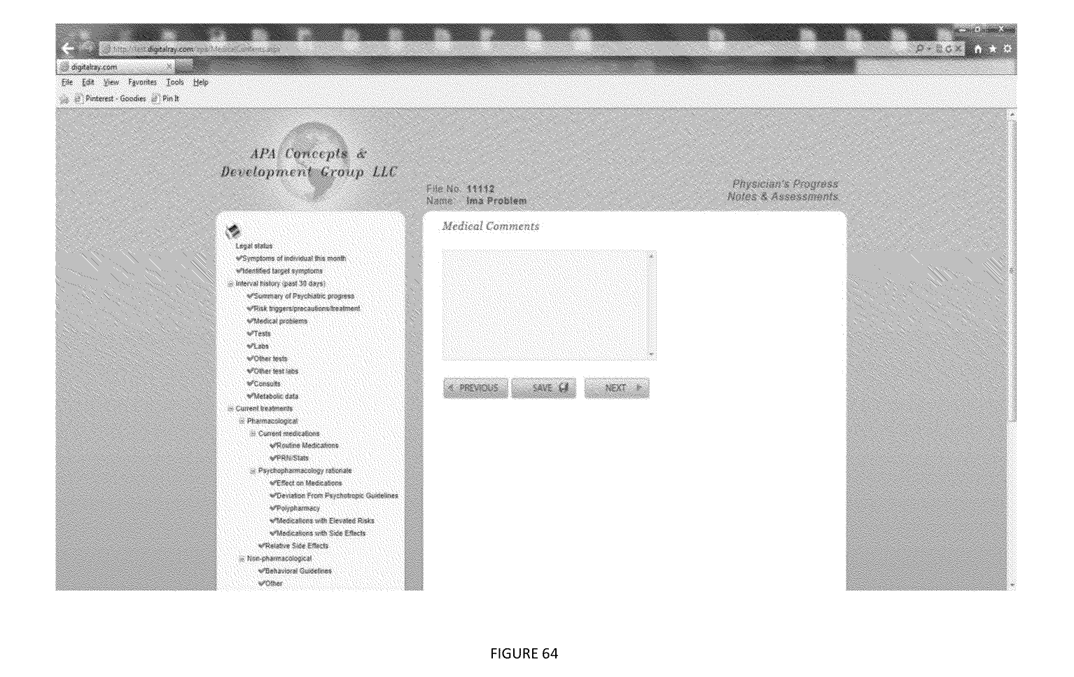

FIG. 64 is an example of a GUI showing Medical Comments, according to principles of the invention. In this GUI, the user can type in any additional information regarding medical comments. Once that is completed, the user can save the section by mouse-clicking the ‘Save’ button. When ready to go onto the next section, the user may mouse-click the ‘Next’ button. Or the user can return to the prior section by mouse-clicking the ‘Previous’ button.

FIG. 65 is an example of a GUI showing Barriers to Discharge, according to principles of the invention. In this GUI, the user can select any number of checkboxes whose content is applicable to the patient.

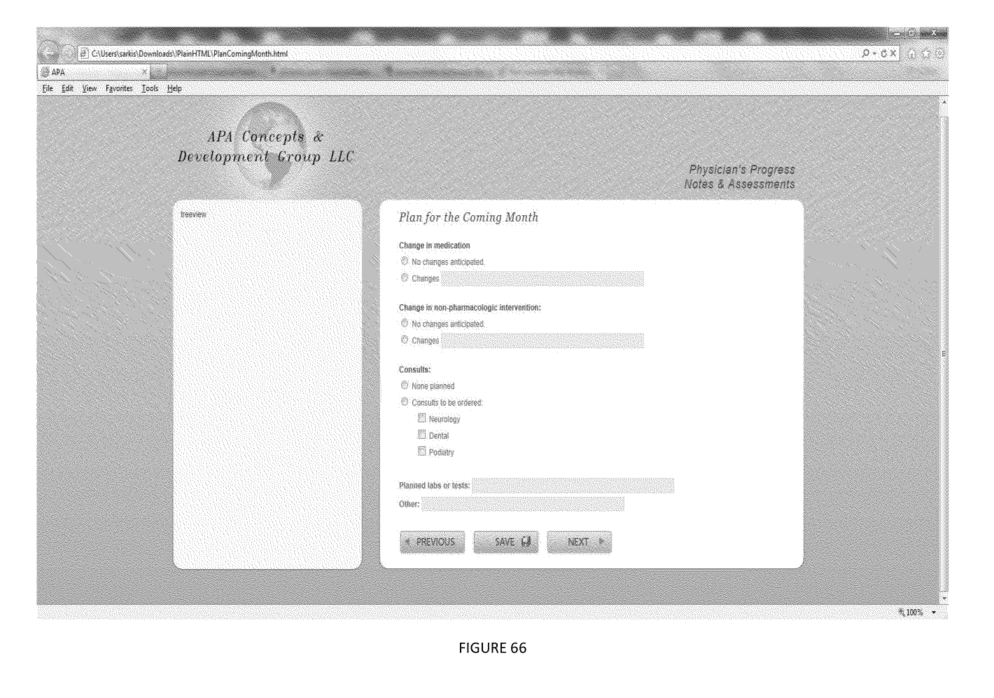

FIG. 66 is an example of a GUI showing “Plan for the Coming Month,” according to principles of the invention. The GUI of FIG. 66 illustrates the selections for the next month's plan. The first section is regarding ‘Change in medication’ and the user may mouse-click either ‘No changes anticipated,’ or may choose ‘Changes’ and then enter the changes by typing in the associated textbox. The second section is regarding ‘Change in non-pharmacologic intervention’ and the user may mouse-click either ‘No changes anticipated,’ or can choose ‘Changes’ and then enter the changes by typing in the associated textbox. The third section is regarding ‘Consults’ and the user may mouse-click either ‘None planned,’ or may choose ‘Consults to be ordered’ and mouse-click one or more checkboxes to select the various type(s) of consults being ordered. The fourth section is regarding ‘Planned labs or tests’ and the client may record, in a textbox, whatever lab(s) or test(s) they plan to have performed. The fifth section is regarding ‘Other’ where the user can mention, in a textbox, additional information. Once that is completed, the client can save the section by mouse-clicking the ‘Save’ button, and continue on to the next tab in this MSE section. When ready to go onto the next section, the user may mouse-click the ‘Next’ button. Or the client may return to the prior section by mouse-clicking the ‘Previous’ button.

According to an aspect of the invention, a computer readable medium is provided storing a computer program, which when executed on, for example, the server 140 (e.g., as shown in FIG. 1), causes the steps, processes and GUIs described herein to be carried out. The computer program may be tangibly embodied in the computer readable medium, and the program may comprise an executable code segment or code section for each of the processes described herein.

While the invention has been described in terms of exemplary embodiments, those skilled in the art will recognize that the invention can be practiced with modifications in the spirit and scope of the appended claims. These examples are merely illustrative and are not meant to be an exhaustive list of all possible designs, embodiments, applications or modifications of the invention.

What is claimed is:

1. A web-based medical record system, comprising:
a web-based server to control patient electronic medical records (EMRs);
a database operatively coupled to the web-based server to store the patient EMRs; and
at least one software module at the server operable to generate graphical user interfaces on a display at a user computer and operable to receive input from the user computer, the user computer in communication with the web-based server over the Internet,
wherein the graphical user interfaces are configured to permit selection of medical parameters for a patient from predetermined selections to update the patient EMRs.

2. The web-based medical record system of claim 1, further comprising an electronic prescription service integrated with the web-based server.

3. The web-based medical record system of claim 2, wherein the electronic prescription service is integrate with the web-based server and residing external to the web-based server.

4. The web-based medical record system of claim 2, wherein the electronic prescription service is integrated with the web-based server so that a single login by a user permits access to the electronic prescription service and patient electronic medical records (EMRs).

5. The web-based medical record system of claim 1, wherein the web-based server comprises a Psychiatric Progress Note (PPN) module, the PPN module configured to permit recordation of:
minimum mental state exam (MMSE) information;
AXIS I information;
AXIS II information;
AXIS III information;
AXIS IV information; and
AXIS V information.

6. The web-based medical record system of claim 5, wherein the PPN module is configured to provide predetermined at least one list for selection by a user to enter information from the at least one list into a patient record.

7. The web-based medical record system of claim 6, wherein the predetermined at least one list permits the user to enter information into the patient's record related to at least one of:
minimum mental state exam (MMSE) information;
AXIS I information;
AXIS II information;
AXIS III information;
AXIS IV information; and
AXIS V information.

8. The web-based medical record system of claim 5, wherein the PPN module is integrated with an electronic prescription service.

9. The web-based medical record system of claim 1, wherein the user computer communicates with the web-based server over the Internet.

10. A method of providing a web-based medical record system, the method comprising the steps of:
providing a web-based server to control patient electronic medical records (EMRs);
providing a database operatively coupled to the web-based server to store the patient EMRs; and
generating at the web-based server graphical user interfaces on a display at a user computer and receiving input from the user computer, the user computer in communication with the web-based server over the Internet,
wherein the graphical user interfaces are configured to permit selection of medical parameters for a patient from predetermined selections to update the patient EMRs.

11. The method of claim 10, further comprising integrating an electronic prescription service with the web-based server.

12. The method of 11, further providing a single login so that a single login by a user permits access to the electronic prescription service and patient EMRs.

13. The method of claim 10, further comprising providing in the web-based server a Psychiatric Progress Note (PPN) module, the PPN module configured to permit recordation of:
minimum mental state exam (MMSE) information;
AXIS I information;
AXIS II information;
AXIS III information;
AXIS IV information; and
AXIS V information.

14. The method of claim 13, wherein the PPN module provides predetermined at least one list for selection by a user to enter information from the at least one list into a patient record.

15. The method of claim 14, wherein the predetermined at least one list permits the user to enter information into the patient's record related to:
minimum mental state exam (MMSE) information;
AXIS I information;
AXIS II information;
AXIS III information;
AXIS IV information; and
AXIS V information.

16. The method of claim 10, wherein the user computer communicates with the web-based server over the Internet.

17. A computer-implemented program product having software code stored in a readable storage medium, the software code when read and executed by a processor, cause the following steps to be performed:
generating from a web-based server, a plurality of graphical user interfaces (GUIs) to permit a user to select information from predetermined lists presented in in the plurality of GUIs to be entered into a selected patients electronic medical record (EMR) in an EMR database;
providing a Physician's Psychiatric Progress Note (PPN) module to permit recordation and access by a user to a patient's medical records for recording Psychiatric information; and
providing access to an electronic prescribing service so that a single login by user to the PPN module also provides access to the electronic prescribing service.

18. The computer program product of claim 17, wherein the PPN module is configured to permit recordation of:
minimum mental state exam (MMSE) information;
AXIS I information;
AXIS II information;
AXIS III information;
AXIS IV information; and
AXIS V information.

19. The computer program product of claim 17, wherein the PPN module provides predetermined at least one list for selection by a user to enter information from the at least one list into a patient record.

20. The computer program product of claim 19, wherein the predetermined at least one list permits the user to enter information into the patient's record related to:
minimum mental state exam (MMSE) information;
AXIS I information;
AXIS II information;
AXIS III information;
AXIS IV information; and
AXIS V information.
